(19) United States
(12) Patent Application Publication
(10) Pub. No.: US 2017/0241949 A1
(43) Pub. Date: Aug. 24, 2017

(54) MOLECULAR DIAGNOSTICS PLATFORM THAT USES DIGITAL MICROFLUIDICS AND MULTIPLEXED BEAD DETECTION

(71) Applicant: Advanced Liquid Logic, Inc., San Diego, CA (US)

(72) Inventors: Donovan Bort, Apex, NC (US); Carrie Graham, Raleigh, NC (US); Vamsee Pamula, Durham, NC (US); Michael Pollack, Durham, NC (US); Ramakrishna Sista, Morrisville, NC (US); Vijay Srinivasan, Durham, NC (US)

(21) Appl. No.: 15/472,248

(22) Filed: Mar. 28, 2017

Related U.S. Application Data
(63) Continuation of application No. 14/115,215, filed on Feb. 18, 2014, now abandoned.
(60) Provisional application No. 61/481,508, filed on May 2, 2011.

(51) Int. Cl. G01N 27/447; B01F 13/00; B01L 3/00; B01F 1/00

(52) U.S. Cl. CPC G01N 27/44791; B01F 1/0027; B01F 13/0071; B01F 13/0076; B01L 3/502761; B01L 3/502792; B01F 2215/0037; B01L 2200/0605; B01L 2200/0668; B01L 2200/10; B01L 2200/16; B01L 2300/0816; B01L 2300/0867; B01L 2300/089; B01L 2400/0406; B01L 2400/0418; B01L 2400/0427; B01L 2400/043; B01L 2400/0487

(57) ABSTRACT

A droplet actuator for manipulating a fluid using an electrical field includes a droplet arranged on or over an electrode. The droplet includes a set of beads arranged substantially in a monolayer on or over a surface of the droplet actuator.

### CROSS-REFERENCE TO RELATED APPLICATIONS

This application is a continuation application of U.S. Ser. No. 14/115,215, filed Feb. 18, 2014, which itself is a national stage entry under 35 U.S.C. §371 of PCT/US2012/035963, filed May 1, 2012, which itself claims the benefit of U.S. Provisional Application Ser. No. 61/481,508, filed May 2, 2011, each of which is incorporated by reference herein in its entirety.

### BACKGROUND

A droplet actuator typically includes one or more substrates configured to form a surface or gap for conducting droplet operations. The one or more substrates establish a droplet operations surface or gap for conducting droplet operations and may also include electrodes arranged to conduct the droplet operations. The droplet operations substrate or the gap between the substrates may be coated or filled with a filler fluid that is immiscible with the liquid that forms the droplets.

Droplet actuators are used in a variety of applications, including molecular diagnostic assays, such as nucleic acid based assays and immunoassays. In one example, nucleic acid based tests, such as reverse transcriptase polymerase chain reaction (RT-PCR) assays, are used for identification of respiratory viruses. Because a single sample may include multiple analytes to be evaluated, there is a need for improved approaches for multiplexing molecular diagnostic assays on a droplet actuator.

### Definitions

As used herein, the following terms have the meanings indicated.

“Activate,” with reference to one or more electrodes, means affecting a change in the electrical state of the one or more electrodes which, in the presence of a droplet, results in a droplet operation. Activation of an electrode can be accomplished using alternating or direct current. Any suitable voltage may be used. For example, an electrode may be activated using a voltage which is greater than about 150 V, or greater than about 200 V, or greater than about 250 V, or from about 275 V to about 375 V, or about 300 V. Where alternating current is used, any suitable frequency may be employed. For example, an electrode may be activated using alternating current having a frequency from about 1 Hz to about 100 Hz, or from about 10 Hz to about 60 Hz, or from about 20 Hz to about 40 Hz, or about 30 Hz.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical, amorphous and other three dimensional shapes. The bead may, for example, be capable of being subjected to a droplet operation in a droplet on a droplet actuator, or otherwise configured with respect to a droplet actuator in a manner which permits a droplet on the droplet actuator to be brought into contact with the bead on the droplet actuator and/or off the droplet actuator. Beads may be provided in a droplet, in a droplet operations gap, or on a droplet operations surface. Beads may be provided in a reservoir that is external to a droplet operations gap or situated apart from a droplet operations surface, and the reservoir may be associated with a fluid path that permits a droplet, including the beads, to be brought into a droplet operations gap or into contact with a droplet operations surface.

Beads may be manufactured using a wide variety of materials, including for example, resins and polymers. The beads may be any suitable size, including for example, microbeads, microparticles, nanobeads and nanoparticles.

In some cases, beads are magnetically responsive; and in other cases, beads are not significantly magnetically responsive. For magnetically responsive beads, the magnetically responsive material may constitute substantially all of a bead, a portion of a bead, or only one component of a bead. The remainder of the bead may include, among other things, polymeric material, coatings, and moieties which permit attachment of an assay reagent. Examples of suitable beads include flow cytometry microbeads, polystyrene microparticles and nanoparticles, functionalized polystyrene microparticles and nanoparticles, coated polystyrene microparticles and nanoparticles, silica microbeads, fluorescent microspheres and nanospheres, functionalized fluorescent microspheres and nanospheres, coated fluorescent microspheres and nanospheres, color dyed microparticles and nanoparticles, magnetic microparticles and nanoparticles, superparamagnetic microparticles and nanoparticles (e.g., DYNABEADS® particles, available from Invitrogen Group, Carlsbad, Calif.), fluorescent microparticles and nanoparticles, coated magnetic microparticles and nanoparticles, ferromagnetic microparticles and nanoparticles, coated ferromagnetic microparticles and nanoparticles, and those described in U.S. Patent Publication Nos. 2005/0260686, entitled “Multiplex flow assays preferably with magnetic particles as solid phase,” published on Nov. 24, 2005; 2003/0132538, entitled “Encapsulation of discrete quanta of fluorescent particles,” published on Jul. 17, 2003; 2005/0118574, entitled “Multiplexed Analysis of Clinical Specimens Apparatus and Method,” published on Jun. 2, 2005; 2005/0277197, entitled “Microparticles with Multiple Fluorescent Signals and Methods of Using Same,” published on Dec. 15, 2005; 2006/0159962, entitled “Magnetic Microspheres for use in Fluorescence-based Applications,” published on Jul. 20, 2006; the entire disclosures of which are incorporated herein by reference for their teaching concerning beads and magnetically responsive materials and beads.

Beads may be pre-coupled with a biomolecule or other substance that is able to bind to and form a complex with a biomolecule. Beads may be pre-coupled with an antibody, protein or antigen, DNA/RNA probe or any other molecule with an affinity for a desired target. Examples of droplet actuator techniques for immobilizing magnetically responsive beads and/or non-magnetically responsive beads, and/or for conducting droplet operations protocols using beads are described in U.S. patent application Ser. No. 11/639,566, entitled “Droplet-Based Particle Sorting,” filed on Dec. 15, 2006; U.S. Provisional Patent Application No. 61/039,183, entitled “Multiplexing Bead Detection in a Single Droplet,” filed on Mar. 25, 2008; U.S. Provisional Patent Application No. 61/047,789, entitled “Droplet Actuator Devices and Droplet Operations Using Beads,” filed on Apr. 25, 2008; U.S. Provisional Patent Application No. 61/086,183, entitled “Droplet Actuator Devices and Methods for Manipulating Beads,” filed on Aug. 5, 2008; International Patent Application No. PCT/US2008/053545, entitled “Droplet Actuator Devices and Methods Employing Magnetic Beads,” filed on Feb. 11, 2008; International Patent Application No. PCT/US2008/058018, entitled “Bead-based Multiplexed Analytical Methods and Instrumentation,” filed on Mar. 24, 2008; International Patent Application No. PCT/US2008/058047, “Bead Sorting on a Droplet Actuator,” filed on Mar. 23, 2008; and International Patent Application No. PCT/US2006/047486, entitled “Droplet-based Biochemistry,” filed on Dec. 11, 2006; the entire disclosures of which are incorporated herein by reference. Bead characteristics may be employed in the multiplexing aspects of the invention. Examples of beads having characteristics suitable for multiplexing, as well as methods of detecting and analyzing signals emitted from such beads, may be found in U.S. Patent Publication No. 2008/0305481, entitled “Systems and Methods for Multiplex Analysis of PCR in Real Time,” published on Dec. 11, 2008; U.S. Patent Publication No. 2008/0151240, “Methods and Systems for Dynamic Range Expansion,” published on Jun. 26, 2008; U.S. Patent Publication No. 2007/0207513, entitled “Methods, Products, and Kits for Identifying an Analyte in a Sample,” published on Sep. 6, 2007; U.S. Patent Publication No. 2007/0064990, entitled “Methods and Systems for Image Data Processing,” published on Mar. 22, 2007; U.S. Patent Publication No. 2006/0159962, entitled “Magnetic Microspheres for use in Fluorescence-based Applications,” published on Jul. 20, 2006; U.S. Patent Publication No. 2005/0277197, entitled “Microparticles with Multiple Fluorescent Signals and Methods of Using Same,” published on Dec. 15, 2005; and U.S. Patent Publication No. 2005/0118574, entitled “Multiplexed Analysis of Clinical Specimens Apparatus and Method,” published on Jun. 2, 2005.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; non-limiting examples of which include generally disc shaped, slug shaped, truncated sphere, ellipsoid, spherical, a partially compressed sphere, hemispherical, ovoid, cylindrical, combinations of such shapes, and various shapes formed during droplet operations, such as merging or splitting, or formed as a result of contact of such shapes with one or more surfaces of a droplet actuator.

For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tears, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No. 6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling, et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne, et al., U.S. Pat. No. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa, et al., U.S. Patent Publication No. 2006/0039823, entitled “Chemical Analysis Apparatus,” published on Feb. 23, 2006; Wu, International Patent Publication No. WO/2009/003184, entitled “Digital Microfluidics Based Apparatus for Heat-exchanging Chemical Processes,” published on Dec. 31, 2008; Fouillet, et al., U.S. Patent Publication No. 2009/0192044, entitled “Electrode Addressing Method,” published on Jul. 30, 2009; Fouillet, et al., U.S. Pat. No. 7,052,244, entitled “Device for Displacement of Small Liquid Volumes Along a Micro-catenary Line by Electrostatic Forces,” issued on May 30, 2006; Marchand, et al., U.S. Patent Publication No. 2008/0124252, entitled “Droplet Microreactor,” published on May 29, 2008; Adachi, et al., U.S. Patent Publication No. 2009/0321262, entitled “Liquid Transfer Device,” published on Dec. 31, 2009; Roux, et al., U.S. Patent Publication No. 2005/0179746, entitled “Device for Controlling the Displacement of a Drop Between two or Several Solid Substrates,” published on Aug. 18, 2005; Dhindsa, et al., “Virtual Electrowetting Channels: Electronic Liquid Transport with Continuous Channel Functionality,” Lab Chip, 10:832-836 (2010); the entire disclosures of which are incorporated herein by reference, along with their priority documents.

Certain droplet actuators will include one or more substrates arranged with a gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention.

During droplet operations it is preferred that droplets remain in continuous contact or frequent contact with a ground or reference electrode. A ground or reference electrode may be associated with the top substrate facing the gap, the bottom substrate facing the gap, or in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, N.J.) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define dispensing reservoirs. The spacer height may, for example, be from about 5 μm to about 600 μm, or about 100 μm to about 400 μm, or about 200 μm to about 350 μm, or about 250 μm to about 300 μm, or about 275 μm. The spacer may, for example, be formed of a layer of projections from the top or bottom substrates, and/or a material inserted between the top and bottom substrates. One or more openings may be provided in the one or more substrates for forming a fluid path through which liquid may be delivered into the droplet operations gap. The one or more openings may, in some cases, be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may, in some cases, be formed as one integral component. One or more reference electrodes may be provided on the base (or bottom) and/or top substrates and/or in the gap. Examples of reference electrode arrangements are provided in the above referenced patents and patent applications.

In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g., external syringe pumps, pneumatic membrane pumps, vibrating membrane pumps, vacuum devices, centrifugal forces, piezoelectric/ultrasonic pumps and acoustic forces); electrical or magnetic principles (e.g., electroosmotic flow, electrokinetic pumps, ferrofluidic plugs, electrohydrodynamic pumps, attraction or repulsion using magnetic forces and magnetohydrodynamic pumps); thermodynamic principles (e.g., gas bubble generation/phase-change-induced volume expansion); other kinds of surface-wetting principles (e.g., electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions cause flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a fluid path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds, such as poly- or per-fluorinated compounds in solution, or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc.), and NOVEC™ electronic coatings (available from 3M Company, St. Paul, Minn.), and other fluorinated monomers for plasma-enhanced chemical vapor deposition (PECVD). In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose, Calif.); ARLON™ 11N (available from Arlon, Inc., Santa Ana, Calif.); NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper. Various materials are also suitable for use as the dielectric component of the substrate. Examples include: vapor deposited dielectric, such as PARYLENE™ C (especially on glass) and PARYLENE™ N (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., PEP), polytetrafluoroethylene; polyester; polyethylene naphthalate; cyclo-olefin copolymer (COC); cyclo-olefin polymer (COP); any other PCB substrate material listed above; black matrix resin; and polypropylene. Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, inter-electrode pitch, and gap height (between top and bottom substrates) may be varied for use with specific reagents, protocols, droplet volumes, etc. In some cases, a substrate of the invention may be derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, and other fluorinated monomers for plasma-enhanced chemical vapor deposition (PECVD). Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray Industries, Inc., Japan. Electrodes of a droplet actuator are typically controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may typically be combined with liquids for reconstitution. An example of reconstitutable reagents suitable for use with the invention includes those described in Meathrel, et al., U.S. Pat. No. 7,727,466, entitled “Disintegratable films for diagnostic devices,” granted on Jun. 1, 2010.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance or capacitance sensing or imaging techniques may sometimes be used to determine or confirm the outcome of a droplet operation. Examples of such techniques are described in Sturmer et al., International Patent Publication No. WO/2008/101194, entitled “Capacitance Detection in a Droplet Actuator,” published on Aug. 21, 2008, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may exceed about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to electrowetting area; in other words, 1×-, 2×-3×-droplets are usefully controlled operated using 1, 2, and 3 electrodes, respectively. If the droplet footprint is greater than the number of electrodes available for conducting a droplet operation at a given time, the difference between the droplet size and the number of electrodes should typically not be greater than 1; in other words, a 2× droplet is usefully controlled using 1 electrode and a 3× droplet is usefully controlled using 2 electrodes. When droplets include beads, it is useful for droplet size to be equal to the number of electrodes controlling the droplet, e.g., transporting the droplet.

“Filler fluid” means a fluid associated with a droplet operations substrate of a droplet actuator, which fluid is sufficiently immiscible with a droplet phase to render the droplet phase subject to electrode-mediated droplet operations. For example, the gap of a droplet actuator is typically filled with a filler fluid. The filler fluid may, for example, be a low-viscosity oil, such as silicone oil or hexadecane filler fluid. The filler fluid may fill the entire gap of the droplet actuator or may coat one or more surfaces of the droplet actuator. Filler fluids may be conductive or non-conductive. Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan, et al., International Patent Publication Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista, et al., International Patent Publication No. WO/2008/098236, entitled “Droplet Actuator Devices and Methods Employing Magnetic Beads,” published on Aug. 14, 2008; and Monroe, et al., U.S. Patent Publication No. 2008/0283414, entitled “Electrowetting Devices,” filed on May 17, 2007; the entire disclosures of which are incorporated herein by reference, as well as the other patents and patent applications cited herein.

“Immobilize” with respect to magnetically responsive beads, means that the beads are substantially restrained in position in a droplet or in filler fluid on a droplet actuator. For example, in one embodiment, immobilized beads are sufficiently restrained in position in a droplet to permit execution of a droplet splitting operation, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe₃O₄, BaFe₁₂O₁₉, CoO, NiO, Mn₂O₃, Cr₂O₃, and CoMnP.

“Reservoir” means an enclosure or partial enclosure configured for holding, storing, or supplying liquid. A droplet actuator system of the invention may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is typically in fluid communication with an opening or fluid path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir will typically include a fluid passage means whereby liquid may be transferred from the off-cartridge reservoir into an on-cartridge reservoir or into a droplet operations gap.

“Transporting into the magnetic field of a magnet,” “transporting towards a magnet,” and the like, as used herein to refer to droplets and/or magnetically responsive beads within droplets, are intended to refer to transporting into a region of a magnetic field capable of substantially attracting magnetically responsive beads in the droplet. Similarly, “transporting away from a magnet or magnetic field,” “transporting out of the magnetic field of a magnet,” and the like, as used herein to refer to droplets and/or magnetically responsive beads within droplets, are intended to refer to transporting away from a region of a magnetic field capable of substantially attracting magnetically responsive beads in the droplet, whether or not the droplet or magnetically responsive beads is completely removed from the magnetic field. It will be appreciated that in any of such cases described herein, the droplet may be transported towards or away from the desired region of the magnetic field, and/or the desired region of the magnetic field may be moved towards or away from the droplet. Reference to an electrode, a droplet, or magnetically responsive beads being “within” or “in” a magnetic field, or the like, is intended to describe a situation in which the electrode is situated in a manner which permits the electrode to transport a droplet into and/or away from a desired region of a magnetic field, or the droplet or magnetically responsive beads is/are situated in a desired region of the magnetic field, in each case where the magnetic field in the desired region is capable of substantially attracting any magnetically responsive beads in the droplet. Similarly, reference to an electrode, a droplet, or magnetically responsive beads being “outside of” or “away from” a magnetic field, and the like, is intended to describe a situation in which the electrode is situated in a manner which permits the electrode to transport a droplet away from a certain region of a magnetic field, or the droplet or magnetically responsive beads is/are situated away from a certain region of the magnetic field, in each case where the magnetic field in such region is not capable of substantially attracting any magnetically responsive beads in the droplet or in which any remaining attraction does not eliminate the effectiveness of droplet operations conducted in the region. In various aspects of the invention, a system, a droplet actuator, or another component of a system may include a magnet, such as one or more permanent magnets (e.g., a single cylindrical or bar magnet or an array of such magnets, such as a Halbach array) or an electromagnet or array of electromagnets, to form a magnetic field for interacting with magnetically responsive beads or other components on chip. Such interactions may, for example, include substantially immobilizing or restraining movement or flow of magnetically responsive beads during storage or in a droplet during a droplet operation or pulling magnetically responsive beads out of a droplet.

“Washing” with respect to washing a bead means reducing the amount and/or concentration of one or more substances in contact with the bead or exposed to the bead from a droplet in contact with the bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Examples of suitable washing techniques are described in Pamula, et al., U.S. Pat. No. 7,439,014, entitled “Droplet-Based Surface Modification and Washing,” granted on Oct. 21, 2008, the entire disclosure of which is incorporated herein by reference.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### BRIEF DESCRIPTION OF THE DRAWINGS

FIG. 1 illustrates an exploded view of an example of a droplet actuator that may be used as a sample-to-answer digital microfluidics molecular diagnostic platform;

FIG. 2 illustrates a top down view of the droplet actuator of FIG. 1 when its components are fully assembled;

FIG. 3 illustrates a top down view of a bottom substrate of the droplet actuator of FIG. 1, which may be a PCB;

FIG. 4A illustrates a top down view of the top substrate and gasket portion of the droplet actuator of FIG. 1;

FIG. 4B illustrates a cross-sectional view of the gasket and the top substrate, taken along line AA of FIG. 4A;

FIG. 5A illustrates a top down view of the top substrate portion of the droplet actuator of FIG. 1;

FIG. 5B illustrates a side view of the top substrate portion of the droplet actuator of FIG. 1, which shows the overall side view profile of the top substrate;

FIG. 6 illustrates a perspective view of another example of a droplet actuator that is suitable for sample-to-answer multiplexed detection of one or more pathogens in a single biological sample;

FIGS. 7 through 24 illustrate an example of a fluid mixing and dispensing process using digital microfluidics;

FIG. 25 illustrates a perspective view of an example of a droplet actuator, which is another example of a sample-to-answer digital microfluidics molecular diagnostic platform;

FIG. 26 illustrates an exploded view of the droplet actuator of FIG. 25;

FIG. 27A illustrates a top down view of the portion of the droplet actuator of FIG. 25 that includes one reagent reservoir and shows an example of dried reagent installed therein;

FIG. 27B illustrates an example of a dried reagent for use in the droplet actuator of FIG. 25;

FIG. 28A illustrates a perspective view of the portion of the droplet actuator of FIG. 25 that includes one reagent reservoir and shows another example of dried reagent installed therein;

FIG. 28B illustrates another example of a dried reagent for use in the droplet actuator of FIG. 25;

FIGS. 29A and 29B illustrate a top side view and a bottom side view, respectively, of a top substrate of the droplet actuator of FIG. 25;

FIG. 30 illustrates a top down view of a bottom substrate of the droplet actuator of FIG. 25 and shows an example of an electrode arrangement for performing sample-to-answer molecular assays (e.g., RT-PCR);

FIG. 31 illustrates a top view of an example of an electrode arrangement that supports an on-actuator sample reservoir of the droplet actuator of FIG. 25;

FIG. 32 illustrates a top view of an example of an electrode arrangement that supports an on-actuator reagent reservoir of the droplet actuator of FIG. 25;

FIGS. 33 through 45 illustrate a top view of a portion of the electrode arrangement of the droplet actuator of FIG. 25 and a process of reconstituting dried reagents and dispensing reagent droplets;

FIG. 46 illustrates a perspective view of an example of an imaging system for multiplexed detection of color coded beads (e.g., fluorescent beads);

FIG. 47 illustrates a flow diagram of an example of a protocol for sample-to-answer detection of respiratory viruses in a biological sample;

FIGS. 48A and 48B show examples of bead classification maps of MagPlex beads after 1 or 40 transport cycles on a droplet actuator that is filled with hexadecane or 2.0 cSt silicone filler fluid;

FIGS. 49, 50, and 51 show an example of a bar graph and example plots of reporter signal in an on-actuator bead washing protocol;

FIGS. 52 and 53 show an example of plots of chemiluminescence data and analysis of the washing efficiency of an on-actuator bead washing protocol;

FIGS. 54A and 54B show example bead classification maps of MagPlex beads after 10 bead washing cycles on a droplet actuator;

FIGS. 55 and 56 show examples of bar graphs of a comparison of an RVP Fast assay performed on-bench and on a droplet actuator;

FIG. 57 shows an example of a data table of an RVP-Fast assay performed on a droplet actuator;

FIG. 58 shows an example of a bar graph of another comparison of an xTAG RVP assay performed on-bench and on a droplet actuator; and

FIGS. 59A and 59B illustrate a side view of a portion of an example of a droplet actuator and illustrate a process of multiplexing immunoassays using multiple types of beads in a single droplet.

### DETAILED DESCRIPTION

The present invention provides molecular diagnostic platforms that use digital microfluidics and bead technologies for multiplexed molecular testing. By use of an integrated droplet actuator in combination with a detection system, sample-to-answer molecular assays may be multiplexed using multiple types of beads (coded beads) in a single sample droplet. In one example, the droplet actuator device uses a large input sample volume (e.g., about 1 milliliter (mL)) and provides for rapid capture and concentration of multiple target analytes (e.g., nucleic acids) from a single sample for subsequent molecular diagnostic assays (e.g., reverse transcription polymerase chain reaction (RT-PCR)) on the same droplet actuator.

In another example, the sample-to-answer digital microfluidics molecular diagnostic platform may use both liquids and certain dry substances, such as dry reagents, in a droplet actuator for performing sample-to-answer molecular assays (e.g., RT-PCR).

In one embodiment, the molecular diagnostics platform and methods of the present invention provide for multiplexed detection of respiratory viruses in a single biological sample (e.g., nasopharyngeal sample) in less than about 60 minutes, or less than about 30 minutes, or less than about 20 minutes.

In another embodiment, the molecular diagnostics platform and methods of the present invention provide for high throughput molecular diagnostics, i.e., multiple different tests (e.g., xMAP bead array panels) performed in parallel.

In yet another embodiment, the present invention provides a method of multiplexing immunoassays in a droplet actuator using a single droplet that contains multiple types of beads.

The present invention also provides a fluid mixing and dispensing process using a microfluidics platform that includes one or more an on-actuator reservoirs that are designed to perform complex droplet mixing operations.

The droplet actuators of the invention are inexpensive and simple-to-use disposable devices that provide for high quality testing in a variety of clinical settings including hospital laboratories and at the point-of-care.

Multiplexed Molecular Diagnostic Platform

The molecular diagnostic platform of the invention includes digital microfluidic liquid-handling technology and bead-based analyte capture technologies for multiplexed molecular analysis (e.g., nucleic acid testing, immunoassays). The molecular diagnostic platform uses imaging technology for bead-based discrimination and detection of one or more analytes in a biological sample.

Digital Microfluidics

Digital microfluidic technology conducts droplet operations on discrete droplets by electrical control of their surface tension (electrowetting). The droplets may be sandwiched between two substrates, a bottom substrate and a top substrate separated by a gap. The bottom substrate may, for example, be a printed circuit board (PCB) with an arrangement of electrically addressable electrodes. The top substrate may, for example, be an injection molded plastic top substrate with a reference electrode plane made, for example, from conductive ink or indium tin oxide (ITO). The bottom substrate and the top substrate may be coated with a hydrophobic material. The space around the droplets (i.e., the gap between bottom and top substrates) may be filled with an immiscible inert fluid, such as silicone oil, to prevent evaporation of the droplets and to facilitate their transport within the device. An electric field, formed when voltage is applied to a control electrode on the bottom substrate, reduces the interfacial tension between the droplet and the electrode. This effect may be used to transport droplets using surface energy gradients established by activating a pattern of control electrodes on the bottom substrate along any path of contiguous electrodes. Other droplet operations may be effected by varying the patterns of voltage activation; examples include merging, splitting, mixing, and dispensing of droplets.

A droplet actuator may be adapted for integrated sample preparation and nucleic acid testing of a biological sample. For example, a thin coating on the PCB may be used to provide more efficient RT-PCR. To facilitate dispensing on thinly coated PCBs, TWEEN® 20, for example, may be included in droplets to be dispensed (e.g., reagent droplets). In another example, the direction of spray coating of the PCB may be varied.

### First Example Sample-to-Answer Platform

In this example, the sample-to-answer digital microfluidics molecular diagnostic platform may use liquids only in a droplet actuator for performing sample-to-answer molecular assays (e.g., RT-PCR).

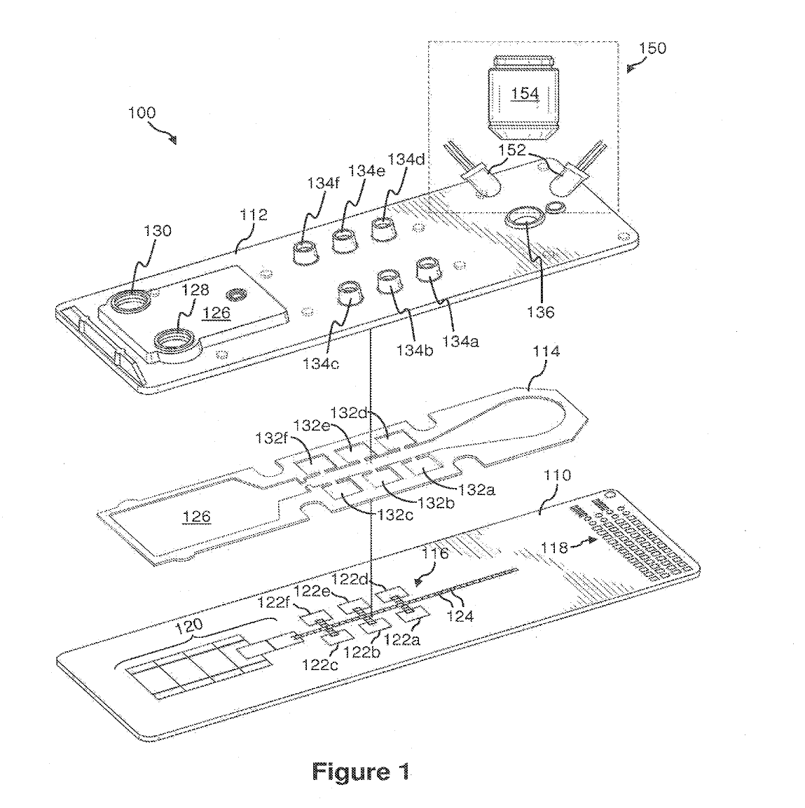

FIG. 1 illustrates an exploded view of an example of a droplet actuator 100 that may be used as a sample-to-answer digital microfluidics molecular diagnostic platform. In one embodiment, droplet actuator 100 is configured for integrated sample preparation and nucleic acid testing of a single sample. Droplet actuator 100 may include a bottom substrate 110 and a top substrate 112. A gasket 114 may be sandwiched between bottom substrate 110 and top substrate 112.

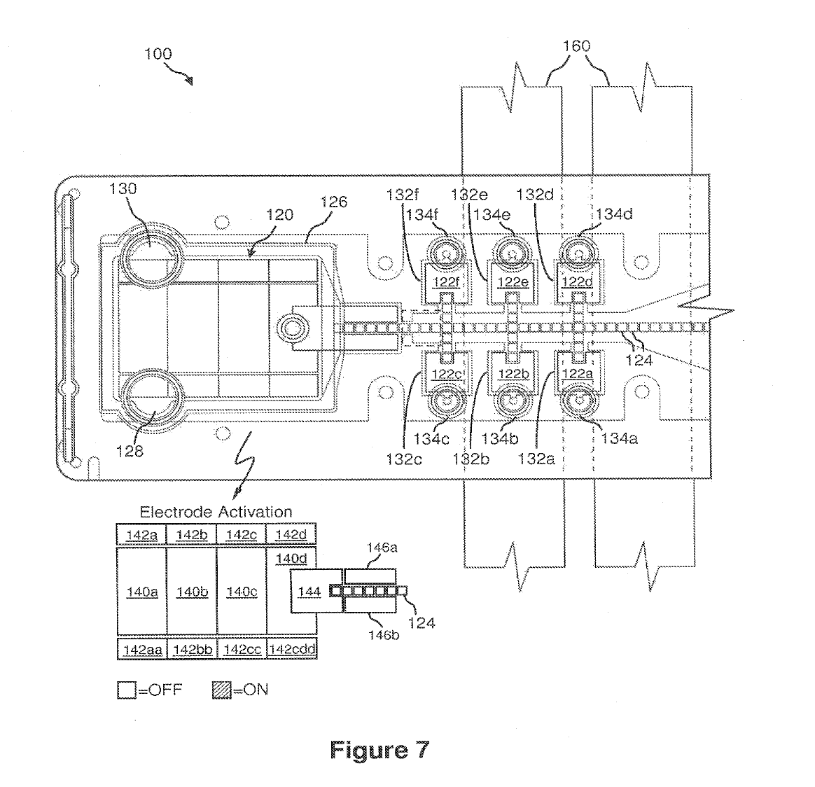

In one example, bottom substrate 110 may be a PCB that has an electrode arrangement 116 and a set of power/signal input/output (I/O) pads 118 patterned thereon. Electrode arrangement 116 may include, for example, at least one sample dispensing electrode 120 and one or more reagent dispensing electrodes 122 (e.g., reagent dispensing electrodes 122a through 122f), all arranged in relation to a path, line, and/or array of droplet operations electrodes 124 (e.g., electrowetting electrodes). Sample dispensing electrode 120 may be segmented into an arrangement of multiple individually controlled electrodes, which are which are further described with reference to FIGS. 7 through 24. Droplet operations are conducted atop these various electrodes on a droplet operations surface.

Top substrate 112 may be formed of a material that is substantially transparent to visible light, ultraviolet (UV) light, and/or any wavelength light of interest. For example, top substrate 112 may be formed of glass, injection-molded plastic, and/or silicon. Additionally, top substrate 112 may be coated with indium-tin oxide (ITO), thereby providing an electrical ground plane.

A clearance region is provided in gasket 114. When bottom substrate 110, top substrate 112, and gasket 114 are assembled together, the clearance region of gasket 114 forms a gap between bottom substrate 110 and top substrate 112 at the droplet operations surface. The thickness of gasket 114 may be used to set the height of the gap. Further, the shape of the clearance region of gasket 114 substantially corresponds to the shape of electrode arrangement 116 of bottom substrate 110. In one example, the shape of the clearance region of gasket 114 at sample dispensing electrode 120, together with bottom substrate 110 and top substrate 112, form a sample reservoir 126. Sample reservoir 126 is an example of an on-actuator reservoir. Sample reservoir 126 may be provided for preparing and dispensing sample fluids (e.g., 1 mL nasopharyngeal swab elute). Sample reservoir 126 may be of sufficient size to contain a large volume of fluid, e.g., about 1.5 mL.

One or more input ports of sample reservoir 126 may be integrated into top substrate 112. For example, an input port 128 for loading sample fluids into sample reservoir 126 may be integrated into top substrate 112. Additionally, an input port 130 for loading sample preparation reagents (e.g., lysis buffer, nucleic acid capture beads) into sample reservoir 126 may be integrated into top substrate 112.

In another example, the shape of the clearance region of gasket 114 at each of reagent dispensing electrodes 122a through 122f, together with bottom substrate 110 and top substrate 112, form respective reagent reservoirs 132 (e.g., reagent reservoirs 132a through 132f) for dispensing various reagent fluids. Each reagent reservoir 132 is an example of an on-actuator reservoir. Respective input ports 134 (e.g., input ports 134a through 134f) of reagent reservoirs 132 may be integrated into top substrate 112. Top substrate 112 may include certain features for helping define the volume of the on-actuator reservoirs (e.g., sample reservoir 126 and reagent reservoirs 132), such as shown in FIGS. 1 through 5B.

A port (e.g., input port 128, input port 130, and input ports 134) is an entrance/exit (opening) to the droplet operations gap. Liquid may flow through the port into any portion of the gap. That could be into a reservoir region of the gap or onto a droplet operations pathway. A port may be used to fill the gap with filler fluid. However, in most cases, a reagent fluid or sample fluid flowing through a port should come into sufficient proximity with an electrode, such that the electrode can be used to conduct one or more droplet operations using the liquid, such as droplet transport, splitting, and dispensing.

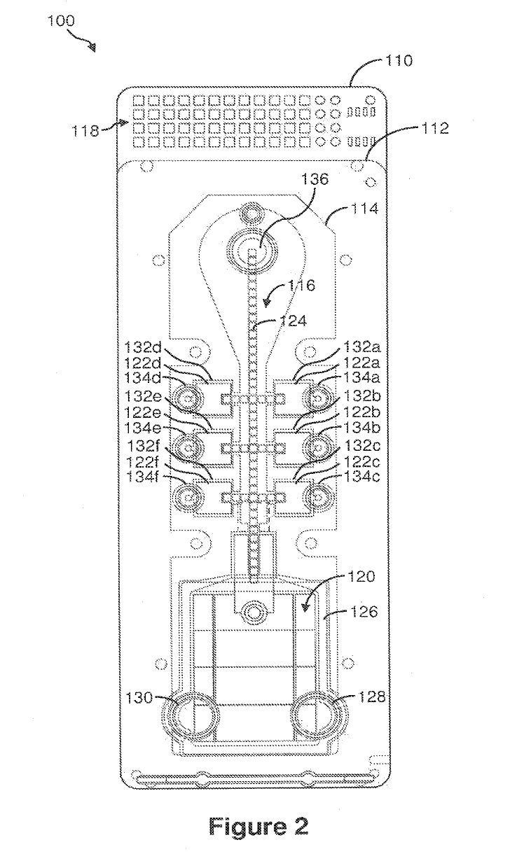

When bottom substrate 110, top substrate 112, and gasket 114 are assembled together, input port 128 and input port 130 in top substrate 112 are substantially aligned with at least a portion of sample dispensing electrode 120 of bottom substrate 110. Similarly, input ports 134 in top substrate 112 are substantially aligned with at least a portion of their respective reagent dispensing electrodes 122 of bottom substrate 110. More details of droplet actuator 100 are described below with reference to FIGS. 2 through 5B.

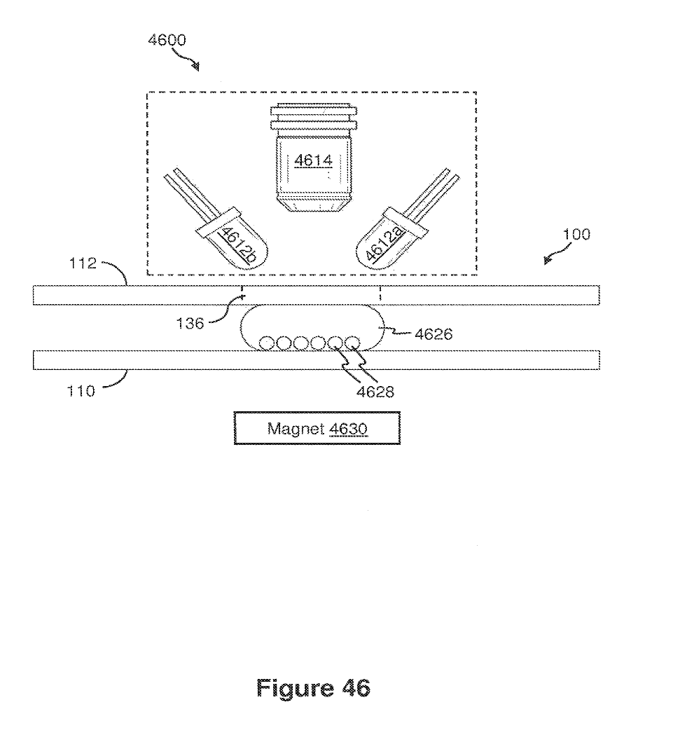

An imaging system 150 may be used in combination with droplet actuator 100. Accordingly, a detection window 136 may be included in top substrate 112 through which imaging system 150 may be used to perform detection operations. The amount of transparency provided at detection window 136 may vary. Detection window 136 may be formed to direct and/or filter light, e.g., formed as a lens and/or as an optical filter that excludes certain wavelengths. Light energy that is generated in the gap of droplet actuator 100 may be transmitted through detection window 136 and then captured by imaging system 150. In one example, imaging system 150 may include one or more light-emitting diodes (LEDs) 152 (i.e., an illumination source) and a digital image capture device, such as a charge-coupled device (CCD) camera 154. (Only the lens of CCD camera 154 is shown in FIG. 1). In one example, one LED 152 may emit green light (525 nm wavelength) and another LED 152 may emit red light (635 nm wavelength). Another example of an imaging system is described with reference to FIG. 46.

FIG. 2 illustrates a top down view of droplet actuator 100 when its components are fully assembled. More specifically, FIG. 2 shows bottom substrate 110, top substrate 112, and gasket 114 assembled together to form droplet actuator 100. In this view, it is shown that the clearance region of gasket 114 substantially corresponds to the shape of electrode arrangement 116 of bottom substrate 110. Additionally, the alignment is shown of sample reservoir 126 to sample dispensing electrode 120 of bottom substrate 110. Similarly, the alignment is shown of the one or more reagent reservoirs 132 to the one or more reagent dispensing electrodes 122 of bottom substrate 110.

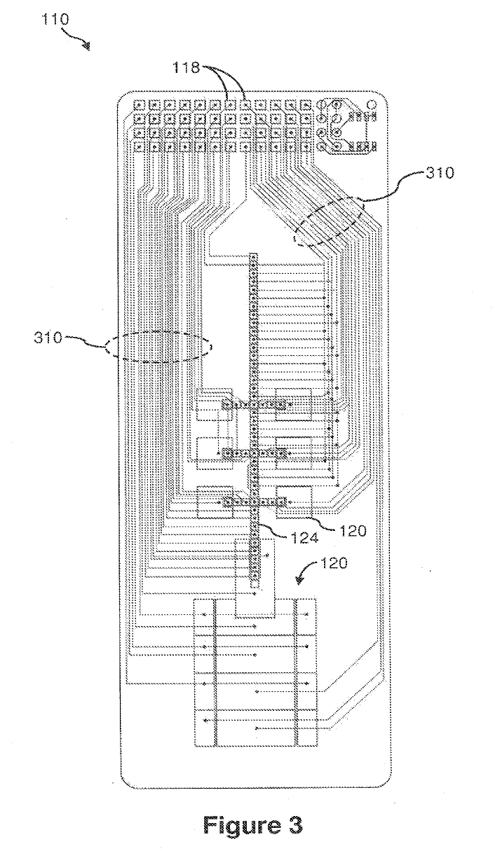

FIG. 3 illustrates a top down view of bottom substrate 110 of droplet actuator 100, which may be a PCB. More specifically, FIG. 3 shows the electrode wiring pattern integrated into the PCB layers of bottom substrate 110. For example, using standard PCB technology, wiring traces 310 are used to electrically connect power/signal I/O pads 118 to sample dispensing electrode 120, to the one or more reagent dispensing electrodes 122, and to the droplet operations electrodes 124.

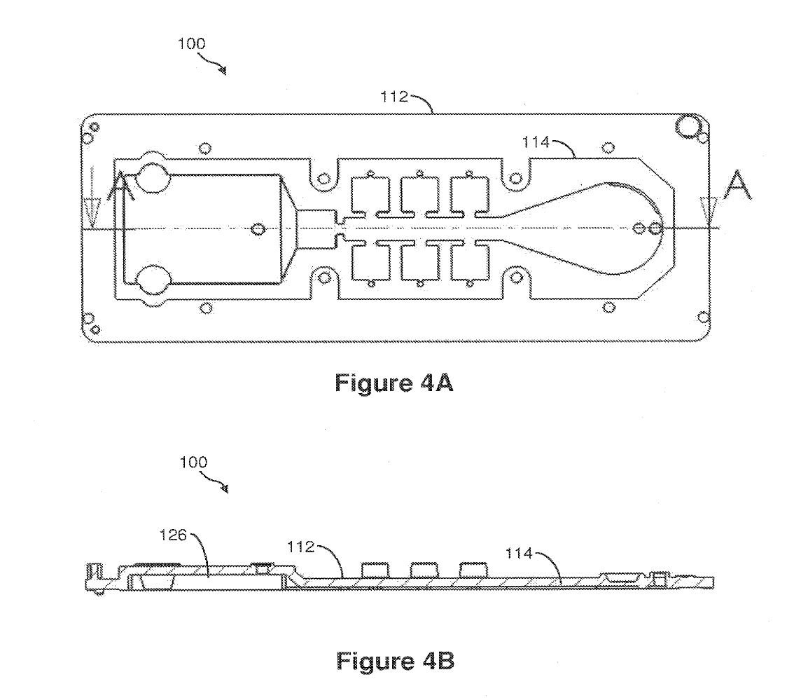

FIG. 4A illustrates a top down view of the top substrate 112 and gasket 114 portion of droplet actuator 100. More specifically, FIG. 4A shows the gasket 114—side of top substrate 112, without bottom substrate 110. FIG. 4B illustrates a cross-sectional view of gasket 114 and top substrate 112, taken along line AA of FIG. 4A.

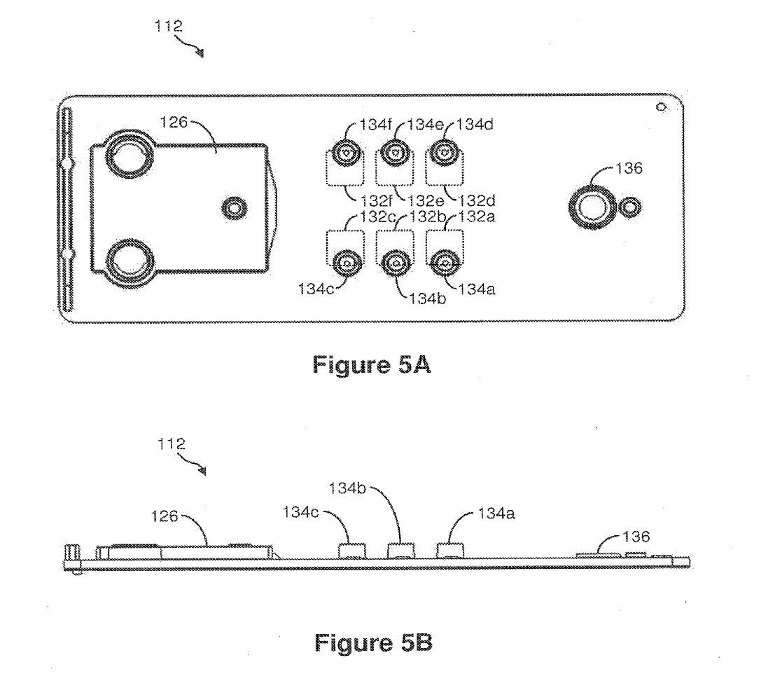

FIG. 5A illustrates a top down view of the top substrate 112 portion of droplet actuator 100. Additionally, FIG. 5B illustrates a side view of the top substrate 112 portion of droplet actuator 100, which shows the overall side view profile of top substrate 112.

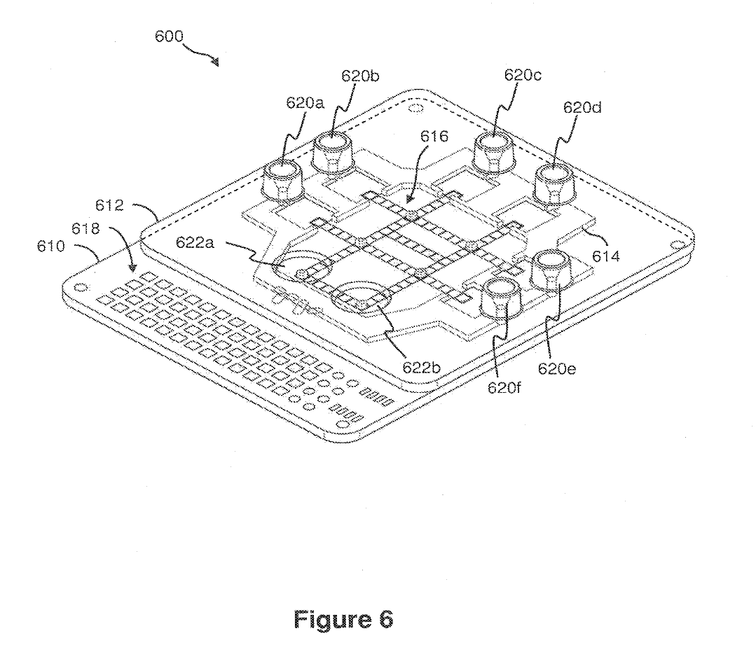

FIG. 6 illustrates a perspective view of another example of a droplet actuator 600 that is suitable for sample-to-answer multiplexed detection of one or more pathogens in a single biological sample. Droplet actuator 600 may include a bottom substrate 610 and a top substrate 612. A gasket 614 may be sandwiched between bottom substrate 610 and top substrate 612. In one example, bottom substrate 610 may be a PCB that has an electrode arrangement 616 and a set of power/signal I/O pads 618 patterned thereon. Electrode arrangement 616 may include, for example, one or more reagent dispensing electrodes that are arranged in relation to a path, line, and/or array of droplet operations electrodes (e.g., electrowetting electrodes). Droplet operations are conducted atop these various electrodes on a droplet operations surface. Again, a clearance region is provided in gasket 614. The shape of the clearance region of gasket 614 substantially corresponds to the shape of electrode arrangement 616 of bottom substrate 610.

Top substrate 612 may be formed of a material that is substantially transparent to visible light, transparent to ultraviolet (UV) light, and/or transparent to any wavelength of interest. For example, top substrate 612 may be formed of glass, injection-molded plastic, silicon, and/or ITO. Certain reservoirs may be integrated into top substrate 612. For example, one or more reagent reservoirs 620 (e.g., reagent reservoirs 620a through 620f) may be integrated into top substrate 612 for dispensing various reagent fluids. Each reagent reservoir 620 is in fluid communication with an opening or fluid path arranged for flowing liquid from into the droplet operations gap. Additionally, one or more detection windows 622 (e.g., detection windows 622a and 622b) may be included in top substrate 612 through which an imaging system, such as imaging system 150 of FIG. 1, may be used to perform detection operations.

Fluid Mixing and Dispensing Process Using Digital Microfluidics

FIGS. 7 through 24 illustrate an example of a fluid mixing and dispensing process using digital microfluidics. That is, an example of an electrode activation sequence of droplet actuator 100 of FIGS. 1 through 5B for performing a fluid mixing and dispensing process is shown in FIGS. 7 through 24. The electrode activation sequence that is depicted in FIGS. 7 through 24 is exemplary only. The invention is not limited to this electrode activation sequence only.

Further, a heating mechanism may be associated with droplet actuator 100. For example, FIGS. 7 through 24 show one or more heater bars 160 positioned in relation to droplet actuator 100 for providing thermal control thereof.

In the example of droplet actuator 100, sample dispensing electrode 120 that is associated with sample reservoir 126 is segmented into an arrangement of multiple individually controlled electrodes, which are referred to collectively as sample dispensing electrode 120. For example and referring to FIG. 7, along the center of sample dispensing electrode 120 may be four segmented reservoir electrodes 140a, 140b, 140c, and 140d. Smaller reservoir flanking electrodes 142a, 142b, 142c, and 142d may be arranged on one side of segmented reservoir electrodes 140a, 140b, 140c, and 140d. Smaller reservoir flanking electrodes 142aa, 142bb, 142cc, and 142dd may be arranged on the other side of segmented reservoir electrodes 140a, 140b, 140c, and 140d. Segmented reservoir electrode 140d of sample dispensing electrode 120 is arranged in relation to a priming electrode 144. For example, segmented reservoir electrode 140d may be arranged in relation to three sides of priming electrode 144. Priming electrode 144 is arranged in relation to the path, line, and/or array of droplet operations electrodes 124 on which droplet may be dispensed. Additionally, a path flanking electrode 146a may be arranged on one side of droplet operations electrodes 124, while a path flanking electrode 146b may be arranged on the other side of droplet operations electrodes 124. Droplet operations are conducted atop these various electrodes on a droplet operations surface. Sample dispensing electrode 120 that includes the multiple individually controlled electrodes supports an on-actuator reservoir that is designed to perform complex droplet mixing and/or droplet dispensing operations.

An aspect of the invention is that the segmented sample dispensing electrode 120 supports an on-actuator reservoir (e.g., sample reservoir 126) that is designed to perform complex droplet mixing operations. The capability to perform complex droplet mixing operations is because sample dispensing electrode 120 is segmented into an arrangement of multiple individually controlled electrodes.

Another aspect of the invention is that when sample reservoir 126 is not fully filled, smaller volumes of fluid may be moved to the dispensing end of sample dispensing electrode 120 (using the individually controlled electrodes) for dispensing various sized droplets.

Yet another aspect of the invention is that path flanking electrodes 146, which are lateral to droplet operations electrodes 124, may be activated to help pull the liquid out of sample dispensing electrode 120 and onto the electrode path.

Yet another aspect of the invention is that sample reservoir 126 has large electrodes as compared with the unit-sized droplet operations electrodes 124. Additionally, sample reservoir 126 has a larger gap height (see FIG. 4B) as compared with the gap height at the unit-sized droplet operations electrodes 124.

Additionally, an “Electrode Activation” detail is shown in each of FIGS. 7 through 24, which indicates the electrode activation for each respective step of the example fluid mixing and dispensing process. In one example, the electrode activation sequence may be executed at a rate of from about 1 Hz to about 100 Hz. FIG. 7 shows droplet actuator 100 prior to beginning the fluid mixing and dispensing process and with no electrodes activated. It can be assumed that the gap inside droplet actuator 100 is filled with filler fluid. The filler fluid may, for example, be a low-viscosity oil, such as silicone oil or hexadecane filler fluid. Different types of fluids (e.g., sample, reagents, etc.) may be processed in droplet actuator 100. The reagents may include reagents for conducting an assay and may also include beads. For example, the reagents may include reagents for constructing a library of oligonucleotides.

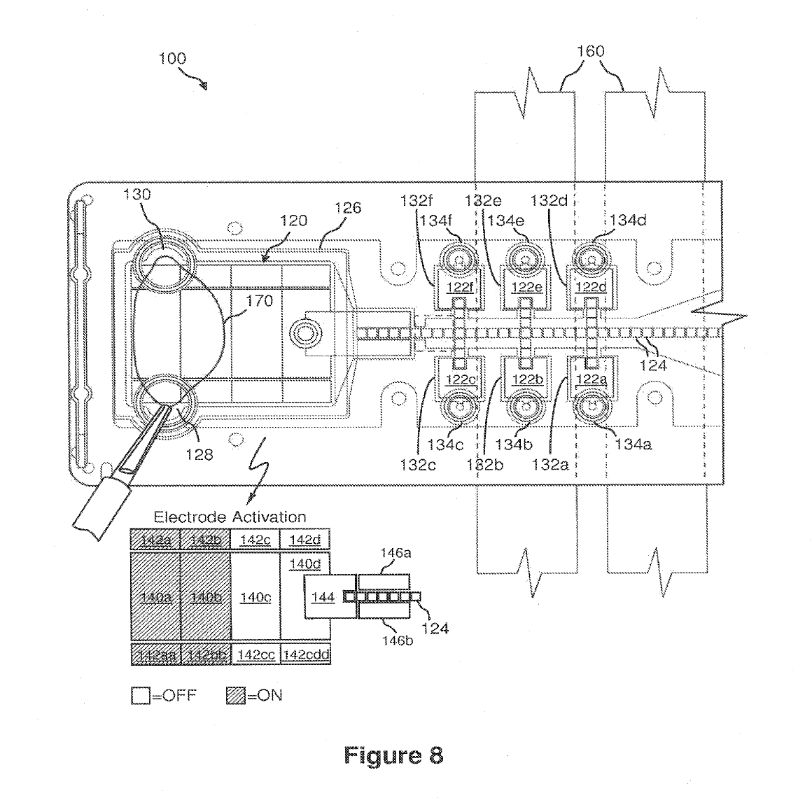

Generally, the example fluid mixing and dispensing process of the invention begins with an elongated droplet that is then deformed into a C- or U-shaped droplet. The C- or U-shaped droplet is then broken off into two or more sub-droplets. This is followed by merging the broken droplets. Accordingly and referring to FIGS. 8 through 24, the example fluid mixing and dispensing process of the invention may include, but is not limited to, the following steps. Additionally, one or more steps or groups of steps of the example fluid mixing and dispensing process may be repeated any number of times.

Referring to FIG. 8, at this step, a volume of a first type of fluid, such as sample fluid 170, is injected into sample reservoir 126 through, for example, input port 128. At the same time, segmented reservoir electrodes 140a and 140b and reservoir flanking electrodes 142a, 142b, 142aa, and 142bb are activated. Consequently, the volume of sample fluid 170 forms an elongated droplet at segmented reservoir electrodes 140a and 140b and reservoir flanking electrodes 142a, 142b, 142aa, and 142bb. Optionally, at this step, sample fluid 170 is injected into sample reservoir 126 with no electrodes activated.

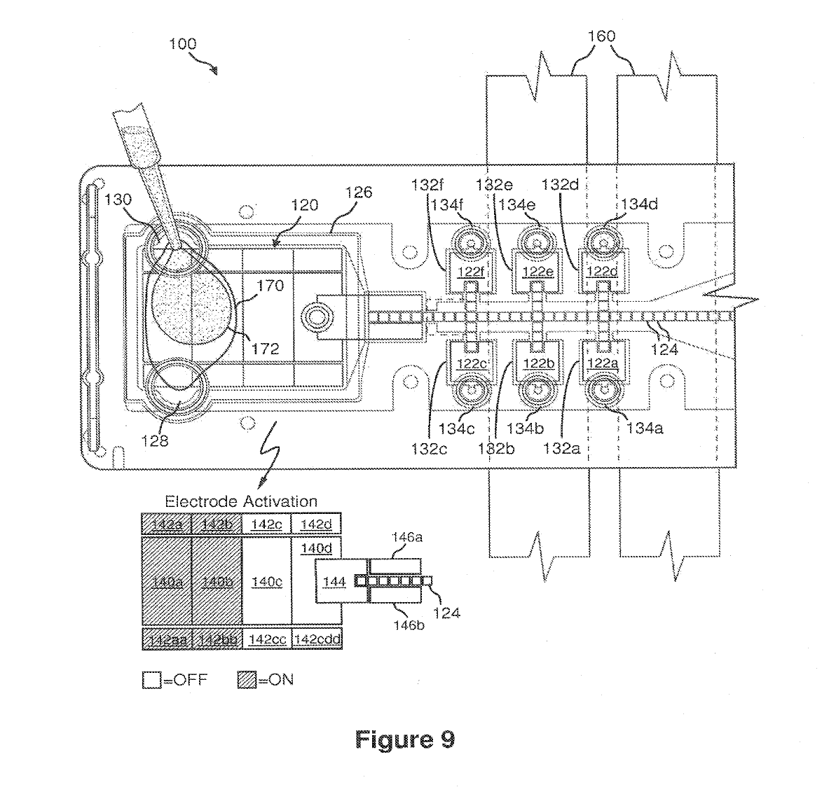

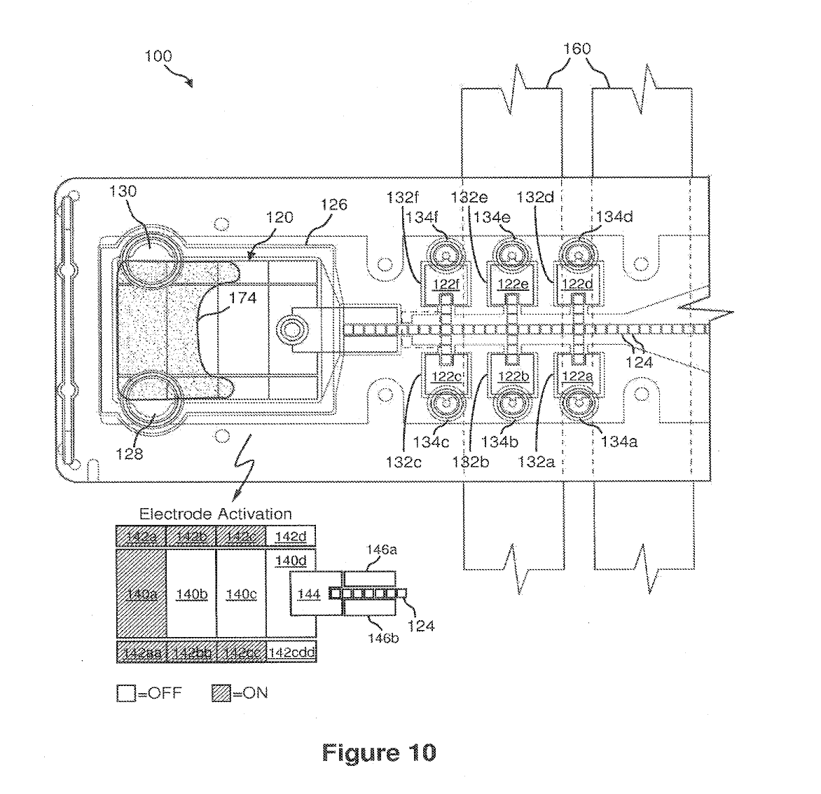

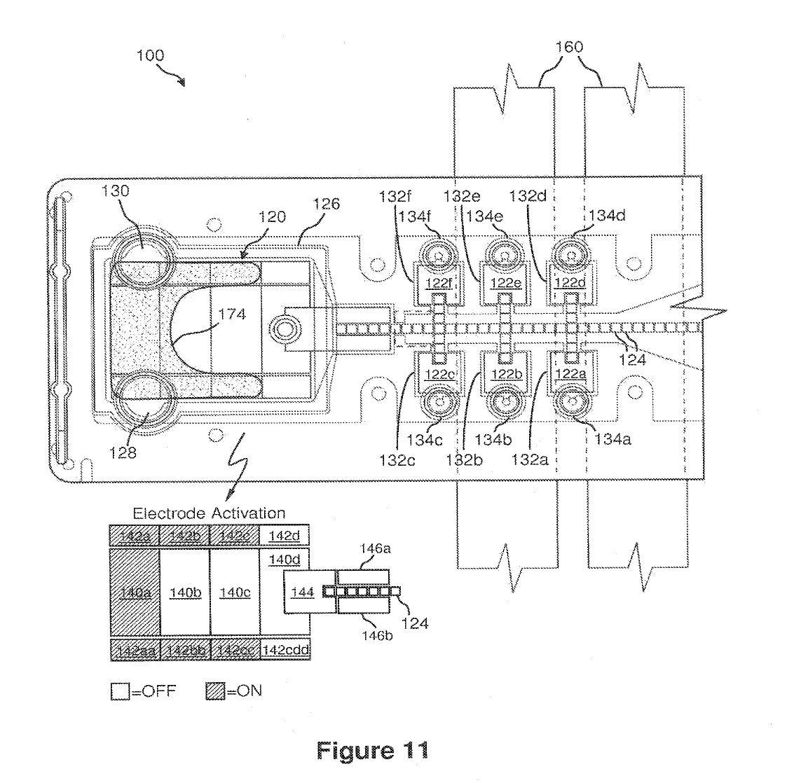

Referring to FIG. 9, at this fluid mixing step, a volume of a second type of fluid, such as reagent fluid 172, is injected into sample reservoir 126 through, for example, input port 130. At the same time, segmented reservoir electrodes 140a and 140b and reservoir flanking electrodes 142a, 142b, 142aa, and 142bb are activated. Consequently, an elongated droplet that contains both sample fluid 170 and reagent fluid 172 forms at segmented reservoir electrodes 140a and 140b and reservoir flanking electrodes 142a, 142b, 142aa, and 142bb. Optionally, at this step, reagent fluid 172 is injected into sample reservoir 126 with no electrodes activated. Once both the sample fluid 170 and reagent fluid 172 are present in sample reservoir 126, mixing operations and dispensing operations ensue, as described with reference to FIGS. 10 through 24.

Referring to FIG. 10, at this step, a fluid 174 begins to form, which is the mixture of both sample fluid 170 (FIG. 8) and reagent fluid 172 (FIG. 9). The mixing process begins by activating segmented reservoir electrode 140a and reservoir flanking electrodes 142a, 142b, 142c, 142aa, 142bb, and 142cc. This causes the volume of fluid 174 to begin forming a C- or U-shaped droplet upon segmented reservoir electrodes 140a, segmented reservoir electrode 140a and reservoir flanking electrodes 142a, 142b, 142c, 142aa, 142bb, and 142cc. Mixing operations continue by manipulating the volume of fluid 174 within sample reservoir 126, as follows.

Referring to FIG. 11, at this fluid mixing step, segmented reservoir electrodes 140a, reservoir flanking electrodes 142a, 142b, 142c, 142aa, 142bb, and 142cc are still activated. The volume of fluid 174 flows yet further into the C- or U-shaped droplet until covering substantially all of segmented reservoir electrode 140a and reservoir flanking electrodes 142a, 142b, 142c, 142aa, 142bb, and 142cc.

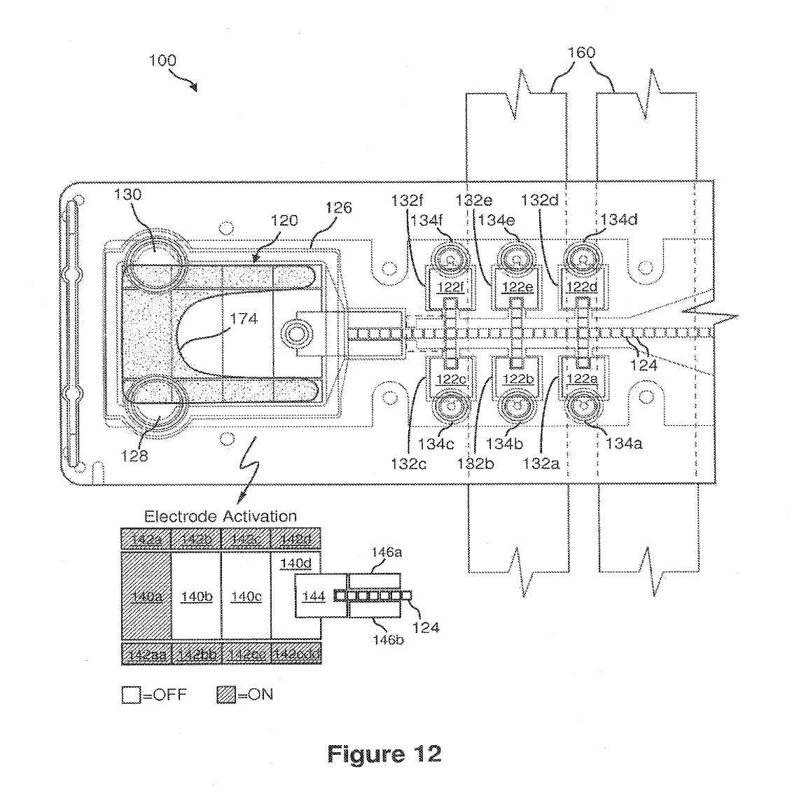

Referring to FIG. 12, at this fluid mixing step, in addition to segmented reservoir electrode 140a and reservoir flanking electrodes 142a, 142b, 142c, 142aa, 142bb, and 142cc are activated. Additionally, reservoir flanking electrodes 142d and 142dd are activated. The volume of fluid 174 flows yet further into the C- or U-shaped droplet until covering substantially all of segmented reservoir electrode 140a and reservoir flanking electrodes 142a, 142b, 142c, 142d, 142aa, 142bb, 142cc, and 142dd.

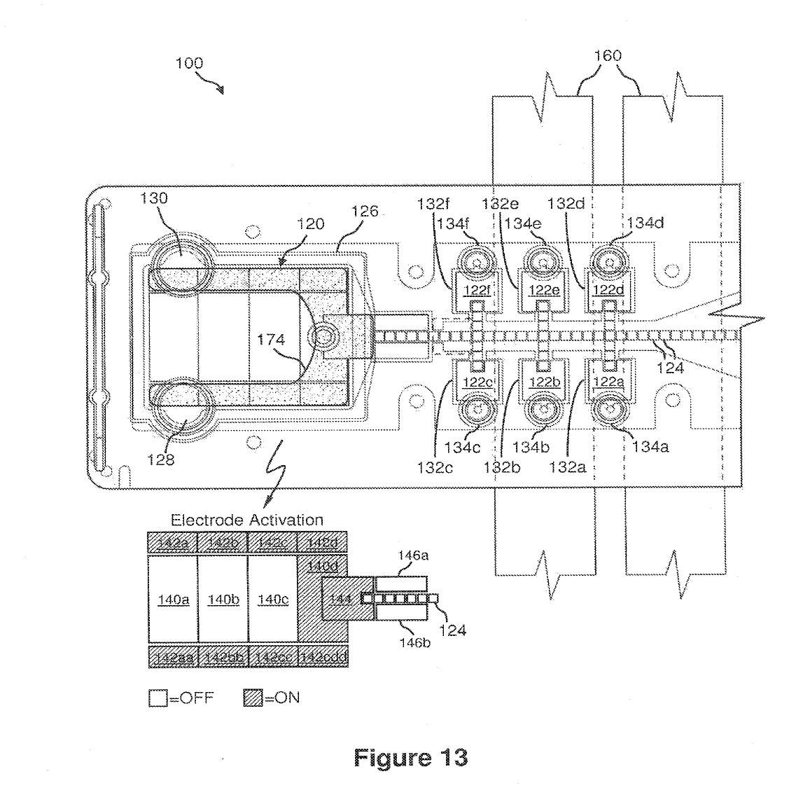

Referring to FIG. 13, at this step, reservoir flanking electrodes 142a, 142b, 142c, 142d, 142aa, 142bb, 142cc, and 142dd remain activated, while segmented reservoir electrode 140a is deactivated and segmented reservoir electrode 140d and priming electrode 144 are activated. Consequently, a volume of fluid 174 shifts from segmented reservoir electrode 140a to segmented reservoir electrode 140d and to priming electrode 144. This has the effect of reversing the orientation of the C- or U-shaped droplet of fluid 174.

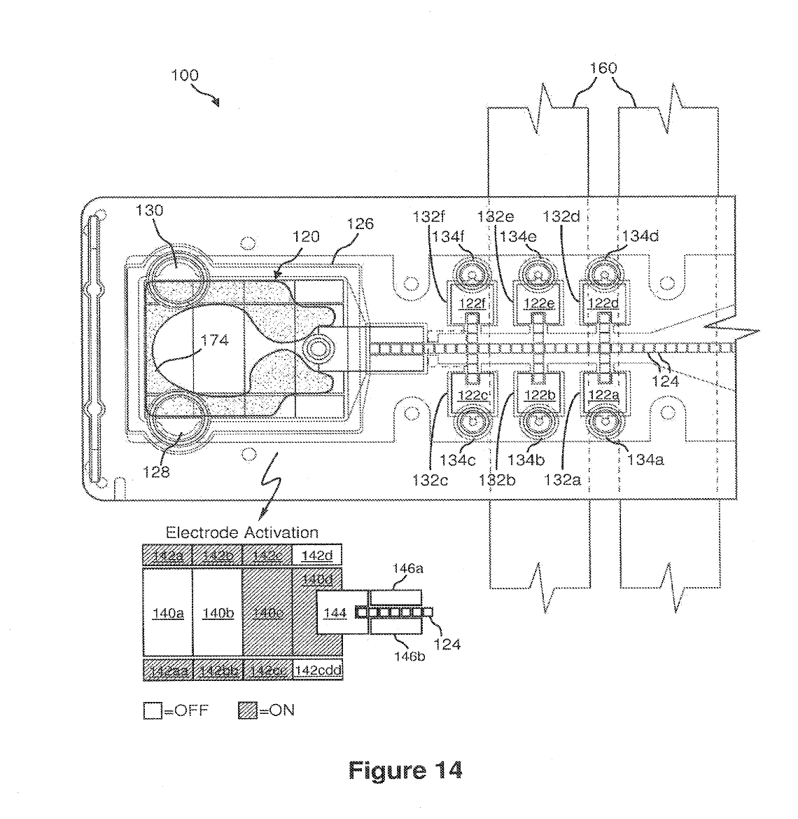

Referring to FIG. 14, at this step, segmented reservoir electrodes 140c and 140d and reservoir flanking electrodes 142a, 142b, 142c, 142aa, 142bb, and 142cc are activated. This causes the volume of fluid 174 to begin collapsing back on itself.

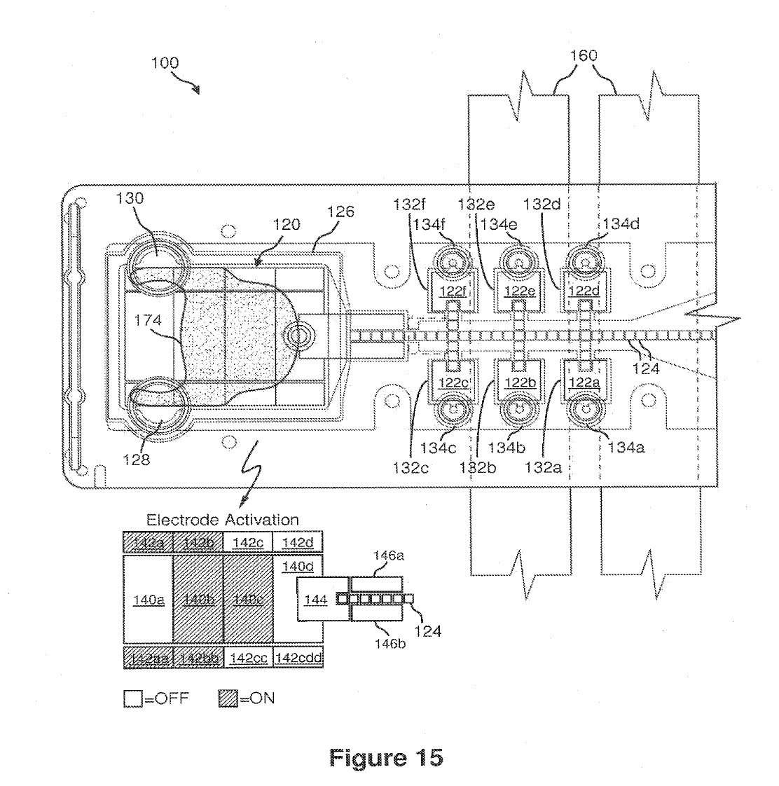

Referring to FIG. 15, at this step, segmented reservoir electrodes 140b and 140c and reservoir flanking electrodes 142a, 142b, 142aa, and 142bb are activated. This causes the volume of fluid 174 to begin forming one large droplet within sample reservoir 126.

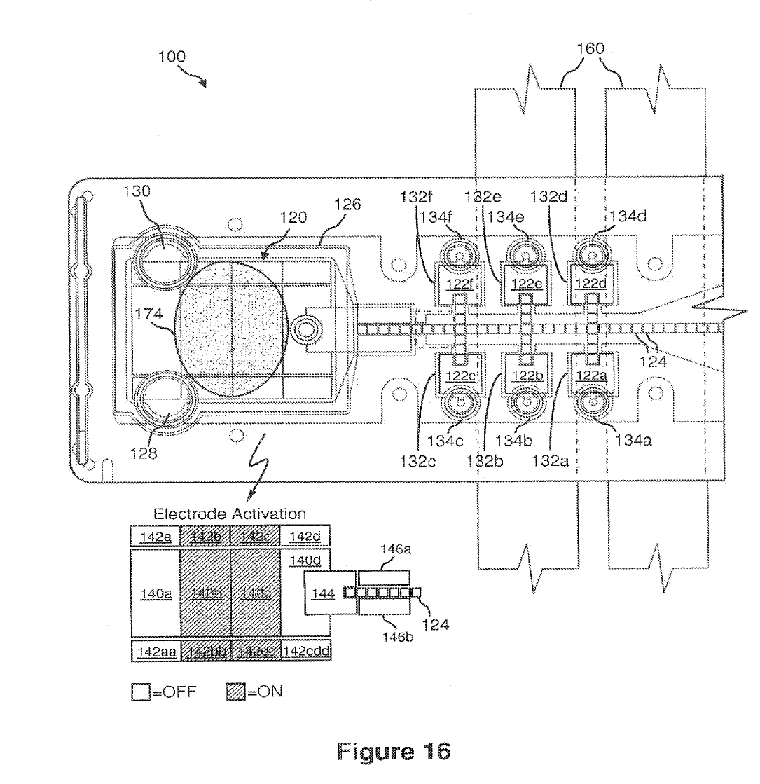

Referring to FIG. 16, at this step, segmented reservoir electrodes 140b and 140c and reservoir flanking electrodes 142b, 142c, 142bb, and 142cc are activated. This causes the volume of fluid 174 to collect in one large droplet at a central portion of sample reservoir 126.

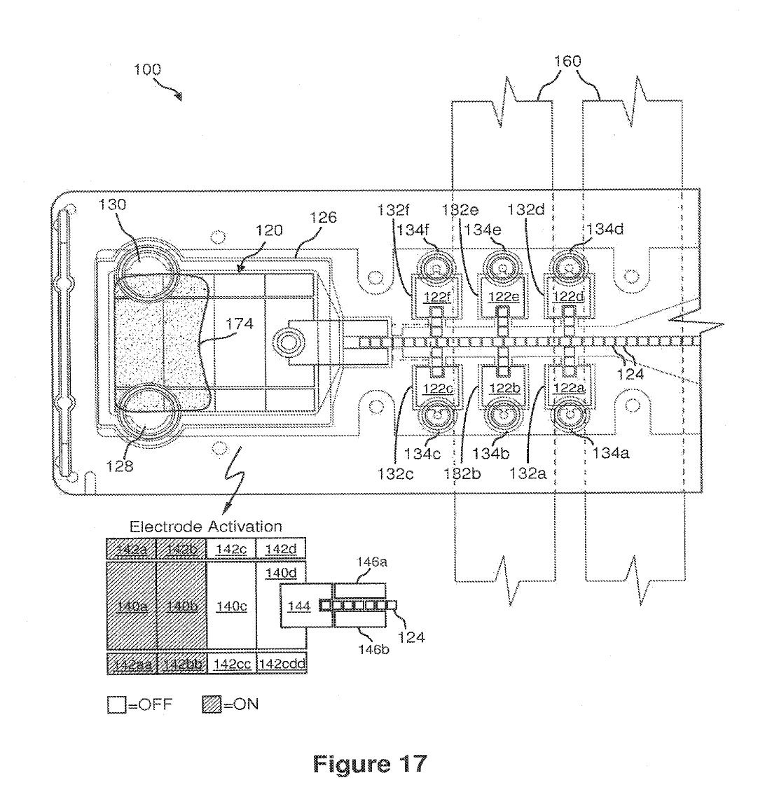

Referring to FIG. 17, at this step, segmented reservoir electrodes 140a and 140b and reservoir flanking electrodes 142a, 142b, 142aa, and 142bb are activated. This causes the volume of fluid 174 to shift to one side sample reservoir 126.

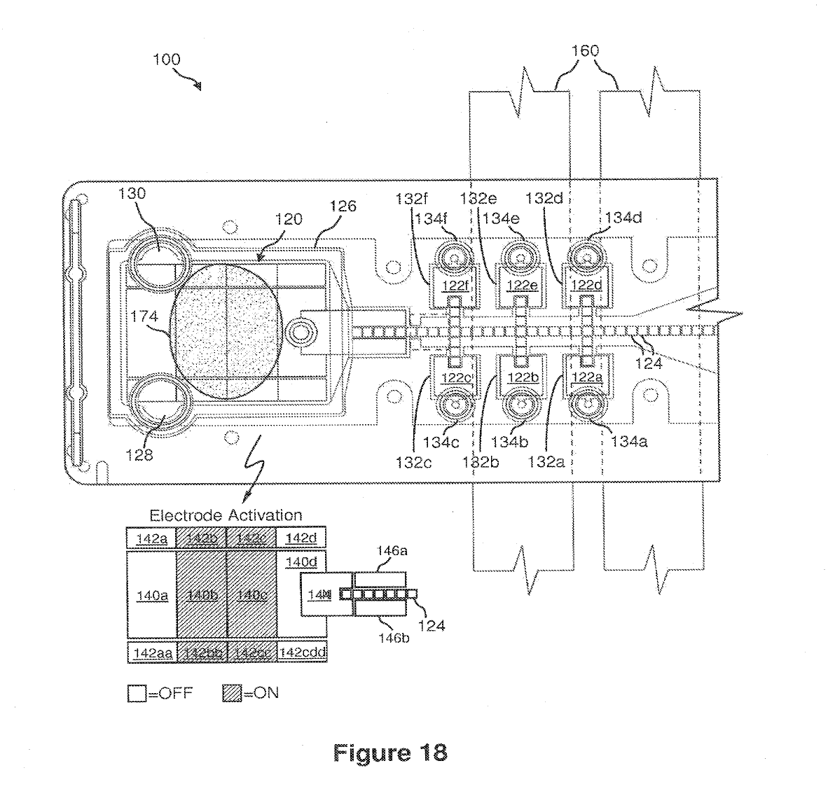

Referring to FIG. 18, at this step, segmented reservoir electrodes 140b and 140c and reservoir flanking electrodes 142b, 142c, 142bb, and 142cc are activated. This causes the volume of fluid 174 to shift back to about the center portion of sample reservoir 126. Optionally, the electrode activation sequence may toggle between the electrode activation shown in FIGS. 17 and 18 any number of times.

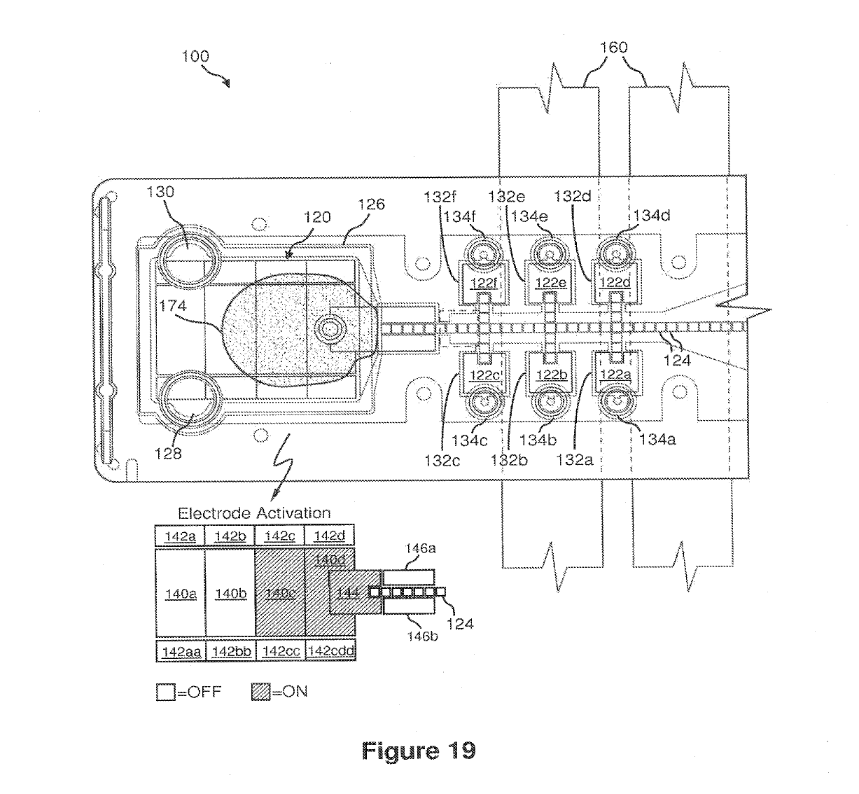

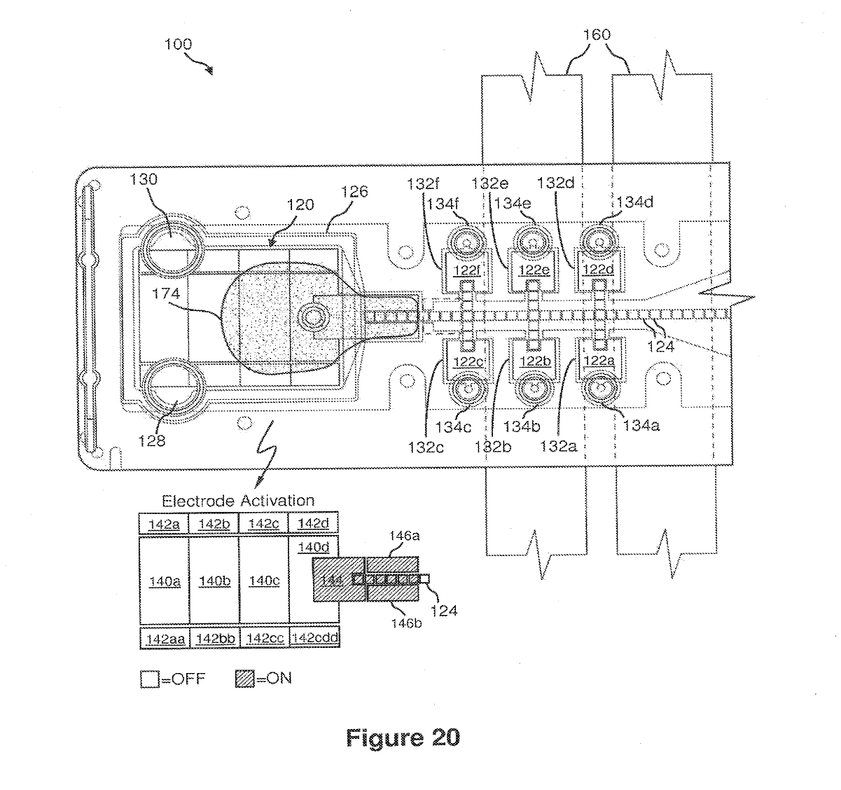

Referring to FIG. 19, at this step, segmented reservoir electrodes 140c and 140d and priming electrode 144 are activated. This causes the volume of fluid 174 to shift toward the dispensing side of sample reservoir 126. Collectively, the aforementioned fluid manipulation operations of FIGS. 10 through 19 serve to mix the original two fluids, e.g., sample fluid 170 (FIG. 8) and reagent fluid 172 (FIG. 9). The result is a substantially uniform mixture of fluid 174. Droplet dispensing operations may ensue, as described below in FIGS. 20 through 24.

Referring to FIG. 20, at this dispensing step, priming electrode 144 and path flanking electrodes 146a and 146b are activated. Additionally, multiple droplet operations electrodes 124 are activated between path flanking electrodes 146a and 146b. This causes a finger of fluid 174 to pull onto path flanking electrodes 146a and 146b and onto the multiple droplet operations electrodes 124.

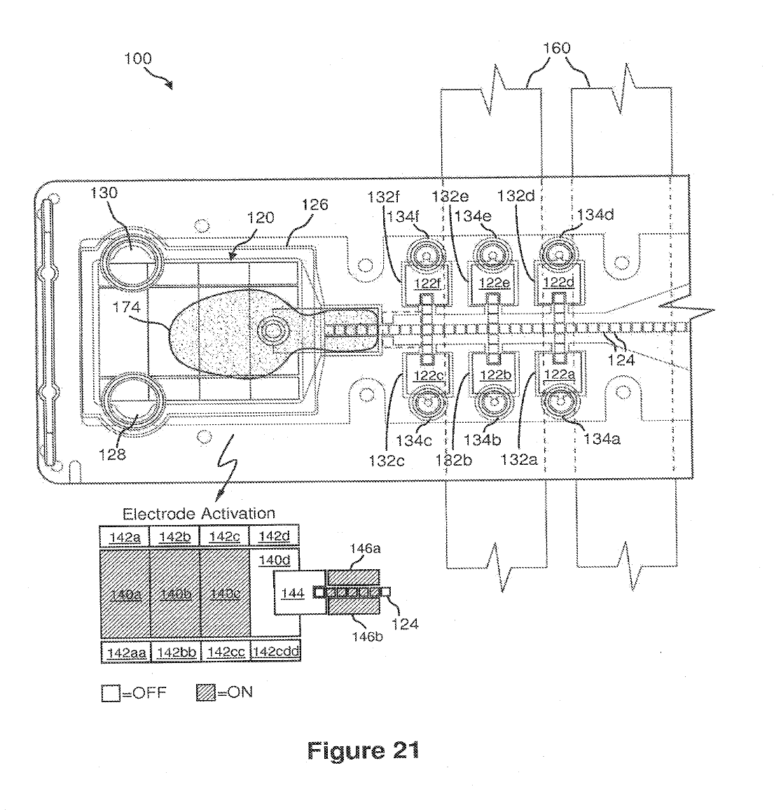

Referring to FIG. 21, at this dispensing step, segmented reservoir electrodes 140a, 140b and 140c and path flanking electrodes 146a and 146b are activated. Additionally, multiple droplet operations electrodes 124 are activated between path flanking electrodes 146a and 146b. This causes some volume of fluid 174 to retreat back into sample reservoir 126, while a smaller portion of the volume of fluid 174 is held at path flanking electrodes 146a and 146b and at the multiple droplet operations electrodes 124.

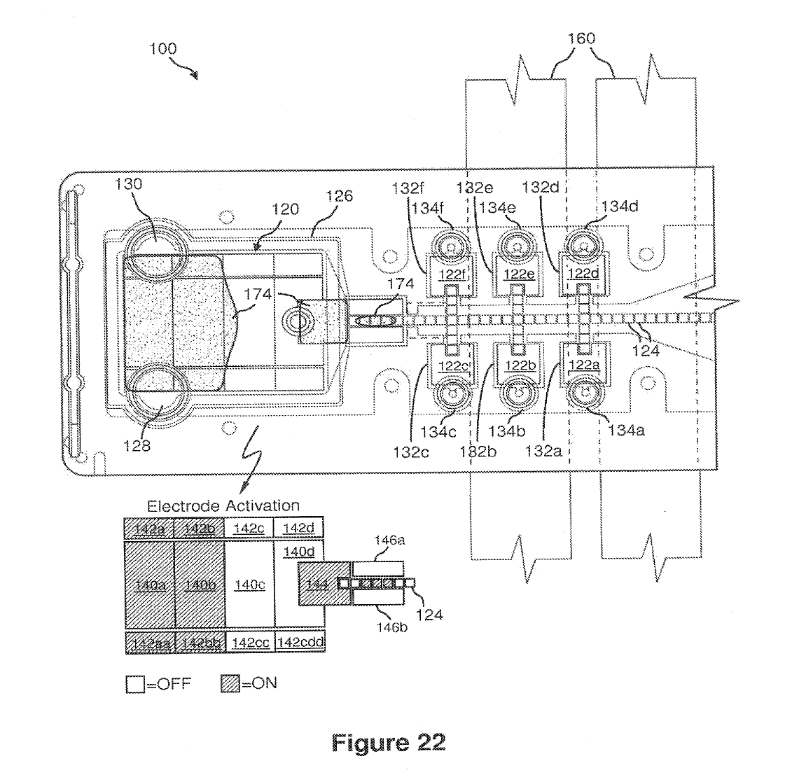

Referring to FIG. 22, at this dispensing step, segmented reservoir electrodes 140a and 140b, reservoir flanking electrodes 142a, 142b, 142aa and 142bb, and priming electrode 144 are activated. Additionally, about three droplet operations electrodes 124 are activated between path flanking electrodes 146a and 146b. This causes some volume of fluid 174 to split. That is, the largest volume of fluid 174 retreats back into sample reservoir 126, another smaller portion of fluid 174 is held at priming electrode 144, and a slug of fluid 174 is held across the three droplet operations electrodes 124.

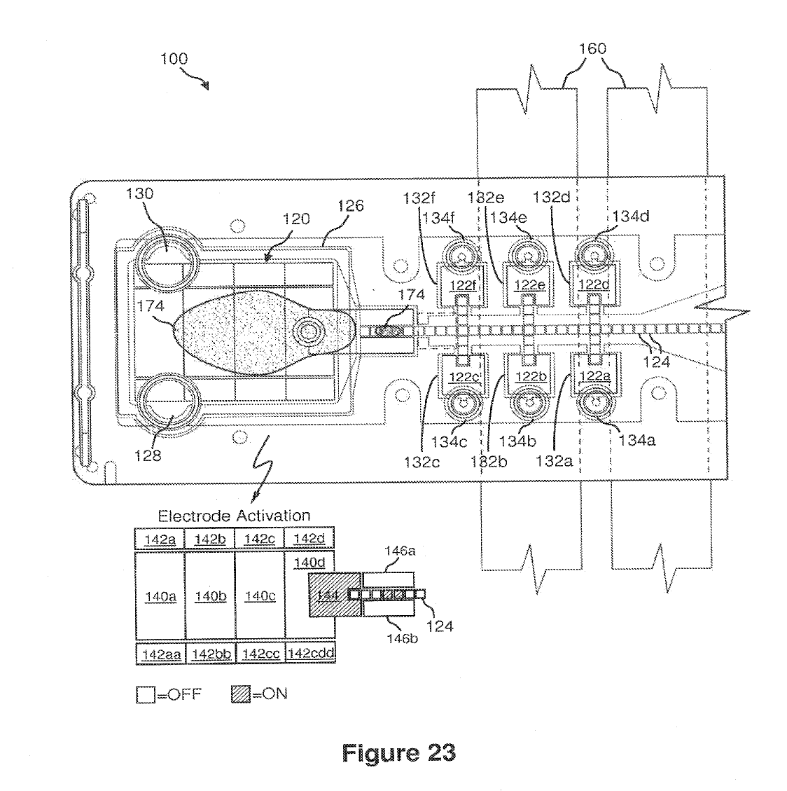

Referring to FIG. 23, at this dispensing step, priming electrode 144 is activated. Additionally, about two droplet operations electrodes 124 are activated between path flanking electrodes 146a and 146b. This causes the largest volume of fluid 174 that is in sample reservoir 126 to merge with the smaller portion of fluid 174 that is at priming electrode 144. At the same time, the slug of fluid 174 contracts onto the two droplet operations electrodes 124.

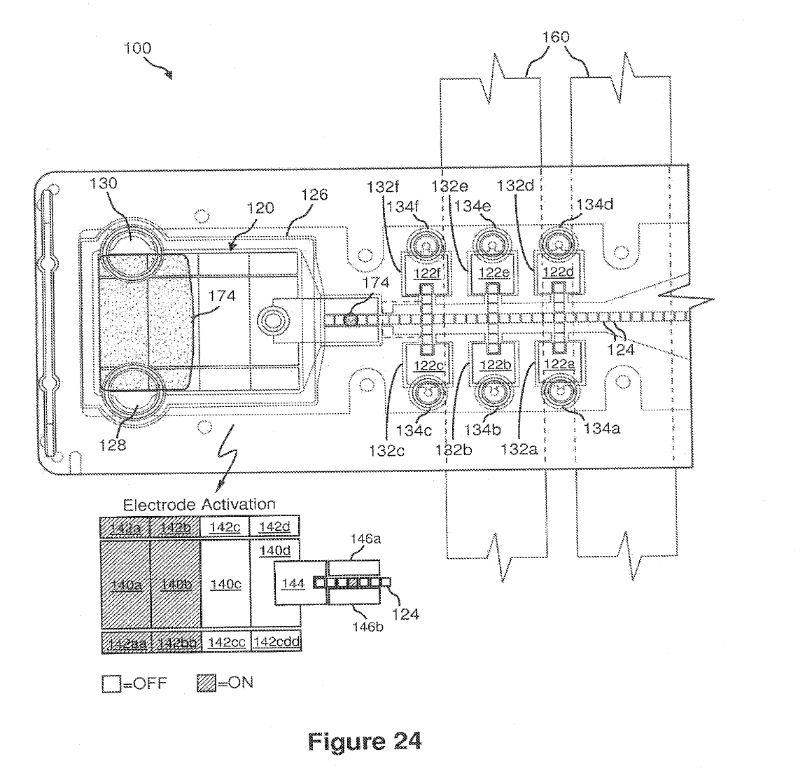

Referring to FIG. 24, at this dispensing step, segmented reservoir electrodes 140a and 140b and reservoir flanking electrodes 142a, 142b, 142aa, and 142bb are activated. Additionally, only one droplet operations electrode 124 is activated between path flanking electrodes 146a and 146b. This causes the volume of fluid 174 to pull back toward the non-dispensing side of sample reservoir 126. At the same time, a 1×-sized droplet of fluid 174 is formed on the one droplet operations electrode 124. This 1×-sized droplet of fluid 174 may then be processed using droplet operations according to any assay protocol.

### Second Example Sample-to-Answer Platform

In this example, the sample-to-answer digital microfluidics molecular diagnostic platform may use both liquids and certain dry substances, such as dry reagents, in a droplet actuator for performing sample-to-answer molecular assays (e.g., RT-PCR). Certain implementations for handling dried reagents in a droplet actuator may include, but are not limited to, (1) dry reagents and liquids on the droplet actuator cartridge in blister packs, (2) dry reagents and oil in the droplet actuator cartridge and rehydration in blister packs, (3) dry reagents and oil in the droplet actuator cartridge and rehydration as separate consumables, and (4) dry reagents on the droplet actuator cartridge and liquids as separate consumables. In a preferred embodiment, this example of the sample-to-answer digital microfluidics molecular diagnostic platform is described with respect to implementation (4), which is dry reagents on the droplet actuator cartridge and liquids as separate consumables. For example, the droplet actuator of the invention may include one or more reagent reservoirs that hold dried reagent material. Upon introducing rehydration solution to the dried reagent, the dried reagent may be reconstituted and reagent droplets may be dispensed.

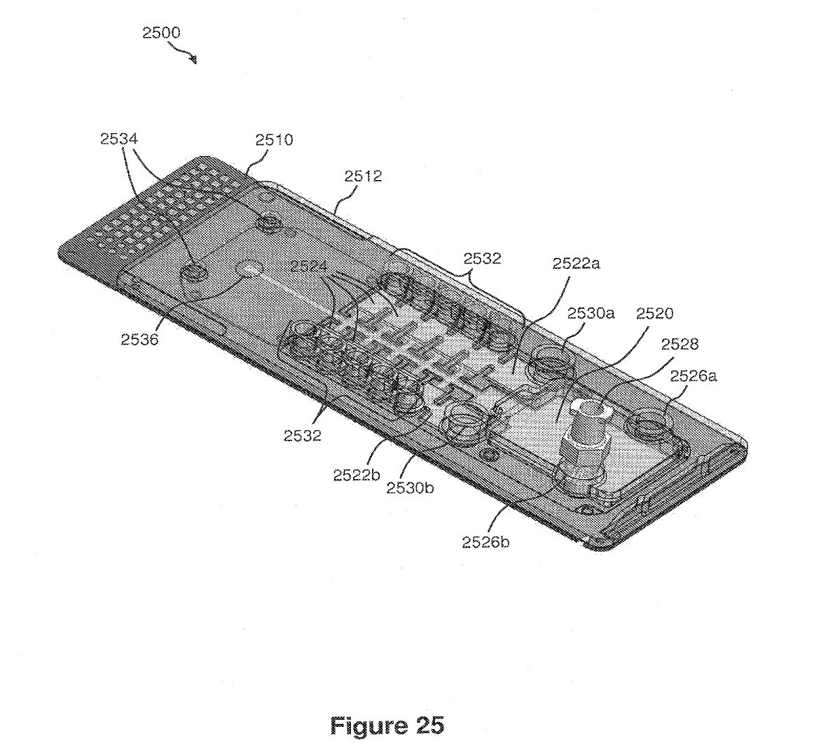

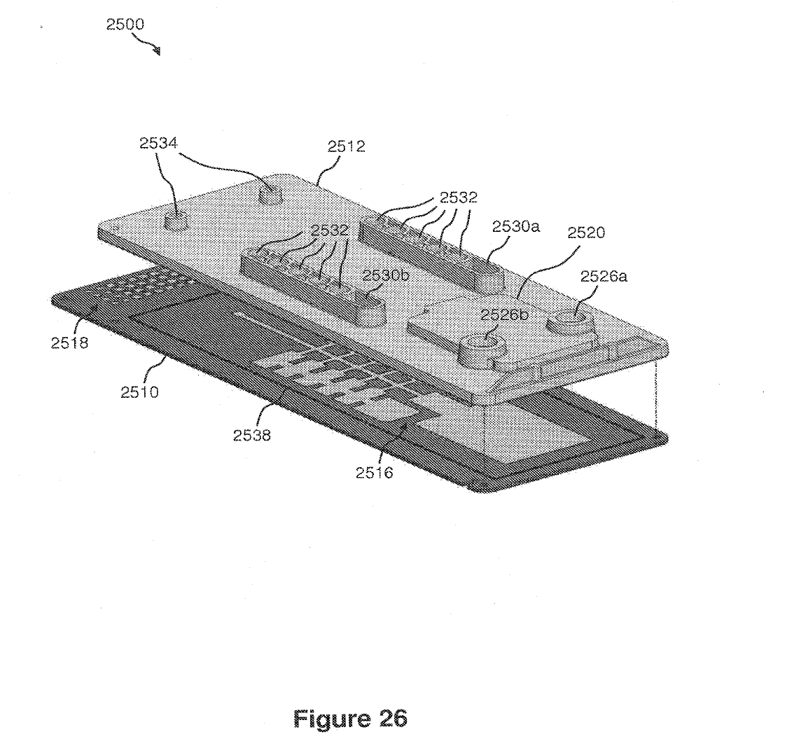

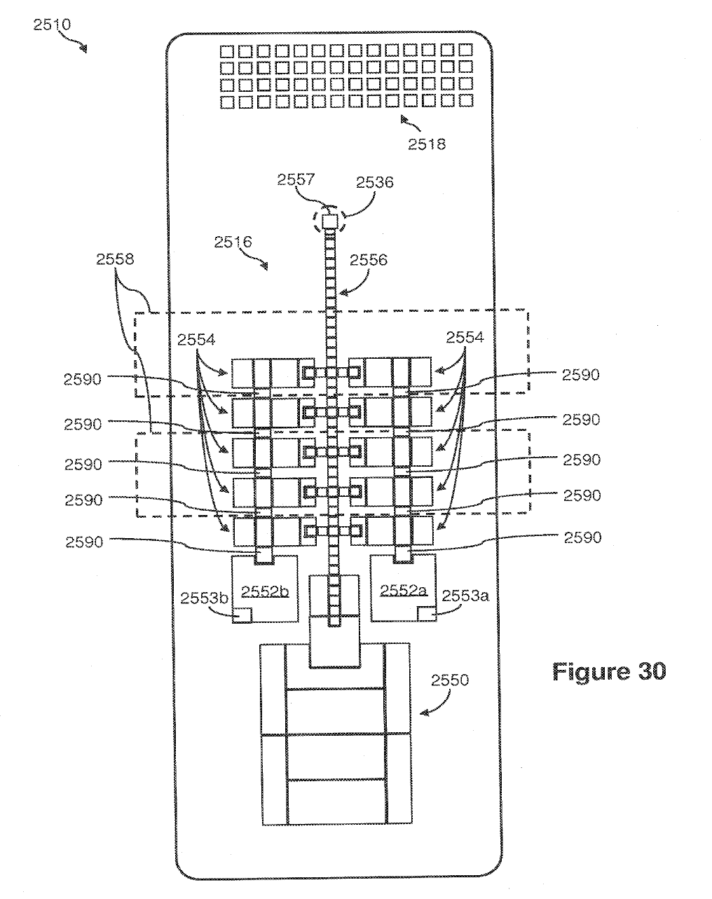

FIG. 25 illustrates a perspective view of an example of a droplet actuator 2500, which is another example of a sample-to-answer digital microfluidics molecular diagnostic platform. FIG. 25 shows droplet actuator 2500 when assembled, while FIG. 26 illustrates an exploded view of droplet actuator 2500. That is, FIG. 26 shows an exploded view of a bottom substrate 2510 with respect to a top substrate 2512 of droplet actuator 2500. Droplet actuator 2500 may include bottom substrate 2510 and top substrate 2512. A gasket (not shown) may be sandwiched between bottom substrate 2510 and top substrate 2512. In one example, bottom substrate 2510 may be a PCB that has an electrode arrangement 2516 and a set of power/signal I/O pads 2518 patterned thereon (see FIG. 26). More details of electrode arrangement 2516 and power/signal I/O pads 2518 are described with reference to FIG. 30.

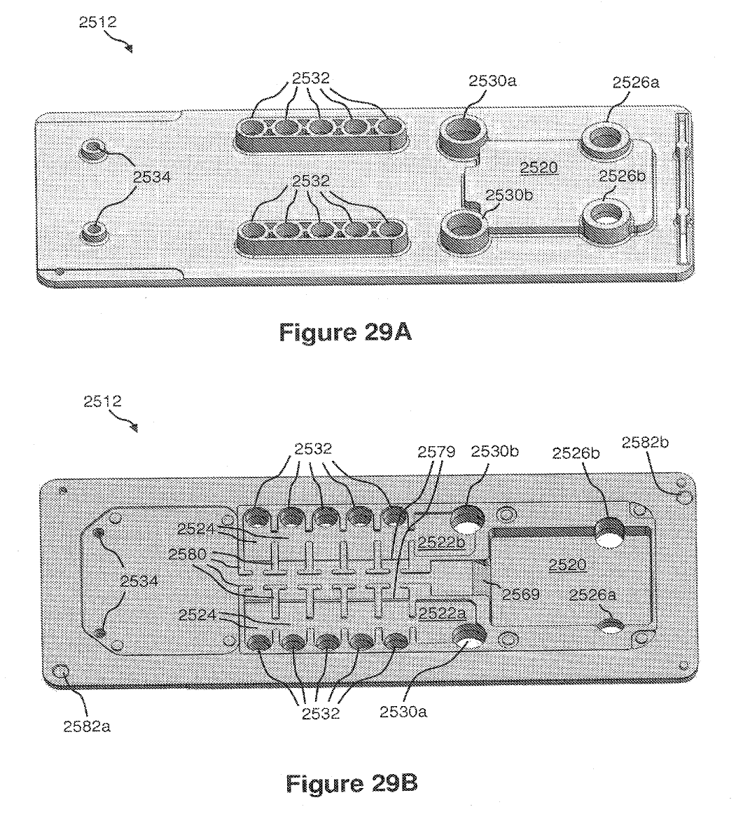

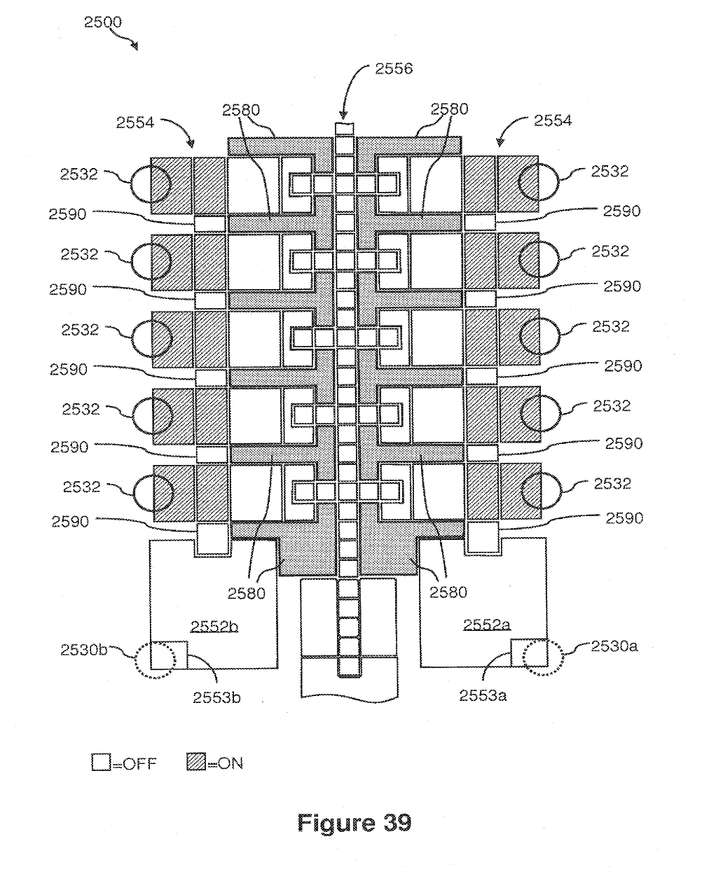

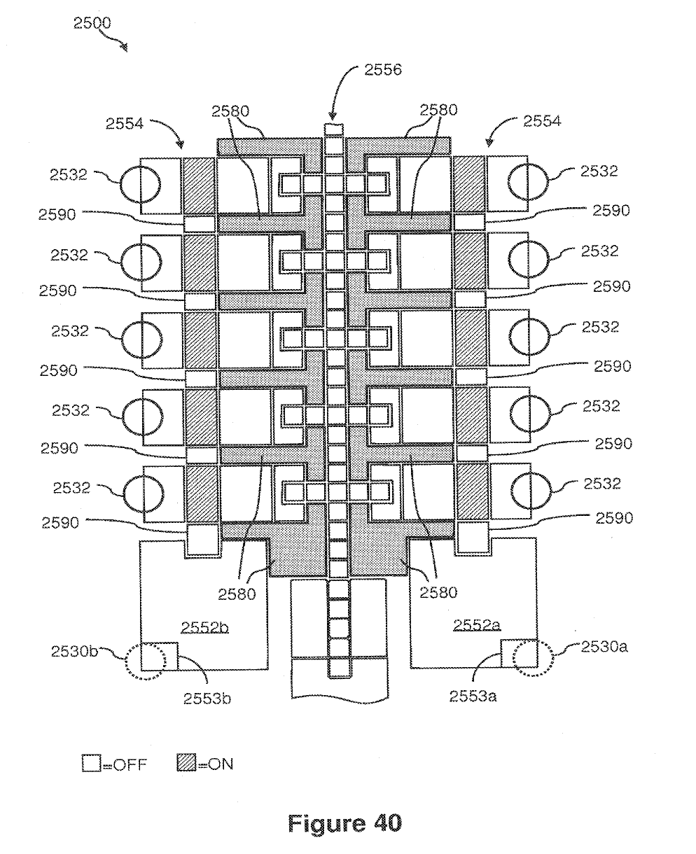

Top substrate 2512 may be formed of a material that is substantially transparent to visible light, UV light, and/or any wavelength light of interest. For example, top substrate 2512 may be formed of glass, injection-molded plastic, and/or silicon. Additionally, top substrate 2512 may be coated with ITO. Certain on-actuator reservoirs may be formed between bottom substrate 2510 and top substrate 2512 of droplet actuator 2500. Top substrate 2512 may include certain features for helping define the volume of the on-actuator reservoirs, such as shown in FIGS. 29A, 29B, 31, and 32. For example, droplet actuator 2500 may include a sample reservoir 2520, a rehydration reservoir 2522a that supplies a line of five reagent reservoirs 2524, and a rehydration reservoir 2522b that supplies another line of five reagent reservoirs 2524. The ten reagent reservoirs 2524 are for dispensing various reagent fluids. Additionally, droplet actuator 2500 includes a designated detection spot 2536. More details of top substrate 2512 are shown with reference to FIGS. 29A and 29B. Additionally, more details of droplet actuator 2500 are described below with reference to FIGS. 26 through 45.

Referring again to FIG. 26, a clearance region around the perimeter of bottom substrate 2510 and top substrate 2512 is provided to accommodate a bond line 2538. Bond line 2538 is, for example, a substantially continuous line of adhesive for bonding together bottom substrate 2510 and top substrate 2512. Once bonded together, a gap is present between bottom substrate 2510 and top substrate 2512 in the region at which droplet operations occur.

In one example, sample reservoir 2520 may have a capacity of about 1.5 mL. Sample reservoir 2520 may also function as a waste reservoir. One or more input ports 2526 may be integrated into top substrate 2512 for supplying sample reservoir 2520. For example, an input port 2526a in top substrate 2512 may be used for loading sample fluids into sample reservoir 2520. Additionally, an input port 2526b in top substrate 2512 may be used for loading other sample preparation fluids into sample reservoir 2520. In one example, a fitting 2528 may be installed in input port 2526b for loading fluids. For example, fitting 2528 may be used with a syringe. An input port 2530a may be integrated into top substrate 2512 for supplying rehydration solution to rehydration reservoir 2522a. An input port 2530b may be integrated into top substrate 2512 for supplying rehydration solution to rehydration reservoir 2522b. In one example, each rehydration reservoir 2522 may have a capacity of about 75 μL in order to provide about 15 μL of fluid to up to five reagent reservoirs 2524. Additional volume for each rehydration reservoir 2522 may be accommodated in its input port 2530. Rehydration reservoir 2522a and 2522b may be used once in the beginning of the protocol. Therefore, the entire liquid volume need not be stored inside droplet actuator 2500.

Reagent reservoirs 2524 may accept drop-loaded wet or dry reagents. A set of reagent loading ports 2532 may be integrated into top substrate 2512 by which the wet or dry reagents may be loaded into their respective reagent reservoirs 2524. In one example, each reagent reservoir 2524 may have a wet capacity of about 15 μL. With respect to dry capacity, each reagent reservoir 2524 may have a minimum volume capacity to accommodate 10 μL GE cakes and/or 15 μL Lyospheres. In one example, each reagent reservoir 2524 may dispense a minimum of 10 droplets when fully loaded.

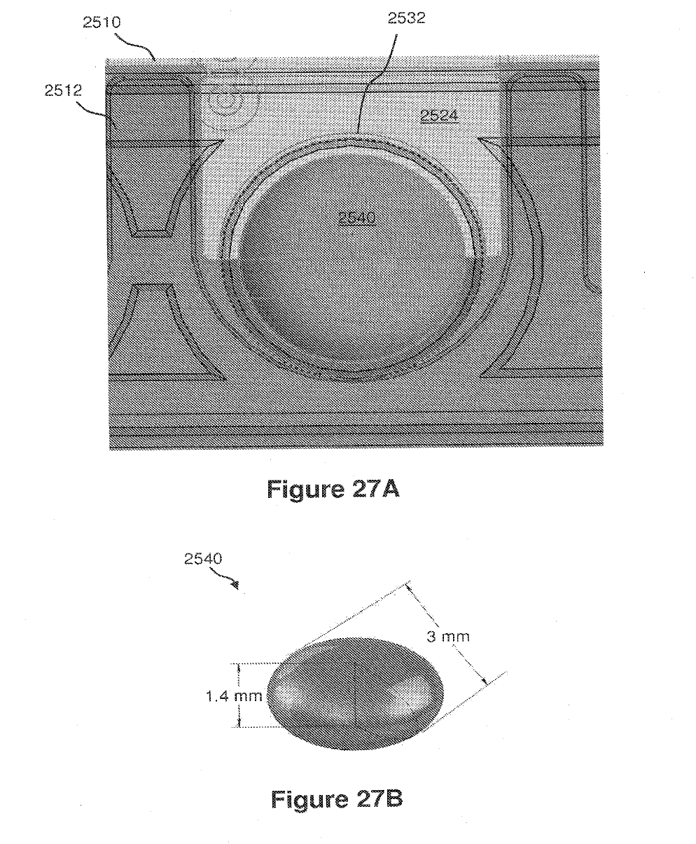

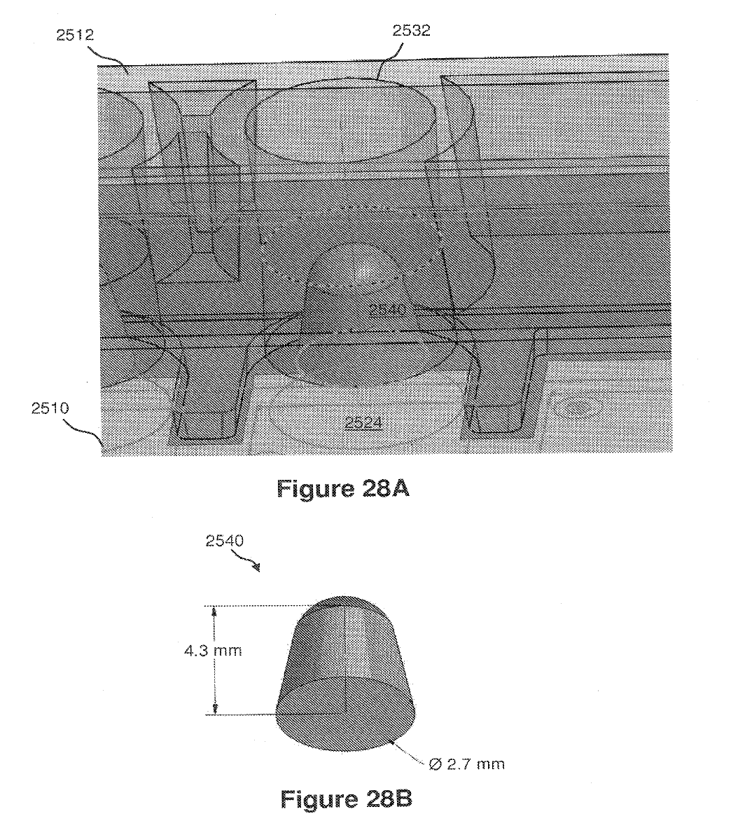

Reagent loading ports 2532 are used to place the dried reagent into droplet actuator 2500. Reagent loading ports 2532 are sized to accept the dried reagent. Any dried reagent is sized to fit into reagent reservoirs 2524 without moving into the droplet operations gap of droplet actuator 2500. More details about dried reagents are described with reference to FIGS. 27A, 27B, 28A, and 28B. Additionally, one or more vent holes 2534 may be integrated into top substrate 2512.

FIG. 27A illustrates a top down view of the portion of droplet actuator 2500 of FIG. 25 that includes one reagent reservoir 2524 and shows an example of a dried reagent 2540 installed therein. Dried reagent 2540 may come in a wide variety of three dimensional (3D) shapes, such as, but not limited to, beads, plugs, pellets, capsules, tablets, film, and the like. Dried reagent 2540 may come in symmetrical shapes or asymmetrical shapes. FIG. 27B shows dried reagent 2540 in the form of a tablet. FIG. 27A shows this tablet-shaped dried reagent 2540 installed in reagent reservoir 2524 of droplet actuator 2500.

FIG. 28A illustrates a perspective view of the portion of droplet actuator 2500 of FIG. 25 that includes one reagent reservoir 2524 and shows another example of dried reagent 2540 installed therein. FIG. 28B shows dried reagent 2540 in the form of a pellet. FIG. 28A shows this pellet-shaped dried reagent 2540 installed in reagent reservoir 2524 of droplet actuator 2500.

Droplet actuator manufacturing and dried reagent manufacturing may be performed separately. Dried reagents 2540 may be assembled with droplet actuator 2500. For example, reagent reservoirs 2524 are loaded with dried reagents 2540 and then the reagent loading ports 2532 are sealed with foil or plastic. This keeps the dried reagents 2540 separate from the liquid until the time of droplet actuator assembly. In one example, dried reagents 2540 may be adhered to the seals and held so that they will not fall into the gap of droplet actuator 2500. In another example, dried reagents 2540 may be sized to press fit into reagent loading ports 2532 without adhering to the seal.

Various dried reagents 2540 for the ten reagent reservoirs 2524 may be sized differently. For example, each reagent loading port 2532 and/or reagent reservoir 2524 may be sized uniquely for the amount of reagent needed. Additionally, in order to ensure that a certain type of dried reagent 2540 is installed in the desired reagent reservoir 2524, droplet actuator 2500 may include uniquely sized reagent loading ports 2532 and correspondingly sized dried reagents 2540.

Referring again to FIGS. 27A, 27B, 28A, and 28B, dried reagents 2540 are designed to dissolve easily with any contact by liquid. Accordingly, reagent loading ports 2532 are designed for suitable capillary action to facilitate the reconstitution process. In one example, the diameter of reagent loading ports 2532 may be about 4 mm. When installed in any reagent loading port 2532, the dried reagent 2540 is about half overlapping a reservoir electrode, which is used to help pull the reconstituted reagent in a certain direction for use. Various methods of drying the reagent material may be used, such as freeze drying, vacuum drying, hot air drying, and the like. Further, different reagents may have different stability requirements depending on their respective components.

Additionally, there may be a heat source (see FIG. 30) near reagent loading ports 2532 to assist the reconstitution process. Additionally, there may be a piezoelectric device (not shown) installed near reagent loading ports 2532 to provide shaking, again to assist the reconstitution process.

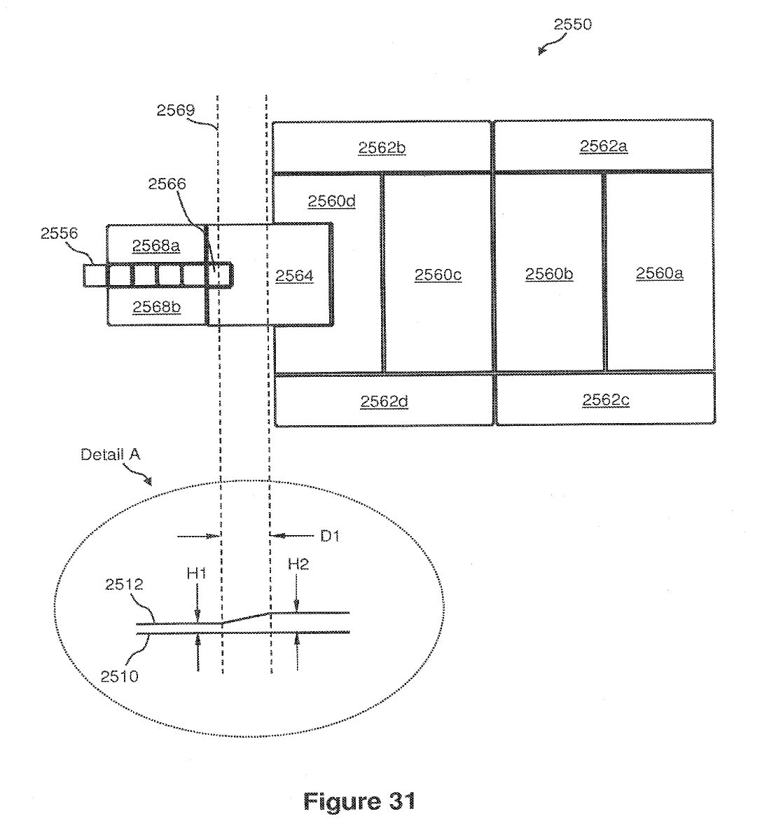

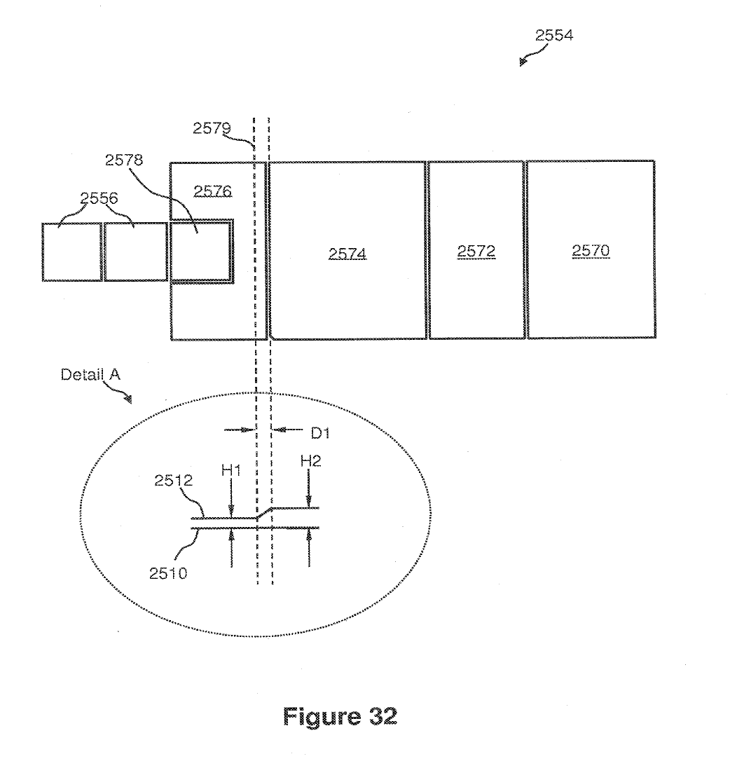

FIGS. 29A and 29B illustrate a perspective top side view and a perspective bottom side view, respectively, of top substrate 2512 of droplet actuator 2500 of FIG. 25. FIGS. 29A and 29B show other views of sample reservoir 2520 and its input ports 2526a and 2526b, rehydration reservoir 2522a and its input port 2530a, rehydration reservoir 2522b and its input port 2530b, reagent reservoirs 2524 and their reagent loading ports 2532, and vent holes 2534. Additionally, top substrate 2512 includes a gap height transition region 2569 (see FIGS. 29B and 31) at sample reservoir 2520. Additionally, top substrate 2512 includes one gap height transition region 2579 (see FIGS. 29B and 32) at one set of five reagent reservoirs 2524 and another gap height transition region 2579 (see FIGS. 29B and 32) at the other set of five reagent reservoirs 2524. Referring to FIG. 29B, top substrate 2512 also includes multiple 3D barriers 2580, which help define the volume of rehydration reservoirs 2522 and reagent reservoirs 2524. Further, top substrate 2512 includes one or more recessed areas 2582 (e.g., recessed areas 2582a and 2582b) for containing conductive foam (not shown) between bottom substrate 2510 and top substrate 2512. The conductive foam is used for electrically coupling an electrical ground electrode (not shown) on top substrate 2512 with certain electrical circuitry on bottom substrate 2510.

FIG. 30 illustrates a top down view of bottom substrate 2510 of droplet actuator 2500 of FIG. 25 and shows an example of electrode arrangement 2516 for performing sample-to-answer molecular assays (e.g., RT-PCR). In one example, bottom substrate 2510 is a PCB that is about 45.24 mm wide and about 27.76 mm long. The set of power/signal I/O pads 2518 is patterned at one end of bottom substrate 2510, while electrode arrangement 2516 is patterned on the remaining area of bottom substrate 2510.

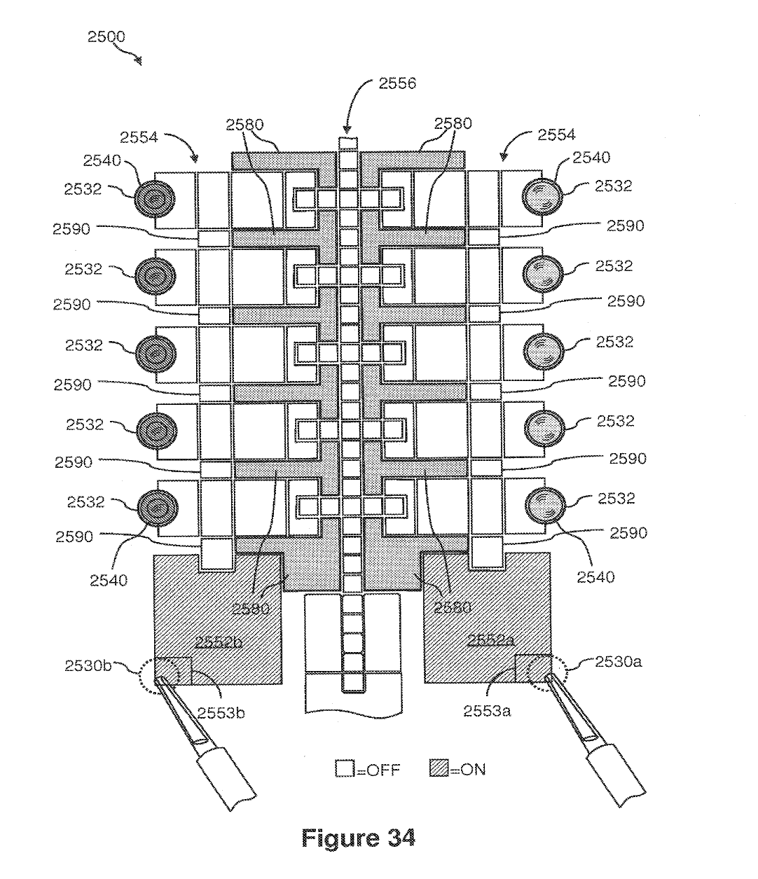

In one example, electrode arrangement 2516 may include a set of sample reservoir electrodes 2550 that support sample reservoir 2520. More details of the set sample reservoir electrodes 2550 are described with reference to FIG. 31. Electrode arrangement 2516 may also include a rehydration reservoir electrode 2552a that supports rehydration reservoir 2522a and a rehydration reservoir electrode 2552b that supports rehydration reservoir 2522b. In the corner of rehydration reservoir electrode 2552a that is near its input port 2530a (see FIG. 34) is a priming electrode 2553a. Likewise, in the corner of rehydration reservoir electrode 2552b that is near its input port 2530b (see FIG. 34) is a priming electrode 2553b. Priming electrodes 2553 may be used to assist in loading rehydration solution into rehydration reservoirs 2522, while the rehydration reservoir electrodes 2552 may serve as the primary storage electrode.

Electrode arrangement 2516 may also include five sets of reagent reservoir electrodes 2554 that support one set of five reagent reservoirs 2524. Electrode arrangement 2516 may also include another five sets of reagent reservoir electrodes 2554 that support the other set of five reagent reservoirs 2524. More details of a set of reagent reservoir electrodes 2554 are described with reference to FIG. 32. Additionally, certain rehydration electrodes 2590 complete the path from each rehydration reservoir electrode 2552 to its corresponding sets of reagent reservoir electrodes 2554.

The set of sample reservoir electrodes 2550, the two rehydration reservoir electrodes 2552, the ten sets of reagent reservoir electrodes 2554, and the rehydration electrodes 2590 are arranged in relation to a path, line, and/or array of droplet operations electrodes 2556 (e.g., electrowetting electrodes). In one example, a line and/or path of droplet operations electrodes 2556 may serve as a PCR lane. The set of sample reservoir electrodes 2550 is arranged at one end of the PCR lane and a detection electrode 2557 is arranged at the opposite end of the PCR lane. Additionally, rehydration reservoir electrode 2552a and five sets of reagent reservoir electrodes 2554 may be arranged on one side of the PCR lane, while rehydration reservoir electrode 2552b and the other five sets of reagent reservoir electrodes 2554 may be arranged on the other side of the PCR lane. Droplet operations are conducted atop these various electrodes on a droplet operations surface.

Detection electrode 2557 is associated with the designated detection spot 2536 of droplet actuator 2500. For example, detection electrode 2557 at the end of the PCR lane is used for retaining a droplet during the detection operation (i.e., during imaging). In one example, the dimensions of detection electrode 2557 may be about 2 mm×2 mm.

FIG. 30 also shows a heat source in relation to bottom substrate 2510 of droplet actuator 2500, when in use. In one example, the heat source may be two heater bars 2558 that are positioned near the ten sets of reagent reservoir electrodes 2554. In another example, the heat source may be local spot heaters, such as resistors, installed on bottom substrate 2510 (e.g., resistors on the PCB). Spot heaters may be less power than bulk heaters, such as heater bars 2558. There may be less bubble formation with localized heating as compared with large area heating. Also, the use of spot heaters may minimize the stress on the bond line (e.g., bond line 2538).

FIG. 31 illustrates a top view of an example of an arrangement of sample reservoir electrodes 2550 that support sample reservoir 2520 of droplet actuator 2500 of FIG. 25. The arrangement of sample reservoir electrodes 2550 may be similar to sample dispensing electrode 120 of FIGS. 1 through 24. That is, like sample dispensing electrode 120, sample reservoir electrodes 2550 are an arrangement of multiple individually controlled electrodes.

For example, along the center of sample reservoir electrodes 2550 may be four segmented reservoir electrodes 2560a, 2560b, 2560c, and 2560d. Narrower reservoir flanking electrodes 2562a and 2562b may be arranged on one side of segmented reservoir electrodes 2560a, 2560b, 2560c, and 2560d. Narrower reservoir flanking electrodes 2562c and 2562d may be arranged on the other side of segmented reservoir electrodes 2560a, 2560b, 2560c, and 2560d. Segmented reservoir electrode 2560d of sample reservoir electrodes 2550 is arranged in relation to a priming electrode 2564. For example, segmented reservoir electrode 2560d may be arranged in relation to three sides of priming electrode 2564. Priming electrode 2564 is arranged in relation to a dispensing electrode 2566. For example, priming electrode 2564 may be arranged in relation to three sides of dispensing electrode 2566. Dispensing electrode 2566 is arranged in relation to the path, line, and/or array of droplet operations electrodes 2556 on which droplet may be dispensed (e.g., the PCR lane). Additionally, a path flanking electrode 2568a may be arranged on one side of droplet operations electrodes 2556, while a path flanking electrode 2568b may be arranged on the other side of droplet operations electrodes 2556. Droplet operations are conducted atop these various electrodes on a droplet operations surface. The set of sample reservoir electrodes 2550 that includes the multiple individually controlled electrodes supports a fluid reservoir that is designed to perform complex droplet mixing and/or droplet dispensing operations.

FIG. 31 also shows a Detail A, which shows a cross-sectional view of bottom substrate 2510 in relation to top substrate 2512 in the gap height transition region 2569 (see FIG. 29B) of top substrate 2512. There is a gap height H1 along droplet operations electrodes 2556. There is a gap height H2 along segmented reservoir electrodes 2560 and reservoir flanking electrodes 2562. In this example, there is a step in the profile of top substrate 2512 so that gap height H2 is greater than the gap height H1. There may be a taper in the profile of top substrate 2512 to facilitate the transition from gap height H2 to gap height H1. In one example, the taper spans a distance D1 of about 3000 μm. The change in gap height and the taper may be useful for pulling fluid back into the reservoir without activating any reservoir electrodes. In one example, H1 may be from about 50 to about 600 μm, or from about 400 to about 500 μm, or about 425 μm.

Priming electrode 2564 spans the gap height transition region 2569, for example, to be used for disposal in a wash protocol. Liquid can be held on dispensing electrode 2566, path flanking electrode 2568a, and path flanking electrode 2568b because these electrodes are at the small gap H1 (i.e., not at the larger gap H2).

FIG. 32 illustrates a top view of an example of an arrangement of reagent reservoir electrodes 2554 that support each reagent reservoir 2524 of droplet actuator 2500 of FIG. 25. Like the arrangement of sample reservoir electrodes 2550, reagent reservoir electrodes 2554 is an arrangement of multiple individually controlled electrodes.

For example, reagent reservoir electrodes 2554 may include a reconstitution electrode 2570, a feeding electrode 2572, a primary storage electrode 2574, and a dispense priming electrode 2576. In one example, feeding electrode 2572 has an area of about 10.12 mm² and may hold about 7.6 μL of fluid. In one example, primary storage electrode 2574 has an area of about 16.31 mm² and may hold about 12.2 μL of fluid.

Dispense priming electrode 2576 is arranged in relation to a dispensing electrode 2578. For example, dispense priming electrode 2576 may be arranged in relation to three sides of dispensing electrode 2578. Dispensing electrode 2578 is arranged in relation to the path, line, and/or array of droplet operations electrodes 2556 on which droplet may be dispensed (e.g., the PCR lane). Droplet operations are conducted atop these various electrodes on a droplet operations surface. The set of reagent reservoir electrodes 2554 that includes the multiple individually controlled electrodes supports a fluid reservoir that is designed to perform complex droplet mixing and/or droplet dispensing operations.

FIG. 32 also shows a Detail A, which shows a cross-sectional view of bottom substrate 2510 in relation to top substrate 2512 in the gap height transition region 2579 (see FIG. 29B) of top substrate 2512. There is a gap height H1 along dispense priming electrode 2576, dispensing electrode 2578, and droplet operations electrodes 2556. There is a gap height H2 along reconstitution electrode 2570, feeding electrode 2572, and primary storage electrode 2574. In this example, there is a step in the profile of top substrate 2512 so that gap height H2 is greater than the gap height H1. There may be a taper in the profile of top substrate 2512 to facilitate the transition from gap height H2 to gap height H1. In one example, the taper spans a distance D1. The change in gap height and the taper may be useful for pulling fluid back into the reservoir without activating any reservoir electrodes. In one example, H1 may be from about 50 to about 600 μm, or from about 400 to about 500 μm, or about 425 μm. In one example, H2 may be about 750 μm.

In this example, the gap height ratio is 750/425, which is 1.76. Library construction successfully uses a ratio of 2 using 0.05% TWEEN® 20 in aqueous phase and 0.01% Span 85 in 2 cSt silicone oil phase.

Referring again to FIGS. 30, 31, and 32, an aspect of the invention is that the arrangement of sample reservoir electrodes 2550 that supports sample reservoir 2520 and the arrangement of reagent reservoir electrodes 2554 that supports each reagent reservoir 2524 are designed to perform complex droplet mixing operations. The capability to perform complex droplet mixing operations is because the arrangement of sample reservoir electrodes 2550 and the arrangements of reagent reservoir electrodes 2554 include multiple individually controlled electrodes.

Another aspect of the invention is that when sample reservoir 2520 and/or any reagent reservoir 2524 are not fully filled, smaller volumes of fluid may be moved to the dispensing end thereof (using the individually controlled electrodes) for dispensing various sized droplets.

Yet another aspect of the invention is that, with respect to sample reservoir 2520, path flanking electrodes 2568, which are lateral to droplet operations electrodes 2556, may be activated to help pull the liquid out of the sample reservoir 2520 and onto the electrode path.

Yet another aspect of the invention is that sample reservoir 2520 and reagent reservoirs 2524 have large electrodes as compared with the unit-sized droplet operations electrodes 2556. Additionally, sample reservoir 2520 and reagent reservoirs 2524 have a larger gap height (see FIGS. 31 and 32) as compared with the gap height at the unit-sized droplet operations electrodes 2556.

Still another aspect of the invention is that, preferably, droplet actuator 2500 avoids gravity fed reservoirs (i.e., reservoirs on the top substrate that feed by gravity through a fluid path into the droplet operations gap), as gravity fed reservoirs are not reliable. Additionally, liquid may be injected into the droplet operations gap without applying voltage to any reservoir electrode.

Referring again to FIGS. 25 through 32, examples of reservoir capacity and reservoir use in droplet actuator 2500 are shown in Table 1 below.

TABLE 1
Examples of Reservoir Capacity and Use

| | | | Max | | |
|---|---|---|---|---|---|
| | | | Working | #of | |
| | | Capacity | Volume | Droplets | Reservoir |
| Reservoir Type | Fluid Type | (μL) | (μL) | Required | Function/Purpose |
| Sample reservoir | Urinary | 1500 | 750 | N/A | Store lysis beads; Store |
| 2520 | soluble | | | | binding beads; Receive |
| | thrombo- | | | | sample fluid; Dissolve lysis |
| | modulin | | | | and binding beads; |
| | (UTM) | | | | Mix (lysis and binding); |
| | | | | | Provide one droplet of |
| | | | | | magnetically responsive |
| | | | | | beads for washing. |
| Rehydration | Rehydration | 75-100 | 75 | N/A | Provide 15 μL to five reagent |
| reservoir 2522a | buffer | | | | reservoirs 2524 |
| Rehydration | Rehydration | 75-100 | 75 | N/A | Provide 15 μL to five reagent |
| reservoir 2522b | buffer | | | | reservoirs 2524 |
| Reagent reservoir | Wash 1 | 15 | 15 | 10 | Provide wash after lysis and |
| 2524a | | | | | binding |
| Reagent reservoir | Wash 2 | 15 | 15 | 10 | Provide wash after lysis and |
| 2524b | | | | | binding |
| Reagent reservoir | Wash 3 | 15 | 15 | 10 | |
| 2524c | | | | | |
| Reagent reservoir | Wash 4 | 15 | 15 | 10 | |
| 2524d | | | | | |
| Reagent reservoir | Elution | 15 | 15 | 1-2 | Provide elution buffer |
| 2524e | | | | | |
| Reagent reservoir | RT-PCR Mix | 15 | 15 | 1 | Provide PCR mix after |
| 2524f | | | | | elution |
| Reagent reservoir | Amplification | 15 | 15 | 1 | |
| 2524g | diluent | | | | |
| Reagent reservoir | SA-PE | 15 | 15 | 1 | |
| 2524h | | | | | |
| Reagent reservoir | Magnetically | 15 | 15 | 1 | Provide magnetically |
| 2524i | responsive | | | | responsive beads after PCR |
| | beads | | | | |
| Reagent reservoir | Calibration | 15 | 15 | 1 | Provide calibration beads for |
| 2524j | beads | | | | detection |
| Extraction reservoir | Final product | 2 | N/A | N/A | Provides ability to extract |
| | | | | | final product from droplet |
| | | | | | actuator |

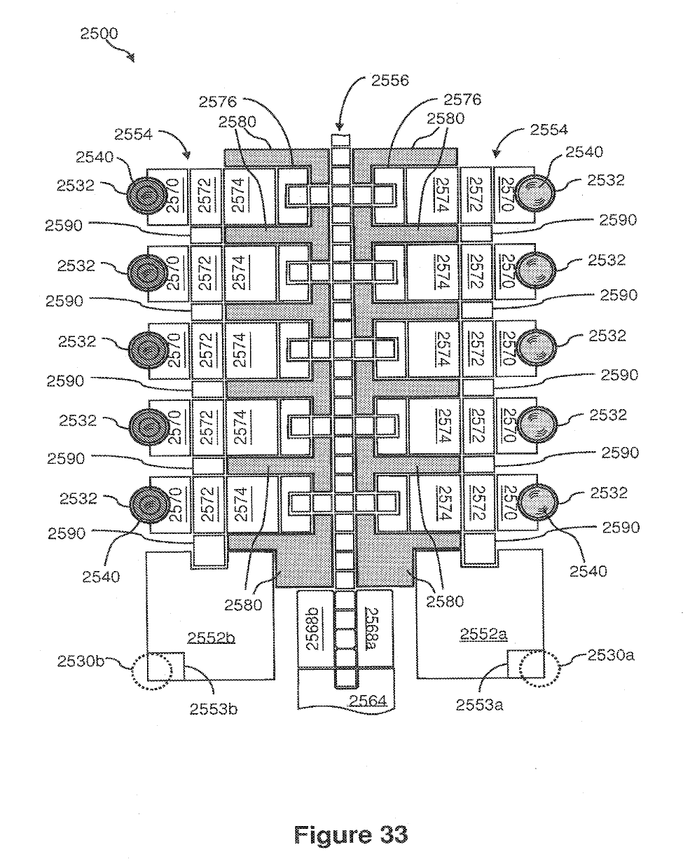

An example method of operation of droplet actuator 2500 may include (1) loading the dried reagents (e.g., dried reagent 2540) into the reagent loading ports 2532 of reagent reservoirs 2524; (2) loading (in any order) certain liquids, such as, but not limited to, filler oil, rehydration solution, liquid reagents, and sample fluid; (3) reconstituting the dried reagents, performing mixing operations, and performing dispensing operations; (4) performing the sample preparation processes, such as, but not limited to, lysis, binding, washing, and elution; and (5) performing assay protocols, such as, but not limited to, RT-PCR, dilution, hybridization, washing, and detection. More details of an example of the step of reconstituting the dried reagents are described with reference to FIGS. 33 through 45.

FIGS. 33 through 45 illustrate a top view of a portion of electrode arrangement 2516 of droplet actuator 2500 of FIG. 25 and a process of reconstituting dried reagents and dispensing reagent droplets. In particular, FIGS. 33 through 45 show an example of an electrode activation sequence for performing the rehydration protocol with respect to the dried reagents. FIGS. 33 through 45 also show another view of 3D barriers 2580 in relation to the various sets of reservoir electrodes and the manner in which 3D barriers 2580 help define the volume of each fluid reservoir. Additionally, FIGS. 33 through 45 show reagent loading ports 2532 of the reagent reservoirs 2524 in relation to the reservoir electrodes. Further, FIGS. 33 through 45 show input ports 2530 of the rehydration reservoirs 2522 in relation to the reservoir electrodes.

Referring to FIG. 33, droplet actuator 2500 is shown with dried reagents 2540 loaded into the reagent loading ports 2532 of the respective reagent reservoirs 2524. In this step, rehydration solution is not yet introduced into droplet actuator 2500 and, therefore, dried reagents 2540 are still in a substantially dry and solid state. No electrodes are activated.

Referring to FIG. 34, in this step, rehydration solution (not shown) is loaded into rehydration reservoir 2522a and rehydration reservoir 2522b. An example of rehydration solution is water. For example, rehydration reservoir electrode 2552a of rehydration reservoir 2522a and its priming electrode 2553a are activated. Rehydration reservoir electrode 2552b of rehydration reservoir 2522b and its priming electrode 2553b are also activated. Using, for example, a pipette or syringe, rehydration solution (not shown) is injected through input ports 2530a and 2530b. As a result of this step, about 75 μL of rehydration solution (not shown) may be atop rehydration reservoir electrode 2552a and priming electrode 2553a. Consequently, rehydration reservoir 2522a is staged to supply one set of five reagent reservoirs 2524. Likewise, about 75 μL of rehydration solution (not shown) is atop rehydration reservoir electrode 2552b and priming electrode 2553b. Consequently, rehydration reservoir 2522b is staged to supply the other set of five reagent reservoirs 2524. In another example, rehydration reservoir 2522a and rehydration reservoir 2522b are loaded with rehydration solution while activating only priming electrode 2553a and priming electrode 2553b (i.e., not activating rehydration reservoir electrode 2552a and rehydration reservoir electrode 2552b). In yet another example, rehydration reservoir 2522a and rehydration reservoir 2522b are loaded with rehydration solution while no electrodes are activated (i.e., not activating rehydration reservoir electrode 2552a, priming electrode 2553a, rehydration reservoir electrode 2552b, and priming electrode 2553b).

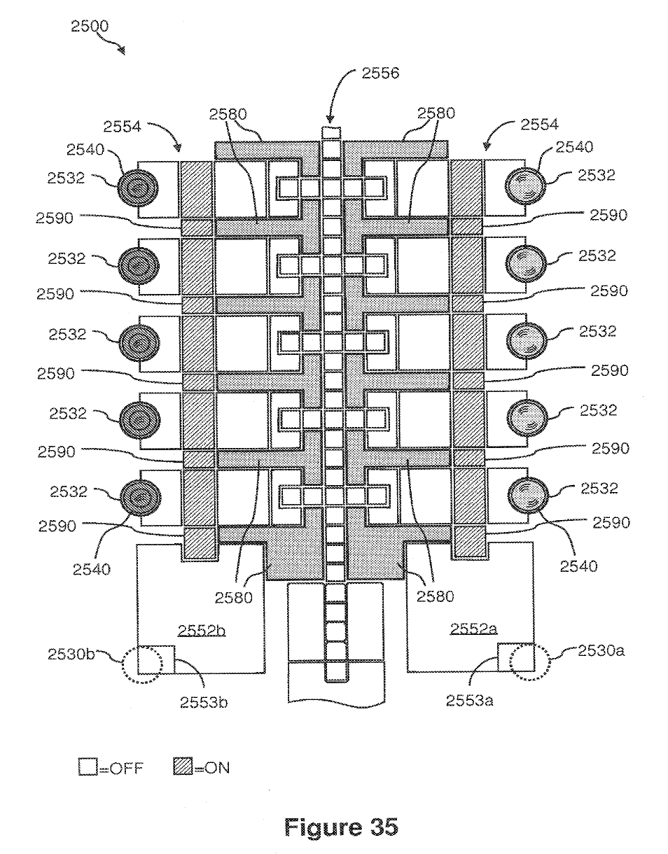

Referring to FIG. 35, in this step, rehydration solution (not shown) is drawn out of rehydration reservoir 2522a and into one set of five reagent reservoirs 2524. Rehydration solution (not shown) is also drawn out of rehydration reservoir 2522b and into the other set of five reagent reservoirs 2524. For example, rehydration reservoir electrode 2552a and priming electrode 2553a of rehydration reservoir 2522a are now deactivated. Likewise, rehydration reservoir electrode 2552b and priming electrode 2553b of rehydration reservoir 2522b are deactivated. The ten feeding electrodes 2572 of the ten reagent reservoirs 2524 as well as all the rehydration electrodes 2590 therebetween are activated. As a result, two rehydration lanes are formed. That is, an elongated volume of rehydration solution (not shown) is formed atop the two lines that are formed by feeding electrodes 2572 and rehydration electrodes 2590. Substantially the entire volume of rehydration solution that was originally loaded into rehydration reservoir 2522a and rehydration reservoir 2522b is pulled onto the two rehydration lanes in an elongated fashion.

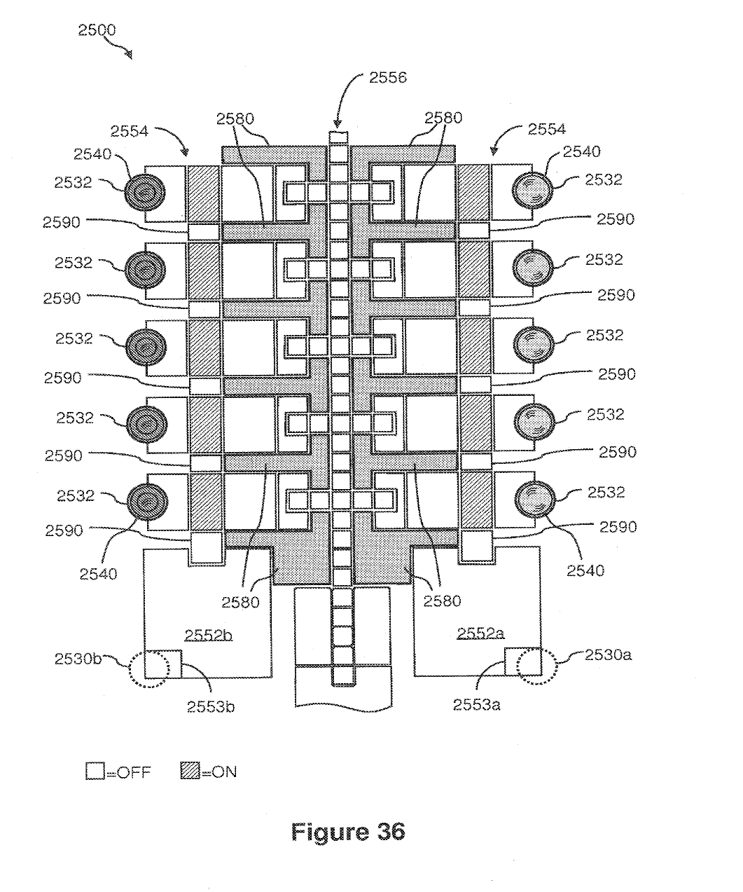

Referring to FIG. 36, in this step, a volume of rehydration solution (not shown) is concentrated at the ten feeding electrodes 2572 of the ten reagent reservoirs 2524. This step ensures that the rehydration solution does not come into contact with dried reagents 2540 until the fluid is fully isolated in each reagent reservoir 2524. For example, all the rehydration electrodes 2590 are now deactivated, leaving only the ten individual feeding electrodes 2572 of the ten reagent reservoirs 2524 activated. In this way, a volume of rehydration solution (not shown) is concentrated at each of the ten individual feeding electrodes 2572 of the ten reagent reservoirs 2524. As a result of this step, about 15 μL of rehydration solution (not shown) may be concentrated atop each of the ten individual feeding electrodes 2572.

In the design of droplet actuator 2500, the spacing of reagent loading ports 2532 of the reagent reservoirs 2524, which are holding the dried reagents 2540, with respect to feeding electrodes 2572 is important in order to maintain a certain spatial separation (in this step) between the rehydration solution (not shown) at the feeding electrodes 2572 and the dried reagents 2540. Further, in this step, the ten reconstitution electrodes 2570 of the ten reagent reservoirs 2524, which are near the ten instances of dried reagent 2540, are deactivated. Again, this is to help maintain a certain spatial separation between the rehydration solution at the feeding electrodes 2572 and the dried reagents 2540.

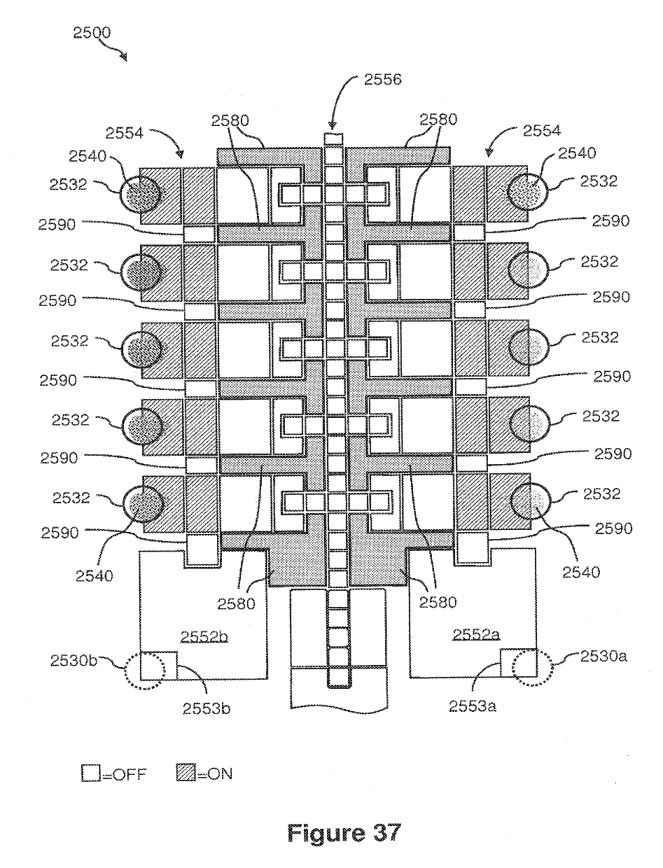

Referring to FIG. 37, in this step, rehydration solution (not shown) is brought into contact with the dried reagent 2540, thereby reconstituting the reagent material into the liquid state. For example, while the feeding electrodes 2572 of the ten reagent reservoirs 2524 remain activated, the ten reconstitution electrodes 2570 are also activated. As a result, the volume of rehydration solution at each reagent reservoir 2524 spreads across both the feeding electrode 2572 and the reconstitution electrode 2570. Once rehydration solution is atop any feeding electrode 2572, the liquid is pulled by capillary action into the reagent loading port 2532 and into contact with the dried reagent 2540. Consequently, the dried reagent 2540 begins to dissolve into and mix with the rehydration solution at each reagent reservoir 2524.

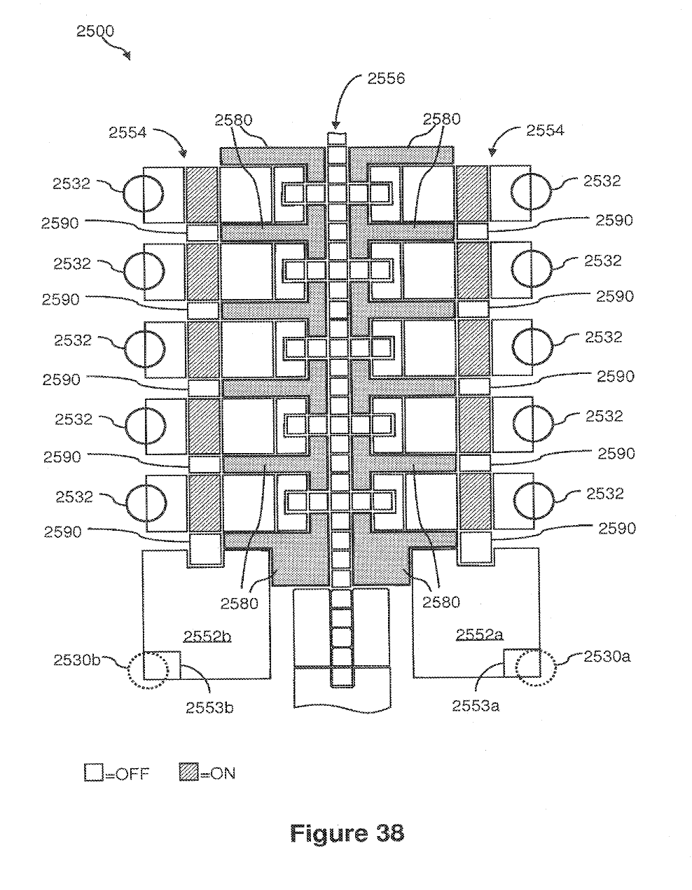

Referring to FIGS. 38, 39, and 40, the reagent material is mixed into the rehydration solution to form reagent fluid. At each reagent reservoir 2524, the liquid may be shuttled back and forth between the feeding electrode 2572 and the reconstitution electrode 2570 for mixing. For example, while holding the feeding electrodes 2572 active, the reconstitution electrodes 2570 may be toggled off and on any number of times in order to achieve sufficient mixing of the reconstituted reagent material and the rehydration solution to form reagent fluid. At the completion of this mixing step, the feeding electrodes 2572 are held active and the reconstitution electrodes 2570 are deactivated, leaving a volume of reagent fluid (not shown) atop each feeding electrode 2572 of each reagent reservoir 2524.

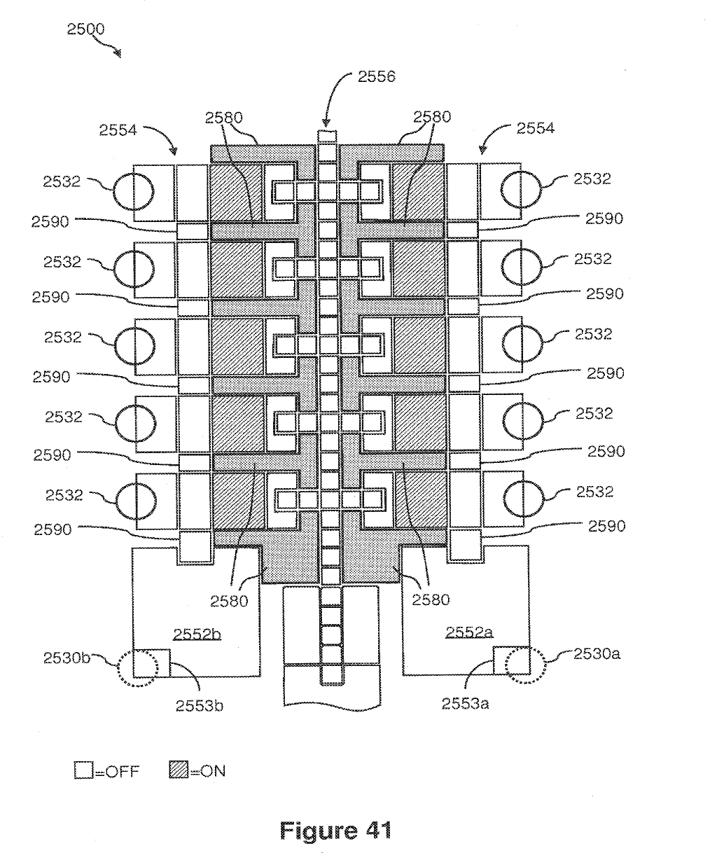

Referring to FIG. 41, in this step, the volume of reagent fluid (not shown) is shifted to the primary storage electrode 2574 of each reagent reservoir 2524. For example, the feeding electrodes 2572 of the reagent reservoirs 2524 are now deactivated and the primary storage electrodes 2574 of the reagent reservoirs 2524 are activated. As a result, at each reagent reservoir 2524, the volume of reagent fluid shifts from the feeding electrode 2572 to the primary storage electrode 2574. At the completion of this step, a volume of reagent fluid (not shown) is atop the primary storage electrode 2574 of each reagent reservoir 2524. The reagent fluid is now staged for dispensing reagent droplets.

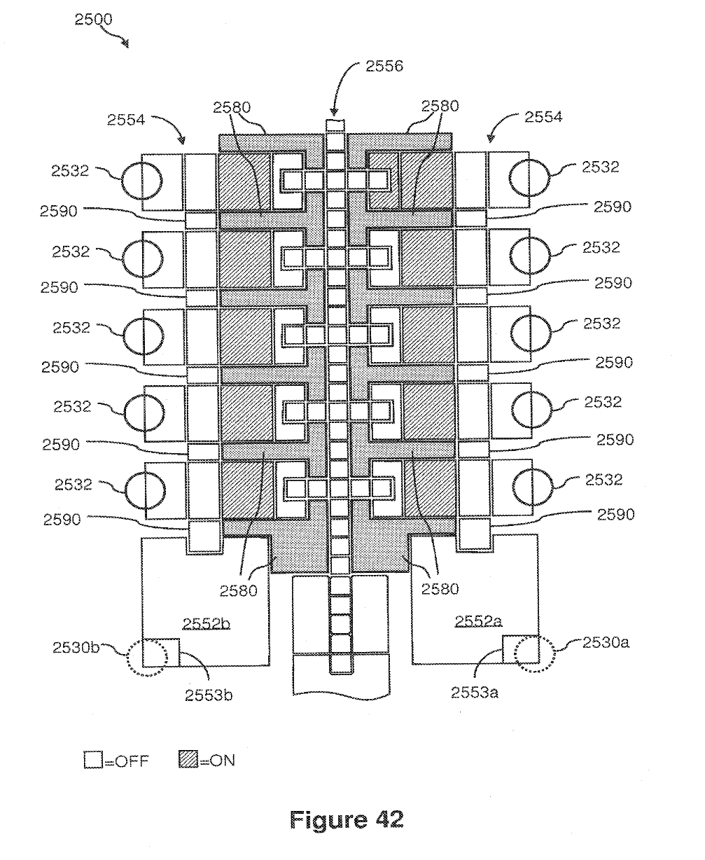

Referring to FIGS. 42 through 45, a reagent droplet is dispensed from one of the ten reagent reservoirs 2524 (e.g., dispense droplet from upper right reagent reservoir 2524 of FIGS. 42 through 45). Referring to FIG. 42, both the primary storage electrode 2574 and the dispense priming electrode 2576 of the reagent reservoir 2524 are activated. As a result, the volume of reagent fluid (not shown) spreads across both the primary storage electrode 2574 and the dispense priming electrode 2576, which is toward the dispensing end of the reagent reservoir 2524.

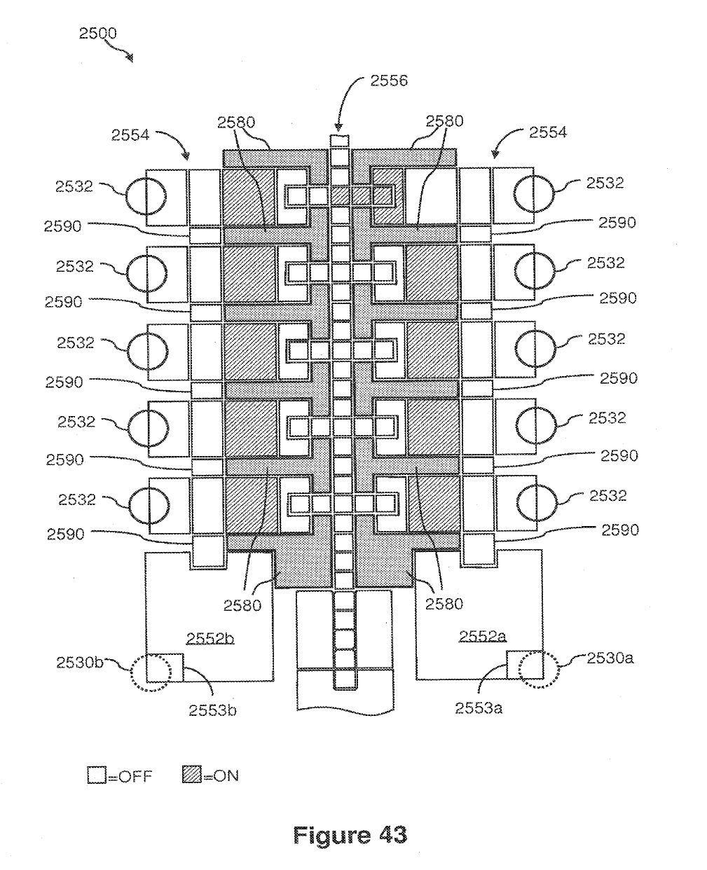

Referring to FIG. 43, the primary storage electrode 2574 of the reagent reservoir 2524 is now deactivated. The dispense priming electrode 2576 remains activated. Dispensing electrode 2578 and, for example, two adjacent droplet operations electrodes 2556 are also activated. As a result, a 3× slug or finger of reagent fluid (not shown) is pulled across dispensing electrode 2578 and the two droplet operations electrodes 2556.

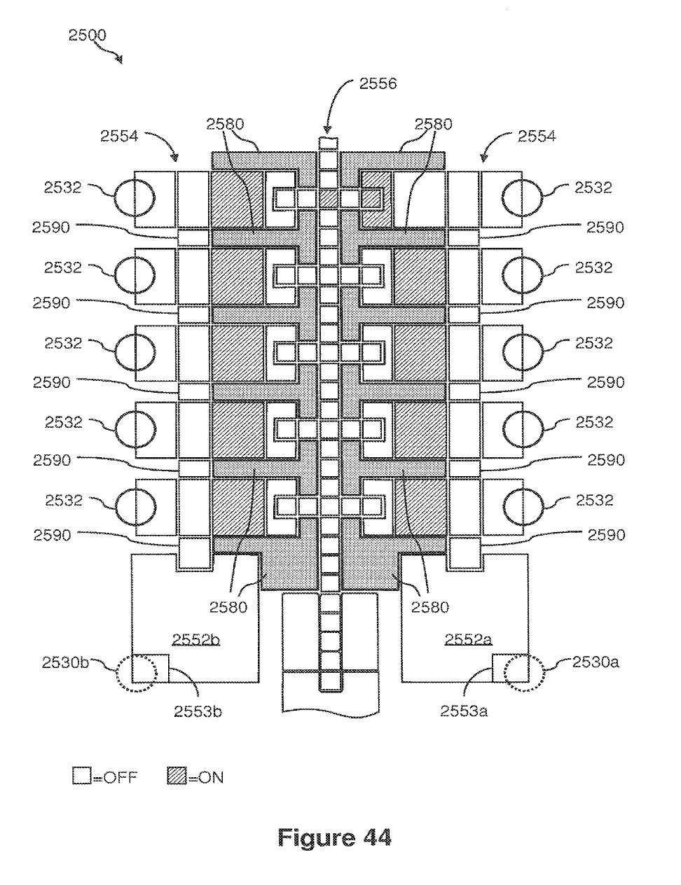

Referring to FIG. 44, a droplet splitting operation occurs via droplet operations. For example, the intermediate electrode of the 3× slug or finger of reagent fluid (not shown) is deactivated. This causes a droplet splitting operation to occur, leaving a droplet (not shown) of reagent fluid at the droplet operations electrode 2556 of the PCR lane. The remaining volume of reagent fluid (not shown) pulls back toward the reagent reservoir 2524 (e.g., onto dispense priming electrode 2576 and dispensing electrode 2578).

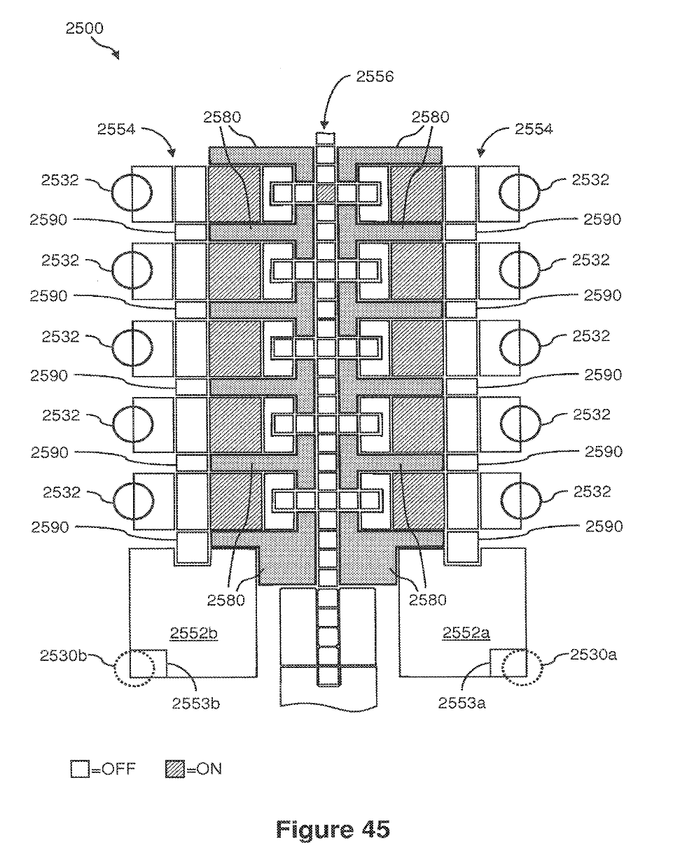

Referring to FIG. 45, the remaining volume of reagent fluid (not shown) is pulled further back into the reagent reservoir 2524 and the droplet (not shown) of reagent fluid at the droplet operations electrode 2556 of the PCR lane is ready to process. For example, dispense priming electrode 2576 of the reagent reservoir 2524 is deactivated and the primary storage electrode 2574 is activated. Therefore, the remaining volume of reagent fluid is atop the primary storage electrode 2574 of the reagent reservoir 2524. The reagent fluid is maintained at the primary storage electrode 2574 of the reagent reservoir 2524 until another reagent droplet dispense operation is called for.

In the aforementioned process of reconstituting dried reagents, the filler oil may be added into droplet actuator 2500 before or after reconstituting the reagents.

Bead-Based Analyte Capture

Sample-to-answer molecular assays may be multiplexed using multiple types of analyte capture beads (coded beads) in a single sample droplet. Each type of analyte capture bead has an identifying trait for easily differentiating one type of bead from another. For example, the various types of analyte capture beads may be differentiated by color, fluorescence, size, density, surface properties, responsiveness to a magnetic field, radioactivity, and any combinations thereof. The analyte capture beads may be coated with a reagent (e.g., oligonucleotide sequences, antibodies, peptides, receptors) specific to a particular bioassay (e.g., nucleic acid testing, immunoassays). In a preferred embodiment, the analyte capture beads are magnetically responsive capture beads.

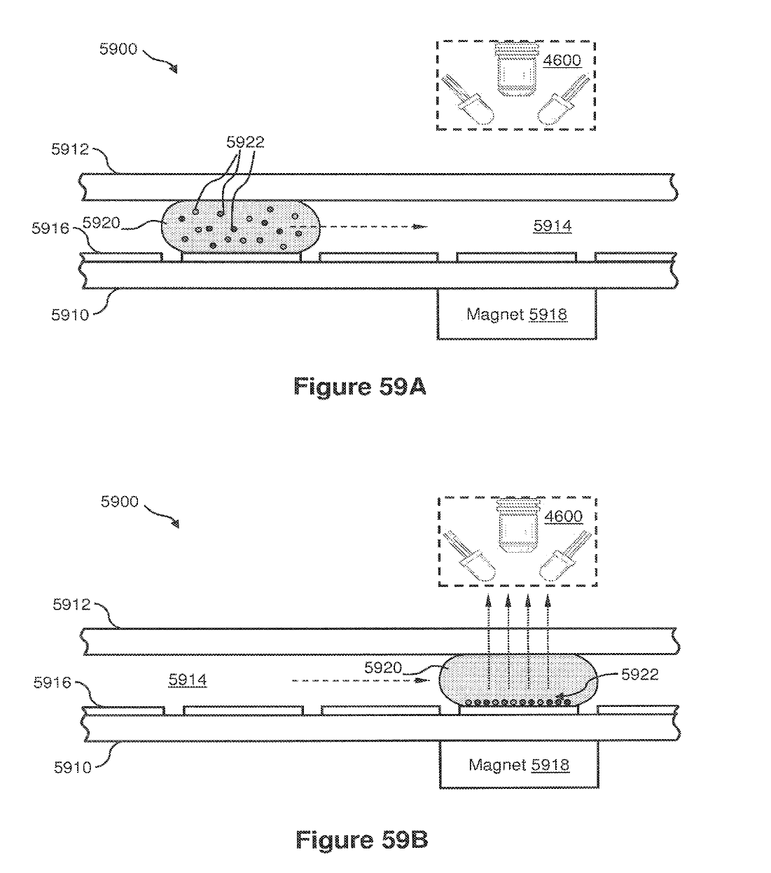

An example of multiplexing an immunoassay in a single droplet that contains different types of beads is described in more detail with reference to FIGS. 59A and 59B.

Detection of Respiratory Viruses

Acute respiratory infections are a leading cause of acute illnesses worldwide and remain the most important cause of infant and young child mortality. Currently, there are several commercially available PCR-based multiplexed respiratory viral panel assays, however most of these are classified as CLIA high complexity, are available only in certain laboratories, and can take more than a day to obtain results. The time-to-result is critical for treating patients since antiviral medications are effective only within the first 24 hours of infection. Rapid and accurate identification of these pathogens is crucial not only for the treatment of individual patients, but also for the public health by helping to control pandemic infection. In addition, with new variants of respiratory viruses continually emerging, laboratories are now faced with the challenge of detecting as many as 20 different viruses that can cause acute respiratory disease. Some of these respiratory viruses have very specific treatments such as oseltamivir or zanamivir for influenza, Pleconaril for rhinovirus and prophylactic Palivizumab for respiratory syncytial virus (RSV). Infection control practices also differ significantly between viruses and some are reportable to public health authorities.

The device and methods of the present invention provide for point-of-care detection of multiple clinically relevant viruses with sufficient sensitivity and specificity to guide therapy and infection control procedures.

In one embodiment, color coded beads (e.g., varying amounts of fluorescent dyes) may be coated with oligonucleotide sequences for capture of specific target DNA sequences (nucleic acid capture beads). In a preferred embodiment, the color coded beads are magnetically responsive beads. Any number of different nucleic acid capture beads may be combined for multiplexed nucleic acid testing of different target sequences in a single sample droplet. One example of magnetically responsive nucleic capture beads suitable for use in a digital microfluidic nucleic acid testing protocol is the xMAP bead microarray (Luminex). xMAP beads (e.g., magnetically responsive MAGPLEX™ beads) are internally color coded by varying the amount of two fluorescent dyes (e.g., red and infrared) and by being coated with a reagent (e.g., tagged oligonucleotide sequences) specific to a particular bioassay. A third fluorophore (e.g., phycoerythrin) coupled to a reporter molecule is used to quantify the biomolecular interaction at the bead surface.

In one example, the multiplexed Luminex xTAG respiratory virus panel (RVP), on magnetically responsive MAGPLEX™ beads, may be adapted for use on a droplet actuator. The xTAG RVP assay may be used to simultaneously to detect 19 respiratory virus types or subtypes, including RSV A & B, 4 Corona Viruses (NL63, 229E, OC43, HKU1), SARS, Non-specific Influenza A and H1, H3, H5 subtypes, Influenza B, Parainfluenza 1/2/3/4, Adenovirus Metapneumovirus, and Rhinovirus/Enterovirus. The assay also includes two controls, MS-2 Bacteriophage Internal Control and Lambdaphage Positive Control.

Specifications of two examples of the molecular diagnostic platform of the invention are shown in Table 2. In one example, Platform I uses a single sample disposable droplet actuator for integrated sample preparation and multiplexed detection of respiratory viruses using the xTAG RVP assay. In another example, Platform II uses a random access, high throughput droplet actuator for integrated sample preparation and multiplexed assays of up to 12 different molecular diagnostic panels (e.g., xTAG panels) on a single disposable droplet actuator.

TABLE 2
Specifications of molecular diagnostics platform

| Product Feature | Platform I | Platform II |
|---|---|---|
| #parallel tests | 1 | 12 (random |
| (use mode) | | access) |
| CLIA Complexity | Moderate | Moderate/Waived |
| Sample prep | Integrated | Integrated |
| Tests Offered | RVP | RVP, other xTAG |
| | | panels |
| Plex level possible | High | High |
| Time to Result | <60 min | <30 min |
| Hands on time | <5 min | <2 min |
| Reagent storage | Loaded by user | Integrated on |
| | | disposable |

Imaging System

The imaging system of the invention is a low cost LED/CCD based bead imaging system. Images may be captured on a computer and analyzed using image processing software. In one example, the imaging system of the invention may be used for multiplexed detection of color coded xMAP beads (e.g., magnetically responsive MAGPLEX™)

FIG. 46 illustrates a perspective view of an example of an imaging system 4600 for multiplexed detection of color coded beads (e.g., fluorescent beads). By way of example, FIG. 46 shows imaging system 4600 in relation to droplet actuator 100 of FIGS. 1 through 5A. Imaging system 4600 may include one or more LEDs 4610, such as two LEDs 4610a and 4610b. In one example, one LED 4610a may emit green light (525 nm wavelength) and LED 4610b may emit red light (635 nm wavelength). LEDs 4610a and 4610b provide an excitation light source.

Imaging system 4600 may also include a CCD camera 4612. It is noted that only the lens of CCD camera 4612 is shown in FIG. 46. An objective lens of CCD camera 4612 may be used to magnify and/or de-magnify the image in its field of view. A linear actuator (not shown) of CCD camera 4612 may be used for z-axis focusing of the image. CCD camera 4612 may also include optical filters, such as red and green optical filters.

In operation, a droplet actuator, such as droplet actuator 100, may be positioned in proximity to imaging system 4600. In particular, droplet actuator 100 may be positioned such that its detection window 136 is substantially aligned with imaging system 4600. A droplet 4626 that includes a quantity of magnetically responsive beads 4628 may be positioned at detection window 136 of droplet actuator 100. Magnetically responsive beads 4628 may, for example, be color coded fluorescent beads.

Bottom substrate 110 may, for example, be a PCB that includes polymer dielectric and FR4 materials. Because the PCB materials may be a source of autofluorescence, a high optical density material, such as Toray Black Matrix resin (OD=5, T=0.6% at 1 μm thickness) or carbon black, may be used to coat bottom substrate 110 and substantially eliminate the autofluorescence. In one example, a 5-10 μm coating is sufficient to substantially suppress autofluorescence from the PCB materials. An opaque coating may also have an additional benefit of suppressing reflection and scatter from the metal electrodes (droplet operations electrodes) on bottom substrate 110.

Top substrate 112 may, for example, be formed of a material with low autofluorescence at the imaging wavelengths of interest (525 nm and 635 nm). In one example, a high temperature PMMA (Acrylite MD H12f) material may be used. Autofluorescence from top substrate 112 may be further reduced by reducing the thickness of the region of top substrate 112 in proximity of the detection window, which is the imaging region. In one example, the thickness of top substrate 112 in proximity of a detection window may be reduced from about 3 mm to about 0.5 mm.

A magnet 4630 may be associated with droplet actuator 100. Magnet 4630 may be arranged such that detection window 136 of droplet actuator 100 is within its magnetic field. Magnet 4630 may, for example, be a permanent magnet or an electromagnet. In one example, magnet 4630 may be a small stationary cube magnet placed about 1.5 inches from droplet actuator 100. Magnet 4630 may be used, for example, to attract and/or immobilize a quantity of magnetically responsive beads 4628 in droplet 4626. The holding force of magnet 4630 is sufficient to prevent migration of magnetically responsive beads 4628 from droplet 4626, but not too strong to prevent mixing of magnetically responsive beads 4628 within droplet 4626 using droplet operations. In operation, magnet 4630 may be used to assist in forming a monolayer of magnetically responsive beads suitable for imaging.

In one example, color coded magnetically responsive MAGPLEX™ beads may be used. In this example, calibration of imaging system 4600 may, for example, be performed using MAGPLEX™ calibration beads (Luminex Cat. No. LX200-CAL-K25). Verification of calibration may, for example, be performed using control bead sets (Luminex Cat. No. LX200-CON-K25). These kits contain xMAP calibrators/controls for MAGPLEX™ classification channels (red/infra red) and for the reporter channel (green/phycoerythrin).

The images taken by imaging system 4600 of the magnetically responsive beads are two dimensional images that may be described as having a background and bright bead events which comprise the foreground. The background is uniform in theory, but in practice the background is imaged as a slowly varying function. The beads are visualized as small blobs randomly but uniformly positioned on the surface of the background.

In the field of image analysis with respect to droplet actuators, three hierarchical tasks may exist: detection, categorization, and identification, in increasing order of complexity. Detection includes localizing the occurrences of a target object (bead) in the image (in terms of coordinates in the image). Categorization includes determining whether a bead is a bead or is an artifact. Categorization may use information from both red-channel images. Identification uses the relative fluorescence between the two red-channels as a classifier to the identity of a magnetically responsive bead. Once a bead has been categorized and identified, the intensity in the green channel at the same coordinates (or fixed offset) is sampled to evaluate the analyte-based signal (reporter signal). Key criteria will be the resolution of all classes of magnetically responsive beads present in the calibration and control bead mix. Separation and spread of clusters (classes) may be evaluated using well-known clustering metrics. Spread of the green-channel intensities (reporter channel) in each cluster may also be well-characterized using standard deviation and other dispersion metrics. In one example, about 1000 beads per 1 mm² area may be imaged.

Respiratory Virus Detection Protocol

Respiratory viruses are typically detected using nasopharyngeal swabs or nasopharyngeal wash as the collected sample, and nucleic acid testing as the assay method. In one example, the swabs are stored and transported in tubes containing 1 mL of viral transport buffer. For sensitive detection, it is preferable to use as much of the sample as possible.

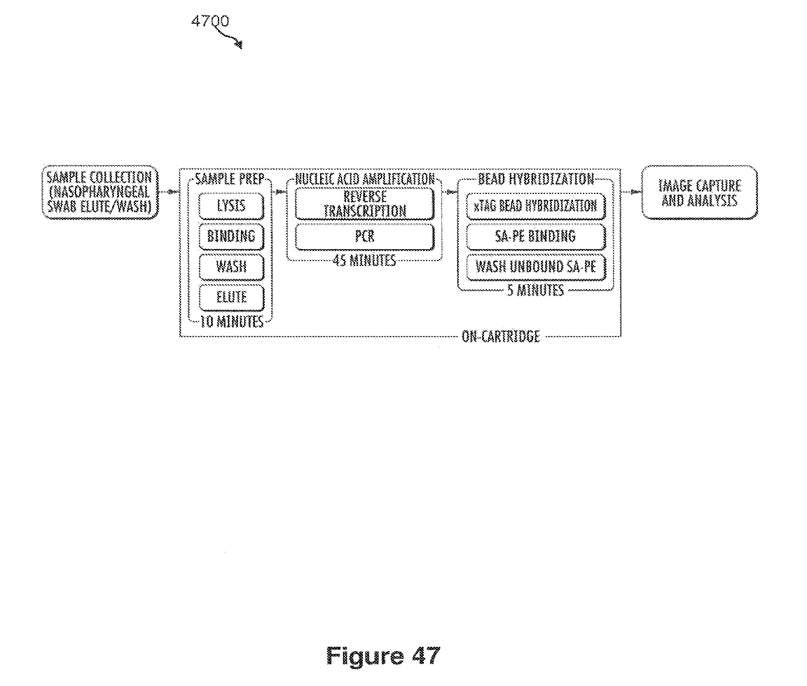

FIG. 47 illustrates a flow diagram of an example of a protocol 4700 for sample-to-answer detection of respiratory viruses in a biological sample. Protocol 4700 integrates sample preparation (e.g., purification of viral nucleic acid), nucleic acid amplification, and bead hybridization on a single droplet actuator. In one example, protocol 4700 uses xTAG RVP primers and beads for detection of respiratory viruses in a clinical sample. Protocol 4700 may include, but is not limited to, the following steps.

In one step, a nasopharyngeal swab or nasopharyngeal wash sample (e.g., about 1 mL) is collected and placed into a sample input reservoir on a droplet actuator. Sample preparation reagents, e.g., lysis reagent, and magnetically responsive RNA capture beads are placed into a reagent input reservoir on the droplet actuator. In one example, DYNABEADS® SILANE viral kit (available from Life Technologies Company, Carlsbad, Calif.) may be used for nucleic acid preparation.

In other steps, viral RNA is prepared. The nasopharyngeal sample is mixed with lysis reagent to disrupt the viral protein coat and release the nucleic acid. Sample processing on-actuator captures viral RNA from the nasopharyngeal sample onto magnetically responsive beads. The magnetically responsive beads with bound RNA thereon are washed extensively to remove all unbound material. The RNA is eluted from the magnetically responsive beads. Preparation of viral RNA may, for example, be completed in about 10 minutes.

In other steps, nucleic acid amplification is performed. Purified viral RNA is reverse transcribed into cDNA and subsequently amplified by PCR. The amplified DNA is mixed with short sequences of DNA specific to each viral target (target specific primer). The target specific primer may be tagged with a universal tag sequence that is common to all primers. If the viral target sequence is present in the sample, the primer will bind and will be extended (target specific primer extension; TSPE). In one example, each target specific primer in the primer extension reaction is attached to an xTAG universal tag sequence (TAG primer). Nucleic acid amplification may, for example, be completed in about 45 minutes.

In other steps, a droplet that includes a quantity of analyte capture beads (e.g., xTAG beads) is dispensed onto the droplet actuator. Attached to each analyte capture bead is an anti-tag sequence. In the example using TAG primer sequences, attached to each differently colored xTAG bead is an anti-TAG sequence specific to one of the extended TAG primers. The droplet of analyte capture beads (e.g., xTAG beads) is combined using droplet operations with a droplet of amplified DNA. Following a period of time sufficient for hybridization of analyte capture beads to target DNA, a droplet of reporter dye (e.g., SA-PE) is dispensed and combined with the hybridization reaction. After a period of time sufficient for reporter binding, the magnetically responsive capture beads with target/reporter complexes (e.g., TAG/anti-TAG/reporter complexes) thereon are washed extensively to remove all unbound material.

In another step, images of analyte capture beads and reporter complexes are captured on a computer and analyzed using custom image processing software.

Droplet actuator 100 of FIGS. 1 through 5B is an example of droplet actuator architecture suitable for performing the respiratory virus detection protocol 4700 of FIG. 47. In one embodiment, sample preparation reagents (e.g., lysis buffer, RNA capture beads, elution buffer) and assay reagents (e.g., RT-PCR reagents, analyte capture beads, reporter dye) may be manually loaded onto droplet actuator 100 by a user. In another embodiment, sample preparation reagents and assay reagents may be pre-loaded and stored on droplet actuator 100 prior to use. Pre-loading of droplet actuator 100 with sample preparation and assay components provides a ready-to-use device that minimizes hands-on time during operation.

In operation and referring again to the example droplet actuator 100 of FIGS. 1 through 5B, a volume of sample fluid (e.g., a nasopharyngeal swab elute of about 1 mL) is loaded into sample reservoir 126 using input port 128. A volume, e.g., about 0.5 mL, of sample preparation reagent (e.g., lysis buffer, RNA capture beads) is loaded into sample reservoir 126 through input port 130. In one example, reagent reservoir 132a may contain a quantity of RT-PCR reagent fluid. Reagent reservoirs 132b and 132c may contain a quantity of wash buffer fluid. Reagent reservoir 132d may contain a quantity of analyte capture beads suspended in a buffer fluid. Reagent reservoir 132e may contain a quantity of reporter dye (e.g., SA-PE). Reagent reservoir 132f may contain a quantity of nucleic acid elution buffer.

Sample Preparation

On-bench protocols for preparation of viral RNA may be described and implemented on a droplet actuator as discrete step-by-step droplet-based protocols. Some modifications to existing assay protocols facilitate translation of the bench-based protocols into droplet-based protocols. In one embodiment, DYNABEADS® SILANE viral kit (available from Life Technologies Company, Carlsbad, Calif.) for viral nucleic acid preparation may be adapted for use on a droplet actuator.

Examples of steps and parameters in a sample preparation protocol that may be adapted in a digital microfluidic protocol are shown in Table 3.

TABLE 3
Selection of sample preparation protocol

| | Droplet | | |
|---|---|---|---|
| | actuator | | |
| Step | protocol | Objective | Key experiments |
| Lysis | Mix lysis buffer, | [symbol] Lysis efficiency | Optimize volumes of lysis |
| | sample in input | [symbol] Lysis time | buffer, sample and lysis time. |
| | reservoir. | | Increase temperature to |
| | | | decrease lysis time. |
| Binding | Mix lysed sample | [symbol] Capture efficiency | Optimize bead concentration. |
| | with magnetically | [symbol] Binding time | Increase bead concentrations |
| | responsive beads. | | to decrease binding time. |
| Bead | Concentrate beads | [symbol] Bead loss | Optimize position and strength |
| capture | after binding step | [symbol] Concentration time | of magnet to rapidly |
| | into 0.5 μL droplet. | | concentrate beads from lmL |
| | | | into 0.5 uL droplet. |
| Wash | Wash concentrated | [symbol] Inhibition | Optimize washing protocol. |
| | beads using | [symbol] Bead loss | Increase number of wash |
| | standard protocols. | | cycles to remove inhibitors. |
| Elute | Mixing with elution | [symbol] Elution efficiency. | Optimize mixing time and |
| | buffer and split | | splitting protocol to recover |
| | supernatant free of | | maximum volume of eluent. |
| | beads. | | Increase temperature to |
| | | | increase elution efficiency. |

In another embodiment, an influenza A model system (Zeptometric) and quantitative RT-PCR may be used for selection of microfluidic and magnetically responsive bead handling protocols.

In yet another embodiment, different respiratory viral controls (Zeptometrix) spiked in Copan Universal Transport Media may be used as control samples for preparation of viral RNA on a droplet actuator.

Digital Microfluidic RT-PCR Protocol

On-bench protocols for reverse transcription (RT) of viral RNA and PCR amplification of cDNA may be described and implemented on a droplet actuator as discrete step-by-step droplet-based protocols. Some modifications to existing assay protocols facilitate translation of the bench-based protocols into droplet-based protocols. Assay protocols may, for example, be selected for increased sensitivity and rapid time-to-result. In one example, control RNA samples extracted using bench-based protocols may be used to select reverse transcription and PCR amplification protocols. An example of a comparison of on-bench and on-actuator RT-PCR protocols is shown in Table 4. Both on-bench and on-actuator protocols were performed using the Roche Transcriptor 1-step RT-PCR kit.

TABLE 4
On-bench kit vs. on-actuator protocol for RT-PCR

| Step | Kit protocol | On-actuator protocol |
|---|---|---|
| Reverse transcription | 5 min @50 C. | 10 min @50 C. |
| Initial denaturation | 5 min @94 C. | 2 min @94 C. |
| PCR - Denaturation + | (10 + 30 + 60 | (10 + 15 + 15 sec) × |
| Annealing + Elongation | sec) | 40 = 26 min |
| Final elongation | 5 min | 5 min |
| Total time | 81 min | 43 min |

In another example, 40 cycles of PCR performed on-actuator may be completed in less than about 30 minutes.

Digital Microfluidic Bead Hybridization and Detection Protocol

On-bench protocols for analyte capture bead hybridization and reporter labeling may be described and implemented on a droplet actuator as discrete step-by-step droplet-based protocols. Some modifications to existing assay protocols facilitate translation of the bench-based protocols into droplet-based protocols. On-bench processed nucleic acid control samples, e.g., viral RNA control samples, may be used to select appropriate on-actuator reaction parameters (e.g., bead hybridization, reporter labeling). An imaging system, such as, but not limited to, imaging system 4600 of FIG. 46, may be used for detection.

In one embodiment, on-bench protocols for bead hybridization using magnetically responsive beads (e.g., MAGPLEX™ beads) and reporter labeling may be described, evaluated and implemented on a droplet actuator. For example, the number of magnetically responsive beads (e.g., MAGPLEX™ beads) used per reaction may be adjusted for use in a digital microfluidic protocol. After bead hybridization and reporter labeling, a bead washing protocol may be used to remove all unbound material. Bead transport and washing may be evaluated for the effect on bead classification (discrimination of individual bead populations), loss of reporter signal and washing efficiency (removal of unbound material).

An example of the number of magnetically responsive MAGPLEX™ beads used per reaction in an on-bench assay and an on-actuator protocol is shown in Table 5.

TABLE 5
Bead concentration per reaction on-bench vs on- actuator

| | | | On-actuator | |
|---|---|---|---|---|
| | On-bench | | protocol | |
| MAGPLEX ™ beads | 6.5 | μm | 6.5 | μm |
| #beads of each | 56 | | 1,000 | |
| population*/μL | | | | |
| #populations | 10 | | 10 | |
| Amount bead mix used per | 20 | μL | 350 | nL droplets |
| reaction | | | | |

| | | |
|---|---|---|
| #beads per reaction | ~11,000 | ~3,500 |
| | (1,100 per population) | (350 per population) |

*Population: a group of beads with a particular dye profile representative of one assay (e.g., population 035 = RSV-A)

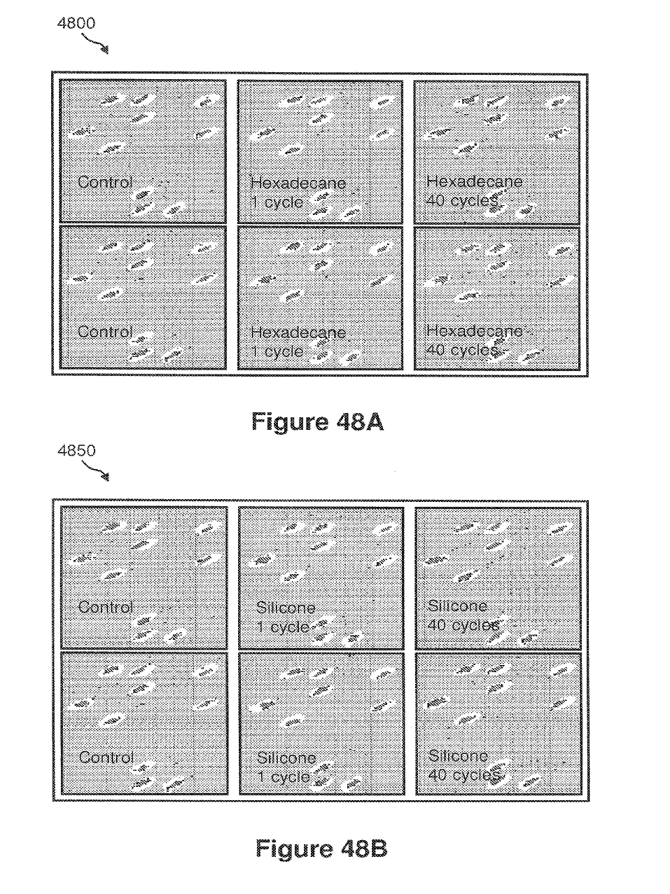

FIGS. 48A and 48B show examples of bead classification maps 4800 and 4850, respectively, of MAGPLEX™ beads after 1 or 40 transport cycles on a droplet actuator that is filled with hexadecane or 2.0 cSt silicone filler fluid. The assay used to evaluate the effect of bead transport on classification of MAGPLEX™ beads included the following steps: Ten populations (1,000 beads/population/μL; total 10,000 beads/μL) of magnetically responsive MAGPLEX™ beads were mixed together on-bench. The mixed bead preparation was loaded into a dispensing reservoir of a droplet actuator. Eighteen 350 nL mixed bead droplets (−3,500 beads/droplet) were dispensed and transported using droplet operations to separate reaction lanes on the droplet actuator. The droplets were transported back and forth using droplet operations over a certain number of droplet operations electrodes for 1 or 40 transport cycles. After 1 or 40 transport cycles, the droplets were transported using droplet operations to an output reservoir. Droplets were manually pipetted (about 6 μL) from the output reservoir and placed in separate microcentrifuge tubes. The beads were washed on-bench and resuspended in 6 μL of Tm buffer. An aliquot (3 μL) of washed beads was mixed with 77 μL of Tm buffer. Bead classification maps were generated on an LX100 instrument. Data show minimal impact of filler fluid composition and electrowetting (droplet operations) on MAGPLEX™ bead classification.

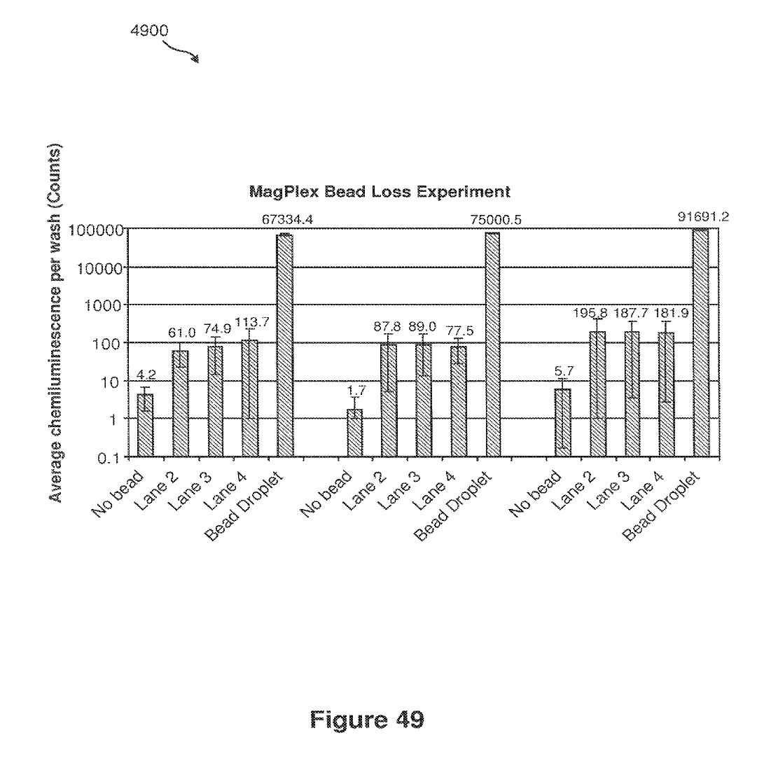

FIGS. 49, 50, and 51 show an example of a bar graph 4900, an example of a plot 5000, and an example of a plot 5100, respectively, of reporter signal in an on-actuator bead washing protocol. Decreases in a reporter signal during a bead washing protocol may, for example, be due to loss of magnet bead/reporter complexes from a washed droplet and/or dissociation of amplified target DNA and bead-bound complementary oligonucleotide sequences (e.g., Tag/Anti-tag sequences).

The assay used to evaluate reporter signal levels in an on-actuator bead washing protocol included the following steps: On-bench, 10 populations (1,000 beads/population/μL; total 10,000 beads/μL) of magnetically responsive MAGPLEX™ beads were mixed together. Complementary biotinylated oligo Tags were added to the mixed bead solution, incubated and washed on-bench (Tag/Anti-Tag hybridization). The reaction was blocked with 10 mg/mL bovine serum albumin (BSA) to prevent non-specific binding of reporter complex (i.e., SA-ALP). SA-ALP (1.3 μg/mL) was added to the blocked bead solution and incubated and washed (3-5 times) on-bench. The prepared bead solution was loaded onto a droplet actuator. One droplet of beads was dispensed onto each of three separate lanes of the droplet actuator and combined using droplet operations with one droplet of wash buffer to yield a 2× bead/wash droplet (i.e., 3-2× bead/wash droplets). A 1× supernatant droplet was split-off using droplet operations to yield a 1× washed bead droplet. This merge and split operation constitutes one bead washing cycle. A total of 10 wash cycles were used. After each bead washing cycle, the supernatant droplet was transported to a detection spot on the droplet actuator and the amount of chemiluminescence (reporter signal) in each supernatant droplet determined. At the completion of 10 wash cycles, the bead containing droplet was transported using droplet operations to a detection spot on the droplet actuator and the amount of chemiluminescence in the washed bead droplet was determined. The experiment was performed in three separate lanes on three different droplet actuators (droplet actuator cartridges 1 through 3). The concentration of MAGPLEX™ beads was estimated from a calibration curve. Droplet actuator cartridges 1 and 2 were evaluated directly after on-bench bead preparation and washing. Droplet actuator cartridge 3 was evaluated about 5 min after on-bench bead preparation and washing. The average loss of chemiluminescent signal per wash is shown in bar graph 4900 of FIG. 49 and Table 6. The average signal loss per wash was about 0.15% or about 1.5% for 10 washes.

TABLE 6
Average signal loss/wash

| Loss/Wash (%) | Lane2 | Lane3 | Lane4 |
|---|---|---|---|
| Droplet actuator | 0.09 | 0.11 | 0.17 |
| cartridge 1 | | | |
| Droplet actuator | 0.12 | 0.12 | 0.10 |
| cartridge 2 | | | |
| Droplet actuator | 0.21 | 0.20 | 0.20 |
| cartridge 3 | | | |

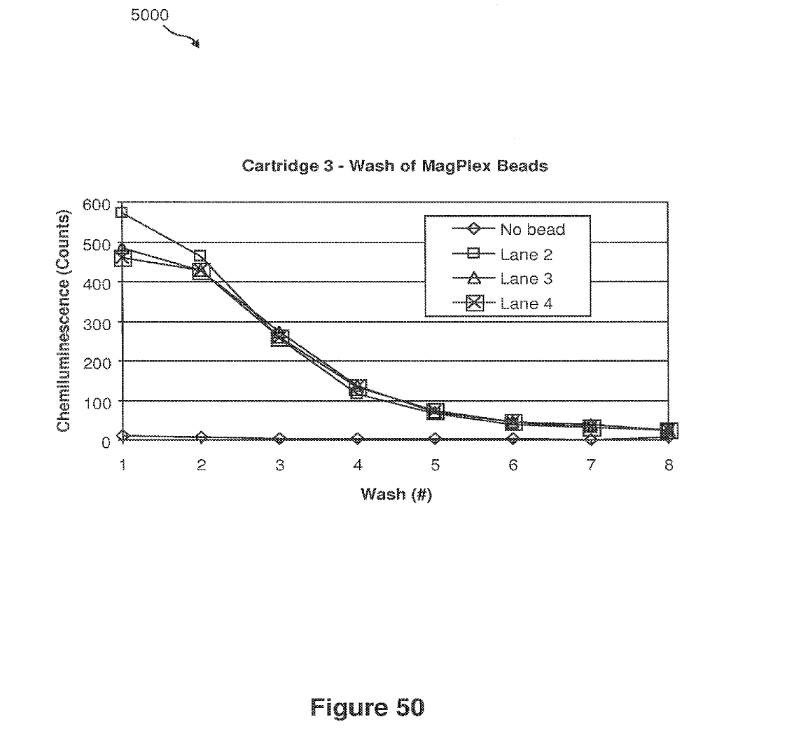

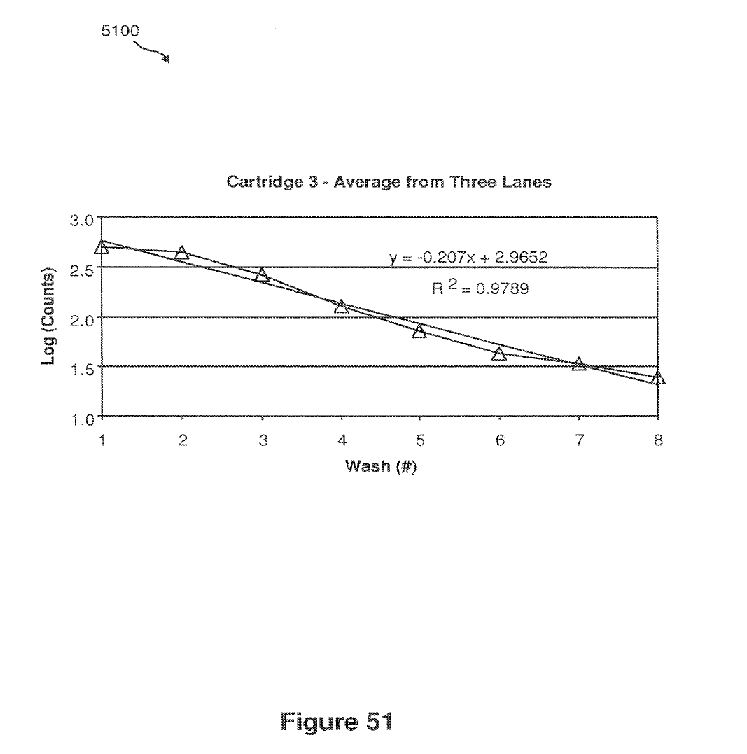

The reduction in chemiluminescent signal (reporter signal) for individual wash droplets on Droplet actuator cartridge 3 is shown in plot 5000 of FIG. 50 and plot 5100 of FIG. 51. The data show the signal from individual wash droplets continually falls and follows a dilution curve. This pattern of signal loss indicates that loss of signal may be due to dissociation of Tag/Anti-Tag sequences. Decreases in signal from bead loss (MAGPLEX™ bead/reporter complex) alone would show uniformity across washes and/or stabilization after a few washes. Loss of reporter signal due to bead loss may, for example, be evaluated using a covalently coupled reporter dye.

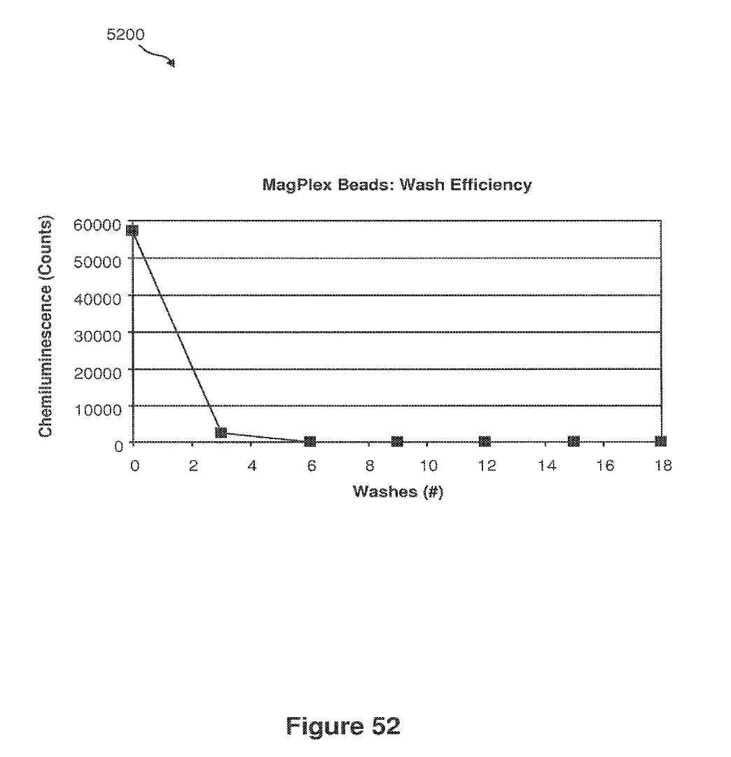

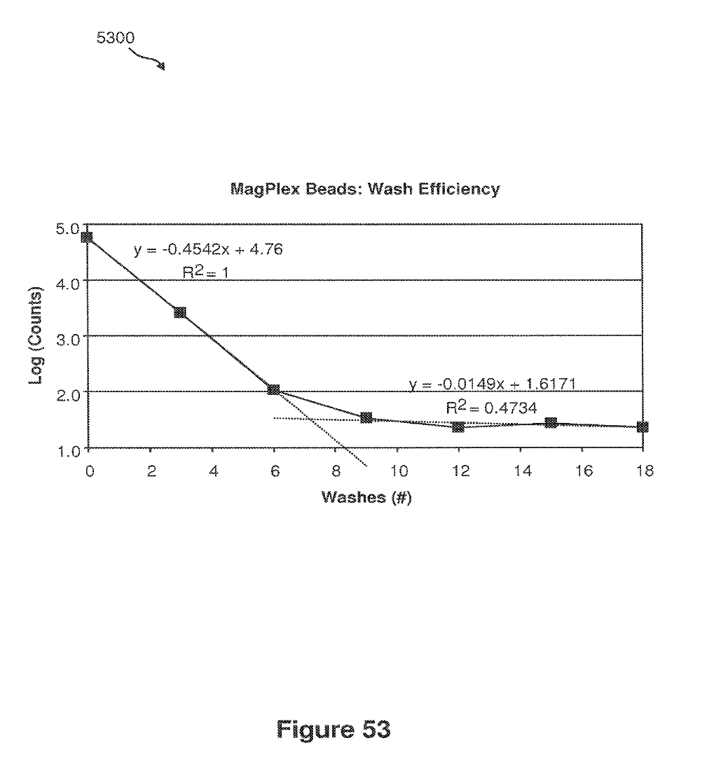

FIGS. 52 and 53 show an example of a plot 5200 and a plot 5300, respectively, of chemiluminescence data and analysis of the washing efficiency of an on-actuator bead washing protocol. The assay used to evaluate the washing efficiency of an on-actuator bead washing protocol included the following steps: On-bench, 10 populations (1,000 beads/population/μL; total 10,000 beads/μL) of magnetically responsive MAGPLEX™ beads (i.e., untagged beads) were mixed together. The beads were blocked with 10 mg/mL BSA. The blocked bead solution was washed and loaded onto a droplet actuator. Twelve droplets of the blocked bead solution were dispensed onto separate washing lanes on the droplet actuator (lanes 1 through 12). Each blocked bead droplet was combined with one droplet of SA-ALP reporter (final concentration of SA-ALP in the combined droplet is 0.13 μg/mL) to form a 2× bead/reporter droplet. The bead/reporter droplets were washed for 0, 3, 6, 9, 12, 15, or 18 wash cycles (i.e., n=2 droplets in separate lanes for each set of wash cycles). After each wash cycle set, bead droplets (n=2 for each was cycle) were transported using droplet operations to a detection spot on the droplet actuator and the amount of chemiluminescence signal (reporter signal) remaining in the washed bead droplet was determined. The experiment was performed on 2 separate droplet actuators. The data show that the chemiluminescence signal (reporter signal) in the washed bead droplet is at background levels after about 8 wash cycles.

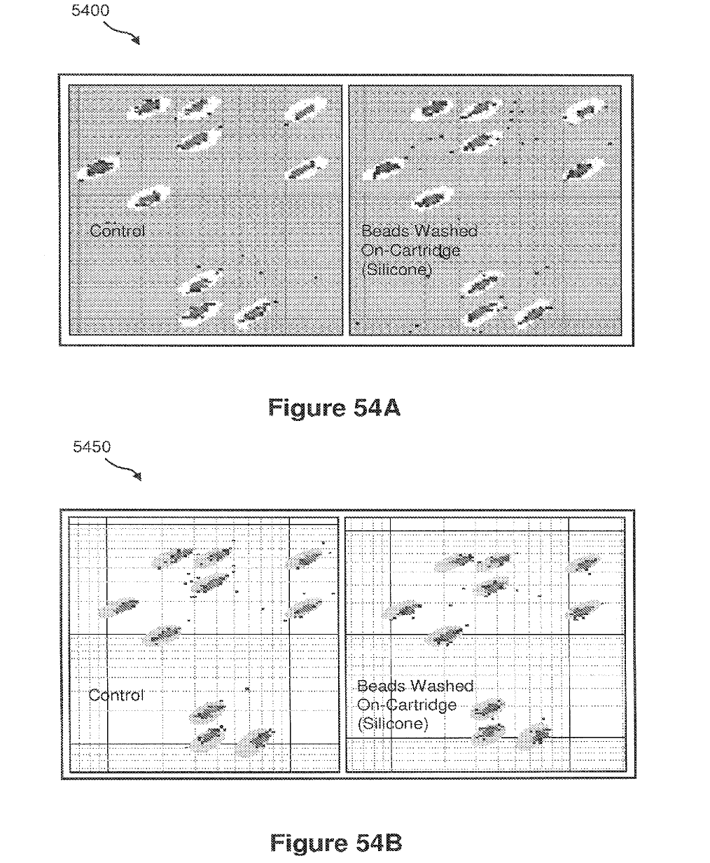

FIGS. 54A and 54B show an example of bead classification maps 5400 and 5450, respectively, of MAGPLEX™ beads after 10 bead washing cycles on a droplet actuator. The assay used to evaluate the effect of bead washing on classification of MAGPLEX™ beads included the following steps: Ten populations (1,000 beads/population/μL; total 10,000 beads/μL) of magnetically responsive MAGPLEX™ beads were mixed together on-bench. The mixed bead preparation was loaded onto a dispensing reservoir of a droplet actuator. Twelve 350 nL mixed bead droplets (about 3,500 beads/droplet) were dispensed and transported using droplet operations to separate washing lanes on the droplet actuator. The mixed bead droplets were washed 10 times using a bead washing protocol. After 10 wash cycles, the mixed bead droplets were transported using droplet operations to separate output reservoirs. Mixed bead droplets were manually pipetted (about 4.2 μL) from the output reservoir and placed in separate microcentrifuge tubes. The beads were washed on-bench (using a magnet and centrifuge) and resuspended in 6 μL of Tm buffer. An aliquot (3 μL) of washed beads was mixed with 77 μL of Tm buffer. Beads prepared on-bench, but not subjected to the on-actuator bead washing protocol were used as a control. Bead classification maps were generated on an LX100 instrument, an example of such is bead classification map 5400 of FIG. 54A. Bead classification maps were generated on a Luminex MagPix instrument, an example of such is bead classification map 5450 of FIG. 54B. The data show minimal impact of bead washing droplet operations on MAGPLEX™ bead classification.

RVP Assay Transfer (On-Bench to On-Actuator)

On-bench protocols using commercially available panels for RVP detection may be adapted for use on a droplet actuator. For example, the RVP-Fast assay (Luminex) may be adapted for use on a droplet actuator. The RVP-Fast assay includes reverse transcription of viral RNA, amplification of target cDNA sequences, bead hybridization and reporter dye labeling. In one example, incubation times (e.g., hybridization times) and temperatures for certain process steps in the assay may be selected for use on a droplet actuator. In another example, the concentration of Tag primer sequences for target amplification may be selected for use on a droplet actuator. In yet another example, the amount of amplified target DNA (PCR product) may be selected for on-actuator hybridization protocols. RNAse inhibitors may be included in reagent droplets to prevent degradation of RNA during processing to cDNA.

Table 7 shows an example of reagent volumes for on-bench and on-actuator protocols for RT-PCR amplification of target viral sequences using the RVP-Fast assay.

TABLE 7
On-bench (iQ5) and on-actuator protocols for RVP Fast
RT-PCR amplification of target viral sequences

| | | | On-Cartridge | | | |
|---|---|---|---|---|---|---|
| | iQS | | Off-Cartridge | | Amount Run on | |
| | Mix (20 μL) | | Mix (20 μL) | | Cartridge (600 nL) | |
| Control Sample | 1 | μL | 10 | μL | 300 | nL |
| (undiluted) | | | | | | |
| RNAse Free | 10.3 | μL | 0 | μL | 0 | nL |
| Distilled Water | | | | | | |
| 5X PCR Buffer | 4.0 | μL | 4.0 | μL | 120 | nL |
| xTAG dNTP Mix | 1.1 | μL | 1.1 | μL | 33 | nL |
| xTAG RVP Fast | 2.0 | μL | 2.0 | μL | 60 | nL |
| Primer Mix | | | | | | |
| xTAG OneStep | 1.6 | μL | 2.4 | μL | 72 | nL |
| Enzyme Mix | | | | | | |

| | | | | | |
|---|---|---|---|---|---|
| TWEEN ® 20 | — | 0.5 | μL | 15 | nL |
| (4%) | | | | | |

Table 8 shows an example of on-bench and on-actuator protocols for RVP-Fast bead hybridization and reporter dye (SA-PE) labeling.

TABLE 8
On-bench and on-actuator (on-cartridge) protocols for
RVP-Fast bead hybridization and reporter labeling

| | Luminex | Cartridge | On-Cartridge |
|---|---|---|---|
| | Standard | Equivalent | Protocol |
| | Protocol | Bench Protocol | (~1 μL or |
| | (97 μL) | (6 μL) | 3 droplets) |
| Targets | 2 μL | 2 μL | 1 droplet |
| in 1x | (50, 25 | (50, 25 | (50, 25 or 5 |
| RVP- | or 5 fmol) | or 5 fmol) | fmol/droplet) |
| Fast | | | |
| Bead | 20 μL | 2 μL | 1 droplet |
| mix in | (56 beads/ | (2,000 beads/ | (2,000 beads/ |
| 1x RVP- | population/μL) | population/μL) | population/μL or |
| Fast | | | 700 beads/ |
| buffer | | | population/droplet) |
| SA-PE | 75 μL | 2 μL | 1 droplet |
| (diluted in | (0.0133 mg/ml) | (0.05 mg/ml) | (0.05 mg/ml) |
| 1x RVP- | | | |
| Fast | | | |

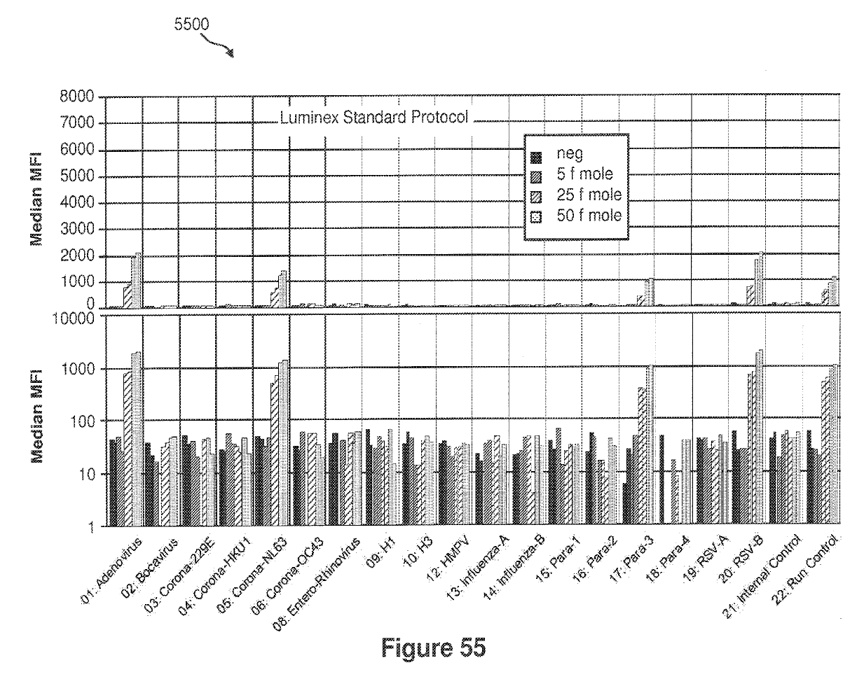

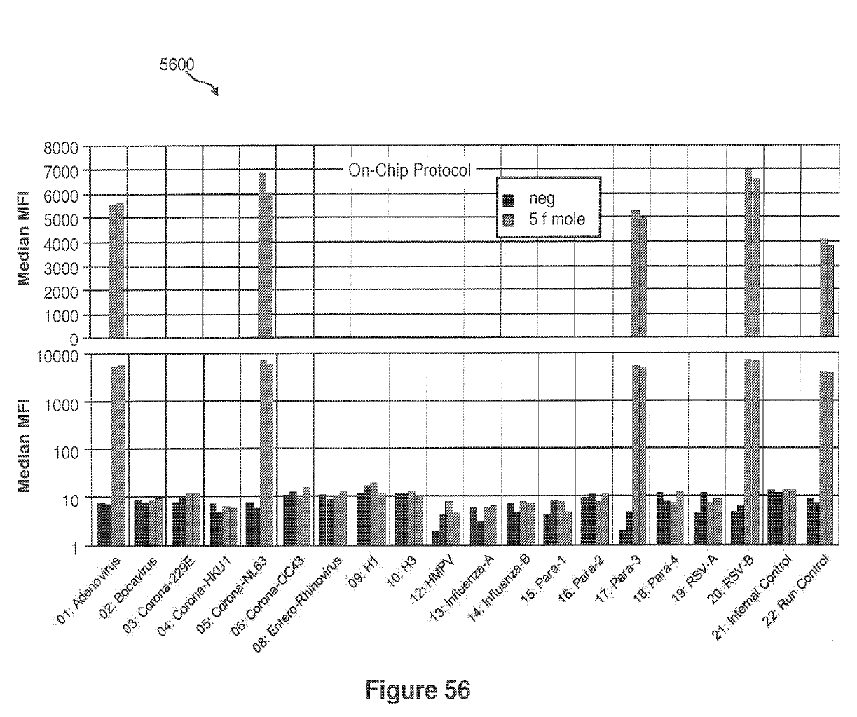

FIGS. 55 and 56 show an example of a bar graph 5500 and a bar graph 5600, respectively, of a comparison of an RVP Fast assay performed on-bench and on a droplet actuator, respectively. The on-actuator protocol used to evaluate the RVP Fast assay on a droplet actuator included the following steps: viral RNA (prepared on-bench) was reverse transcribed and amplified using an on-actuator protocol as described in reference to Table 6. A 1× droplet of xTag-amplified DNA was combined using droplet operations with a 1× bead droplet (xTag beads) and a 1× reporter droplet (SA-PE reporter) to yield a 3× reaction droplet. The 3× reaction droplet was incubated at 45° C. for 5 minutes. The bead hybridization and reporter binding reactions were divided into 4 groups (match: 5 targets/Group; mismatch: 15 targets/group). After the incubation period, the 3× reaction droplet was transported using droplet operations to an output reservoir on the droplet actuator and removed by manual pipetting from the droplet actuator. The 3× reaction droplet was mixed on-bench with 96 μL of Tm wash buffer. The diluted reaction droplet was analyzed on a LX100 instrument. The data shows results for Group 2: positive results for AdV, CoV-NL63, Para-3, RSV-B (and positive run control). Higher signals and lower backgrounds were observed in the on-actuator protocol compared to the standard on-bench (Luminex) protocol.

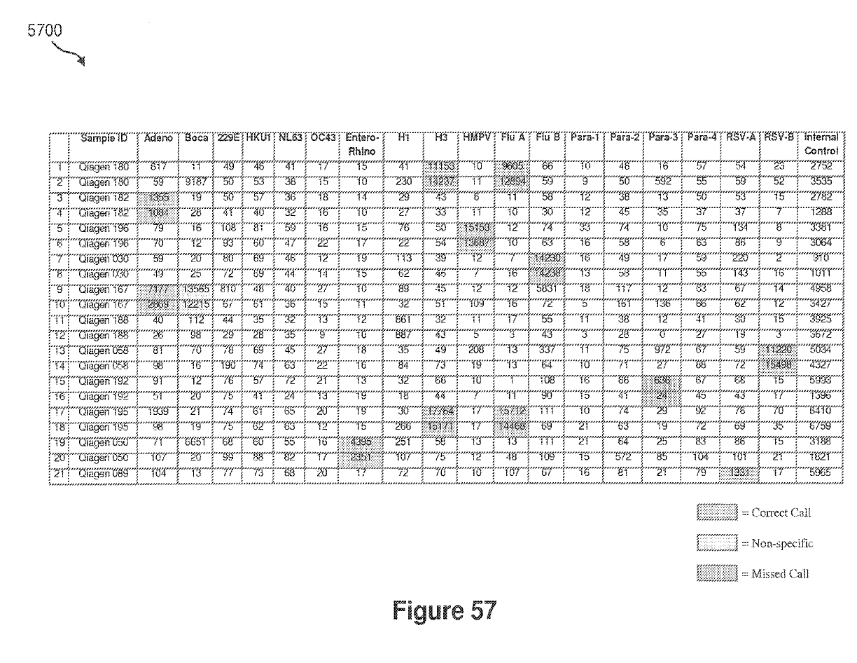

FIG. 57 shows an example of a data table 5700 of an RVP-Fast assay performed on a droplet actuator. In this example, viral RNA from 11 clinical samples was extracted on-bench using a Qiagen nucleic acid extraction kit and processed (i.e., RT-PCR, bead hybridization, reporter labeling) on a droplet actuator. The samples were analyzed in duplicate (n=2). Table 9 shows process step reaction times for RT-PCR and hybridization times used for the on-actuator RVP-Fast assay. In this example, total time to result was about 2 hours.

TABLE 9
Process step reaction times

| | | |
|---|---|---|
| Heaters to 50° C. | 1 | min |
| Reverse Transcription | 20 | min |
| Heaters to PCR Temps | 15 | min |
| Inactivation/Activation | | |
| Amplification | 55 | min |
| Heaters to 45° C. | 6 | min |
| Dilution of product | 8 | min |
| Hybridization (includes setup) | 7 | min |

Table 10 shows reagent volumes for RT-PCR and hybridization reactions used in a standard RVP-Fast on-bench protocol and the on-actuator protocol.

TABLE 10
Reagent volumes for RT-PCR and hybridization reactions on-bench
and on-actuator

| | | | | On-Cartridge | | |
|---|---|---|---|---|---|---|
| | | | | Off-Cartridge | | Amount Used |
| | | Standard | | Equiv. | | on Cartridge |
| 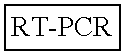 | Sample | 10 | μL | 10 | μL | 194 nL |
| | RNAse Free Distilled Water | 1.3 | μL | 0.7 | μL | 27 nL |
| | 5X PCR Buffer | 4.0 | μL | 4.0 | μL | 155 nL |
| | xTAG dNTP Mix | 1.1 | μL | 1.1 | μL | 43 nL |
| | xTAG RVP Fast Primer Mix | 2.0 | μL | 1.0 | μL | 39 nL |
| | | (30x) | | (15x) | | |
| | xTAG OneStep Enzyme Mix | 1.6 | μL | 2.4 | μL | 93 nL |

| | | | | |
|---|---|---|---|---|
| Qiagen Hot StarTaq (5U/μL) | — | 0.8 | μL | 31 nL |
| RNAse Inhibitor | — | 0.5 | μL | 19 nL |

| 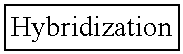 | PCR Product | 2 | μL | — | 300 nL |
|---|---|---|---|---|---|
| | | | | | (diluted 16x) |
| | Bead mix in 1x RVP-Fast | 20 | μL | — | 300 nL |
| | buffer | | | | |
| | SA-PE | 75 | μL | — | 300 nL |

The on-actuator protocol included the following steps: viral RNA (prepared on-bench) was loaded onto a droplet actuator. A 1× droplet of RNA was dispensed and combined using droplet operations with a 1×RT-PCR reagent droplet. A 1× droplet of xTag-amplified DNA was combined using droplet operations with a 1× bead droplet (xTag beads) and a 1× reporter droplet (SA-PE reporter) to yield a 3× reaction droplet. The 3× reaction droplet was incubated at 45° C. for 5 minutes. After the incubation period, the 3× reaction droplet was transported using droplet operations to an output reservoir on the droplet actuator and was removed by manual pipetting from the droplet actuator. The 3× reaction droplet was mixed on-bench with 96 μL of Tm wash buffer. The diluted reaction droplet was analyzed on a LX100 instrument.

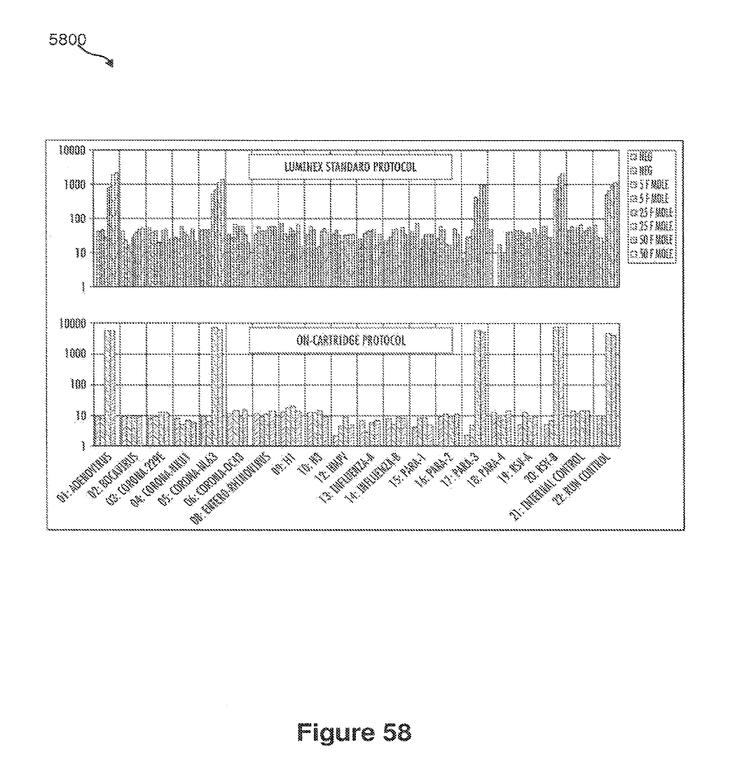

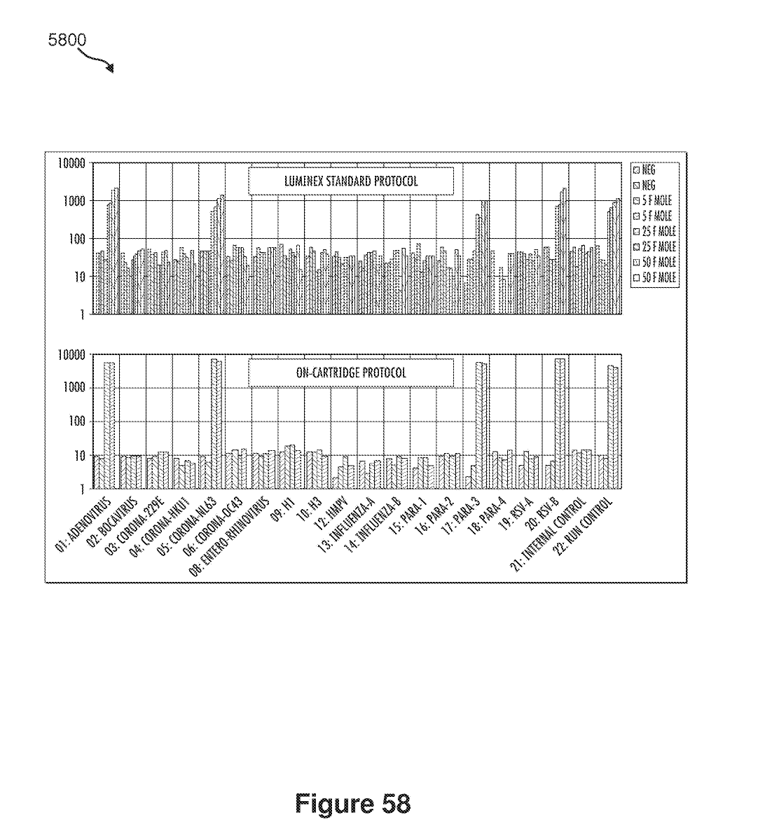

FIG. 58 shows an example of a bar graph 5800 of another comparison of an xTAG RVP assay performed on-bench and on a droplet actuator. Viral RNA was extracted on-bench. RT-PCR, xTAG bead hybridization and reporter labeling steps were performed on-actuator, followed by detection on a Luminex LX100 flow cytometer (bottom graph On-Cartridge Protocol). In parallel, the experiment was performed using the standard Luminex xTAG assay protocol (top graph Luminex Standard Protocol). Assays performed on-actuator and using the standard Luminex xTAG protocol are comparable. Sensitivity of the xTAG assay was higher on-actuator compared to the standard protocol.

Integration of Sample Preparation and xTAG RVP Assay

The present invention provides methods for integrated sample preparation (i.e., nucleic acid isolation and amplification) and detection (e.g., xTAG spectral multiplexing) of respiratory viruses on a droplet actuator.

Cystic Fibrosis Assay

The present invention also provides on-actuator protocols for cystic fibrosis (CF) screening. CF is an inherited disease that causes thick, sticky mucus to build up in the lungs and digestive tract. CF affects approximately 30,000 adults and children in North America. CF is caused by a mutation in the gene for the protein cystic fibrosis transmembrane conductance regulator (CFTR). Genetic testing may be used to screen (e.g., pre-natal screening, newborn screening) for CFTR gene mutations.

In one example, a PCR-based coded bead assay, such as the xTAG Cystic Fibrosis assay (Luminex), may be adapted for use on a droplet actuator. The PCR-based coded bead assay may be used to simultaneously detect and identify a panel of mutations (e.g., 23 mutations) and variants (e.g., 4 variants) in the CFTR gene in human blood specimens. An example of an on-actuator amplification protocol for CF screening using a PCR-based coded bead assay (e.g., CRTRv2 23-plex PCR) is shown in Table 11.

TABLE 11
On-bench (iQ5) and on-actuator protocols
for CRTRv2 23-plex PCR

| | On-Cartridge | | | | | |
|---|---|---|---|---|---|---|
| | iQ5 | | Off-Cartridge | | Amount Run on | |
| | Mix (25 μL) | | Mix (25 μL) | | Cartridge (600 nL) | |
| DNA Sample | 5 | μL | 5 | μL | 120 | nL |
| 5X PCR Buffer | 5 | μL | 5 | μL | 120 | nL |
| 50 mM | 1.75 | μL | 1.75 | μL | 42 | nL |
| MgCl₂ | | | | | | |
| CFTR v2 Primer | 2.5 | μL | 2.5 | μL | 60 | nL |
| Mix | | | | | | |
| Platinum ® Tfi | 1.0 | μL | 2.5 | μL | 60 | nL |
| exo(−) DNA | | | | | | |
| Polymerase | | | | | | |
| DNAse, RNAse | 9.75 | μL | 5.75 | μL | 138 | nL |
| Free Distilled | | | | | | |
| Water | | | | | | |

| | | | | | |
|---|---|---|---|---|---|
| TWEEN ® 20 | — | 2.5 | μL | 60 | nL |
| (1%) | | | | | |

Multiplexing Immunoassays

The present invention also provides a method of multiplexing immunoassays in a droplet actuator using a single droplet that contains multiple types of beads. In existing droplet actuators, the ability to multiplex immunoassays is a time consuming process that requires intensive attention by a skilled technician. Existing methods of multiplexing immunoassays require that the sample be divided into multiple volumes and that beads be separated and processed individually. By contrast, the method of multiplexing immunoassays of the invention uses a single sample droplet that contains different types of beads, the types and numbers of which are determined beforehand.

FIGS. 59A and 59B illustrate a side view of a portion an example of a droplet actuator 5900 and illustrate a process of multiplexing immunoassays using multiple types of beads in a single droplet. Droplet actuator 5900 may include bottom substrate 5910 that is separated from a top substrate 5912 by a gap 5914. Bottom substrate 5910 may include an arrangement of droplet operations electrodes 5916 (e.g., electrowetting electrodes). Droplet operations are conducted atop droplet operations electrodes 5916 on a droplet operations surface. A magnet 5918 may be arranged in close proximity to bottom substrate 5910 and substantially aligned with a certain droplet operations electrode 5916, such that the certain droplet operations electrode 5916 is within the magnetic field of magnet 5918. Magnet 5918 may be a permanent magnet or an electromagnet. Magnet 5918 may in some embodiments be sized to substantially correspond to the footprint of the certain droplet operations electrode 5916.

A droplet, such as droplet 5920, may be in gap 5914 of droplet actuator 5900. Droplet 5920 may, for example, be a droplet of sample fluid or a reagent fluid. One or more beads 5922 to be evaluated may be suspended in droplet 5920. Beads 5922 may, for example, be a combination of one or more types of beads. That is, beads 5922 may be a collection of different types of beads that have affinities for different analytes or substances, e.g., different primary capture antibodies having affinity for different substances. Additionally, beads 5922 may be magnetically responsive. Examples of suitable magnetically responsive beads are described in U.S. Pat. No. 7,205,160, entitled, “Multiplex flow assays preferably with magnetic particles as solid phase,” granted on Apr. 17, 2007.

In one example, beads 5922 may contain a certain number of a first type of magnetically responsive bead that has a first type of primary capture antibody, a certain number of a second type of magnetically responsive bead that has a second type of primary capture antibody, a certain number of a third type of magnetically responsive bead that has a third type of primary capture antibody, and so on. Additionally, each type of bead has an identifying trait for easily differentiating one type of bead from another. For example, the various types of beads 5922 may be differentiated by color, fluorescence, size, density, surface properties, responsiveness to a magnetic field, radioactivity, and any combinations thereof. In some embodiments, the number of each type of bead 5922 within droplet 5920 is known.

Upon interacting with a reagent, the different types of beads 5922 within droplet 5920 may be evaluated for target substances that have an affinity for the beads. As an example, a method of evaluation may involve digital imaging of the beads for identifying, for example, different fluorophores. In this embodiment, an imaging system, such as, but not limited to, imaging system 4600 of FIG. 46, may be associated with droplet actuator 5900. Imaging system 4600 may be used to capture digital images of, for example, droplet 5920 and the beads 5922 therein. Imaging system 4600 may capture images through top substrate 5912, which may be, for example, a glass plate that is substantially transparent or otherwise transmissive of wavelengths of interest. Various optical filters may be used to distinguish beads by wavelengths emitted and/or the invention may employ a spectrometer that can image different wavelengths. By use of imaging system 4600 and the multiple types of beads 5922 within droplet 5920, a mechanism is provided for performing multiple immunoassays using a single droplet, i.e., multiplexing immunoassays, which is the process of evaluating a single sample that includes multiple substances of interest.

A method of multiplexing immunoassays using a single droplet that contains multiple types of beads may be accomplished using any of a variety of droplet operations mediated by droplet operations electrodes 5916. A droplet including the beads and potentially including one or more target molecules may be provided on the droplet actuator. For example, a droplet including the beads may be combined with a droplet including the one or more target molecules using droplet operations on the droplet actuator. Or, as another example, the beads may be brought into association with a fluid comprising the target molecules off the droplet actuator, and thereafter introduced onto the droplet actuator. The beads in association with the target molecules may be subjected to various immunoassay protocols, such as a sandwich immunoassay protocol. For example, a first type of substance may bind to the first type of primary capture antibody of the first type of magnetically responsive bead, a second type of substance may bind to the second type of primary capture antibody of the second type of magnetically responsive bead, a third type of substance may bind to the third type of primary capture antibody of the third type of magnetically responsive bead, and so on.

At the point in the immunoassay protocol at which imaging is desired, beads 5922 may be transported into proximity with magnet 5918, as illustrated in FIG. 59B. Because beads 5922 are magnetically responsive and are attracted to magnet 5918, a layer of beads 5922 form along the surface of the droplet operations electrode 5916. Preferably, the concentration of beads 5922 within droplet 5920 is substantially optimized such that the layer of beads 5922 is substantially a monolayer, with substantially no clumping. The optimization to provide a monolayer of beads may occur by selecting a certain size of bead, certain gap height, certain magnetic field strength, certain magnetic field pattern, and/or using various additives, such as surfactants to control surface tension of the droplet. For example, providing large beads and a small gap may assist in the formation of a monolayer of beads. Droplet 5920 may then be illuminated, and a digital image of the monolayer of beads 5922, as shown in FIG. 59B, may be captured via imaging system 4600.

Using known image analysis processes, each type of bead 5922 may be identified via its predetermined identifying trait (e.g., color, fluorescence, and/or size). In another embodiment, each type of bead 5922 may be identified by measuring its magnetism level using a Superconducting Quantum Interference Device (SQUID) magnetometer (not shown). Subsequently, once identified, each type of bead 5922 may be evaluated for additional substances, such as for secondary antibodies of interest that may be bound thereto. For example, this may be accomplished by evaluating the type of fluorophore that is attached to each type of bead 5922. More specifically, a secondary antibody may be labeled with a fluorophore. Once exposed to the reagent, imaging may be used to quantify the amount of secondary antibody that has been captured.

A variation of the method of multiplexing immunoassays using a single droplet that contains multiple types of beads may include imaging the beads before exposing the beads to target analytes, in order to identify the location of each bead. Then the beads may be subjected to an immunoassay protocol while maintaining their position, after which the beads may be reimaged in order to identify the expected properties of each bead resulting from the immunoassay, e.g., the measure the fluorescence from each bead, and/or, a change in fluorescence resulting from the immunoassay protocol.

In various embodiments, optical filters may be used to assist in the differentiation of beads having different fluorophores. Multiple optical filters may be required, for example, to distinguish the fluorescence of the primary antibody of the bead from the fluorescence of the secondary antibody.

An aspect of the invention is the use of different types of beads and determining beforehand the number and type of each bead in the sample droplet. Because the number, types and/or locations of beads are known, the fluorescence, luminescence, radioactivity, or other reporter characteristics can be used to distinguish multiple substances in a single droplet.

Systems

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module” or “system.” Furthermore, the methods of the invention may take the form of a computer program product on a computer-usable storage medium having computer-usable program code embodied in the medium.

Any suitable computer useable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicants' invention set forth in this specification, and neither its use nor its absence is intended to limit the scope of the applicants' invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

1.-20. (canceled)

21. A method of mixing a droplet, the method comprising:
forming a droplet into a first “U” shape having a bottom region and two terminal ends, wherein the droplet is on a surface; and
simultaneously merging the terminal ends and splitting the droplet at the bottom region to form a second “U” shape which is substantially opposite the first “U” shape.

22. The method of claim 21, further comprising repeating the forming step and the simultaneously merging and splitting step one or more times.

23. The method of claim 21, wherein the forming step comprises manipulating the droplet using droplet operations mediated by electrodes.

24. The method of claim 23, wherein the droplet operations are electrowetting-mediated.

25. The method of claim 21, wherein the droplet comprises beads.

26. The method of claim 21, wherein the droplet comprises a sample.

27. The method of claim 21, wherein prior to forming the droplet into the first “U” shape, the method further comprises merging a sample droplet and a reagent droplet to yield the droplet on the surface.

28. The method of claim 21, wherein the droplet is situated on the surface and sandwiched between two substrates.

29. A droplet actuator, comprising:
one or more substrates arranged to form a droplet operations gap; and
an arrangement of reservoir electrodes associated with one or both substrates, the reservoir electrodes comprising:
a central path of reservoir electrodes; and
reservoir flanking electrodes arranged on either side of the central path of reservoir electrodes.

30. The droplet actuator of claim 29, wherein each central reservoir electrode is aligned with a pair of the reservoir flanking electrodes.

31. The droplet actuator of claim 29, wherein the reservoir electrodes comprise electrowetting electrodes.

32. The droplet actuator of claim 29, wherein the arrangement of reservoir electrodes is present in a sample reservoir.

33. The droplet actuator of claim 29, wherein the arrangement of reservoir electrodes is situated in a region of the droplet operations gap having a transition and gap height, wherein the gap height decreases in a direction which is away from the central reservoir electrodes.

34. The droplet actuator of claim 29, wherein one of the reservoir electrodes is arranged in relation to a priming electrode, and wherein the priming electrode is arranged in relation to a path of droplet operations electrodes.

35. The droplet actuator of claim 34, wherein the arrangement of reservoir electrodes is situated adjacent to the path of droplet operations electrodes, such that the reservoir electrodes are arranged to dispense droplets onto the path of droplet operations electrodes.

36. The droplet actuator of claim 29, wherein the central reservoir electrodes are arranged along an X axis, and wherein a length of each central reservoir electrode along the X axis is substantially equal to a length of each central reservoir electrode's flanking reservoir electrodes along the X axis.

37. A method of distorting a droplet shaped to effectuate mixing, the method comprising:
using the droplet actuator of claim 29, activating a central reservoir electrode and one or more flanking reservoir electrodes which do not flank the activated central electrode.

38. The method of claim 37, further comprising activating two or more of the central reservoir electrodes and one or more of the flanking reservoir electrodes which do not flank the activated two or more central reservoir electrodes.
